(19) United States
(12) Patent Application Publication
(10) Pub. No.: US 2012/0014673 A1
(43) Pub. Date: Jan. 19, 2012

(54) VIDEO AND AUDIO CONTENT SYSTEM

(75) Inventor: Sean Patrick O'Dwyer, Forest Lake (AU)

(73) Assignee: iGruuv Pty Ltd, Moss Vale (AU)

(21) Appl. No.: 13/121,047

(22) PCT Filed: Sep. 24, 2009
(86) PCT No.: PCT/AU09/01270

§ 371 Date: Sep. 27, 2011

(30) Foreign Application Priority Data
Sep. 25, 2008 (AU) 2008904993
Feb. 17, 2009 (AU) 2009900666

(51) Int. Cl. H04N 5/93

(52) U.S. Cl. 386/282; 386/285; 386/E05.028

(57) ABSTRACT

A method for use in editing video content and audio content, wherein the method includes, in a processing system, determining a video part using video information, the video information being indicative of the video content, and the video part being indicative of a video content part, determining an audio part using first audio information, the first audio information being indicative of a number of events and representing the audio content, and the audio part being indicative of an audio content part including an audio event and editing, at least in part using the audio event, at least one of the video content part and the audio content part using second audio information indicative of the audio content.

### BACKGROUND OF THE INVENTION

The present invention relates to a method and apparatus for use with video content and audio content, and in particular to a method and apparatus for use in editing or generating video in accordance with audio content.

The present invention also relates to a method and apparatus for use in presenting audio content, and in particular to a method and apparatus for presenting audio content with associated video content to allow modification of the presentation of the audio content.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavor to which this specification relates.

Software for video and audio creation and manipulation has advanced in recent years, moving from the realm of the professional in large scale production studios to the realm of the average person with a personal computer.

For example, it is possible to detect the tempo of a particular piece of audio or ‘song,’ and ‘time stretch’ the song to a user-defined tempo whilst altering the audio such that it does not appear ‘pitch-shifted.’ Software which enables tempo change without subsequent pitch shift requires several different functionalities including waveform analysis software and time compression and expansion algorithms (TCEAs).

The main problem with this type of software is that although two waveform songs can be automatically tempo-matched via transient detection they are not automatically ‘position-matched.’ Using such software two songs can be analyzed and played back together in the same tempo, however the songs will not necessary match each other in terms of bars and beats timing. This means for example that if a user chooses the beginning of a particular bar of the first song to play from, the mix may begin playing from the middle of a bar of the second song. The songs are in the same tempo; however the ‘time grid’ behind the two different songs is not synchronized. Songs therefore need to be position corrected via input from the user of the software (a process commonly known as ‘nudging the song left and right’) in order that two songs are position-matched and their bars and beats line up appropriately. This still does not ensure however that the songs will remain position matched throughout and certainly does not mean that the songs will match each other in terms of ‘arrangement’ (for example the chorus beginning of one song will not necessarily line up with the chorus beginning of another song).

The utilization of ‘loops’ (bars or bar multiple ‘bits’ of audio) means that a user does not have to position songs as to one another, bar by bar. Loops may be made using waveform analysis software to detect transients and typically include the following data:
Waveform data.
Metadata.
Transient markers.

A common MP3 file has waveform and metadata. By providing the additional transient markers in a file the means is provided by which a TCEA can be used in order that two loops of different tempos can be played back at the same tempo without altering the pitch of either loop.

In the case of video editing, and in particular the situation in which video and audio content are edited together, for example when adding a sound track to pre-edited video, similar problems exist in aligning specific portions of video with corresponding audio content. Typically this requires a user to align the video and audio content based on either the start or end of the audio content, or by providing manual intermediate alignment. Such manual alignment is typically achieved by allowing a user to listen to music and adjust the position of an audio waveform relative to the video content.

As a result of these difficulties, use of video editing software is still typically limited due to the time and effort required to acquire the skill, knowledge and talent required to utilise the software. As a result it is desirable to provide an interactive music capability that requires a small amount of time and effort to learn and very little, knowledge or talent to use.

A number of media player software applications, such as Windows Media Player, generate visualisations associated with the presentation of audio content. The visualisations typically take the form of computer generated animations whose appearance changes to simulate changes in the audio content being presented.

When generating such video content, this is typically achieved by performing waveform analysis, with the derived information being used in a computer algorithm to generate video content, for example by generating a fractal image the current parameters of which varying in time depending on the waveform information. However, such analysis provides only limited information, typically regarding the overall pitch, volume, or the like and does not therefore discern between events, such as different instruments playing. Accordingly, when the video is generated, this is performed only on the basis of limited information, and typically therefore has only limited relevance to the music.

As a result of these issues, the appeal of such visualizations is limited.

WO2005104549 discloses a method and apparatus of synchronizing a caption in an audio file format (e.g., way, MP3, wma, ogg, asf, etc.) reproduced in a bit steam, a musical instrument digital interface (MIDI) file format for reproducing an audio, and a file format combined with a picture and an audio data reproduced in a bit stream, regardless of compression, and, more particularly, to a method and apparatus of synchronizing a caption, in which an interested location information is inputted every bit and a caption is synchronized in various file formats, such as a bit stream file format, an interface file format or a multimedia file format, so that the caption may be easily modified to variable bit rate, zipping or a new multimedia file format, and the caption is synchronized by use of synchronization information produced from an appliance (e.g., mobile devices and computer system) to be consistently track or color according to the audio when the audio is reproduced, regardless of the variable bit rate like a computer music player.

### SUMMARY OF THE PRESENT INVENTION

In a first broad form the present invention seeks to provide a method for use in editing video content and audio content, wherein the method includes, in a processing system:
a) determining a video part using video information, the video information being indicative of the video content, and the video part being indicative of a video content part;
b) determining an audio part using first audio information, the first audio information being indicative of a number of events and representing the audio content, and the audio part being indicative of an audio content part including an audio event; and,
c) editing, at least in part using the audio event, at least one of:
   i) the video content part; and
   ii) the audio content part using second audio information indicative of the audio content.

Typically the second audio information includes a waveform of the audio content.

Typically the method includes, in the processing system, at least one of:
a) aligning the video content part and the audio content part using the audio event;
b) modifying the video content part; and,
c) modifying the audio content part.

Typically the method includes, in the processing system, determining the audio content part from the second audio information using the first audio information.

Typically the method includes, in the processing system, determining at least one of the video part and the audio part based on an association between the video part and the audio part.

Typically the method includes, in the processing system, defining an association between the video part and the audio part.

Typically the method includes, in the processing system, storing the video content and the audio content by storing each video content part together with an associated audio content part.

Typically the method includes, in the processing system, storing the video content parts and associated audio content parts as a file.

Typically the method includes, in the processing system, storing the first information in the file.

Typically the method includes, in the processing system, causing the video and audio content to be presented by presenting:
a) each video content part using the video information; and,
b) each audio content part using second audio information.

Typically the method includes, in the processing system, determining at least one of the audio part and the video part in accordance with user input commands

Typically the method includes, in the processing system:
a) displaying to the user:
   i) indications of a number of events; and
   ii) indications of a number of parts of video content; and
b) allowing the user to select at least one event and at least one video part using the indications.

Typically the method includes, in the processing system:
a) determining a user selection of at least one event;
b) presenting audio content including the at least one event using second audio information includes waveform data representing the audio content.

Typically the method includes, in the processing system:
a) determining an event type for the event; and,
b) modifying at least one of the audio content and the video content in accordance with the event type.

Typically the first information includes, at least one of:
a) note data;
b) timing data;
c) marking data; and,
d) instrument data.

Typically the video content includes a sequence of a number of frames, and wherein the video part includes at least one frame.

Typically the first audio information includes midi data.

Typically the first audio information includes a time grid, the events being positioned on the time grid to thereby indicate the respective position of the event within the audio content.

Typically the time grid includes an associated tempo representing the tempo of the audio content.

Typically the method includes, in the processing system:
a) determining at least one video event using first video information, the first video information being indicative of a number of video events within the video content; and,
b) editing at least one of the video content and the audio content at least in part using the video event.

Typically the first video information includes a time grid, the video events being position on the time grid to thereby indicate the respective position of the event within the video content.

Typically the time grid includes an associated tempo representing a video tempo assigned to the video content.

Typically the method includes, in the processing system, editing at least one of the video and the audio content at least in part using the video tempo.

Typically the method includes, in the processing system, combining audio content with video content, the audio content being selected at least partially in accordance with the video tempo and a tempo of the audio content.

Typically the first video information forms part of the first audio information.

Typically the method includes, in the processing system:
a) determining at least one video event using the first audio information, the first audio information being indicative of a number of video events within video content associated with the audio content; and,
b) editing at least one of the video content and the audio content at least in part using the video event.

In a second broad form the present invention seeks to provide a method for use in generating video and audio content, the method including:
a) determining an event using first audio information, the first audio information being indicative of a number of events and representing the audio content;
b) generating a video part indicative of a video content part; and,
c) causing the video content part to be presented to the user with an audio content part including the event, the audio content part being presented using second audio information indicative of a waveform of the audio content.

In a third broad form the present invention seeks to provide a method for use in presenting video and audio content, the method including, in a processing system:
a) presenting video and audio content to the user;
b) determining an event within the audio content using first information, the first audio information being indicative of a number of events and representing the audio content;
c) causing at least one of:
   i) modifying at least one of the video content part and the associated audio content part;
   ii) allowing interaction with at least one of the video content part and the associated audio content part; and,
   iii) triggering an external event.

In a fourth broad form the present invention seeks to provide a method for use in editing video content and audio content, wherein the method includes, in a processing system:
a) determining at least one video event using first video information, the first video information being indicative of a number of video events within the video content, the first video events being aligned on a time grid defining a tempo; and,
b) editing at least one of video content and audio content at least in part using the at least one video event.

In a fifth broad form the present invention seeks to provide a method for use in presenting audio content, wherein the method includes, in a processing system:
a) determining an audio part using first audio information, the first audio information being indicative of a number of events and representing the audio content, and the audio part being indicative of an audio content part including an audio event; and,
b) modifying the audio content part; and,
c) presenting audio content including the modified audio content part.

Typically the audio content part is at least one of:
a) a instrument or vocal solo; and,
b) an audio content component part.

Typically the component part includes a drum beat.

Typically the method includes, in the processing system, presenting the audio content using second audio information indicative of the audio content, the second audio information includes a waveform of the audio content.

Typically the method includes, in the processing system, presenting the audio content by:
a) determining the waveform part representing the audio content part;
b) modifying the waveform part; and,
c) presenting the second audio content using the modified waveform part.

In a sixth broad form the present invention seeks to provide apparatus for use in editing video content and audio content, wherein the apparatus includes a processing system for:
a) determining a video part using video information, the video information being indicative of the video content, and the video part being indicative of a video content part;
b) determining an audio part using first audio information, the first audio information being indicative of a number of events and representing the audio content, and the audio part being indicative of an audio content part including an audio event; and,
c) editing, at least in part using the audio event, at least one of:
   i) the video content part; and
   ii) the audio content part using second audio information indicative of the audio content.

In a seventh broad form the present invention seeks to provide apparatus for use in presenting video and audio content, the apparatus including a processing system for: a) presenting video and audio content to the user;
b) determining an event within the audio content using first information, the first audio information being indicative of a number of events and representing the audio content;
c) causing at least one of:
   i) modifying at least one of the video content part and the associated audio content part;
   ii) allowing interaction with at least one of the video content part and the associated audio content part; and,
   iii) triggering an external event.

In an eighth broad form the present invention seeks to provide apparatus for use in editing video content and audio content, wherein the apparatus includes a processing system for:
a) determining at least one video event using first video information, the first video information being indicative of a number of video events within the video content, the first video events being aligned on a time grid defining a tempo; and,
b) editing at least one of video content and audio content at least in part using the at least one video event.

In a ninth broad form the present invention seeks to provide apparatus for use in presenting audio content, wherein the apparatus includes a processing system for:
a) determining an audio part using first audio information, the first audio information being indicative of a number of events and representing the audio content, and the audio part being indicative of an audio content part including an audio event; and,
b) modifying the audio content part; and,
c) presenting audio content including the modified audio content part.

In a tenth broad form the present invention seeks to provide a machine readable file including:
a) video information, the video information being indicative of the video content;
b) first audio information, the first audio information being indicative of a number of events and representing the audio content; and,
c) second audio information indicative of the audio content. the second audio information includes a waveform of the audio content.

Typically the file includes first video information, the first video information being indicative of a number of video events within the video content.

Typically the first audio information is indicative of a number of video events within the video content.

In an eleventh broad form the present invention seeks to provide a method for use in presenting audio content, wherein the method includes, in a processing system:
a) generating video content using first audio information representing the audio content, the first audio information being indicative of audio events and including at least one audio component, the video content including at least one video component representing the at least one audio component and including video events based on corresponding audio events;
b) causing the video content and audio content to be presented to a user, the audio content being presented at least in part using second audio information, the second audio information including a waveform of the audio content, the video and audio content being presented so that the video events are presented synchronously with corresponding audio events;
c) determining at least one input command representing user interaction with the at least one video component; and,
d) modifying the presentation of the audio content in accordance with the user input command.

Typically the at least one video component is at least partially indicative of a parameter value associated with the audio component.

Typically the method includes, in the processing system:
a) determining a user input command indicative of user interaction with the video component; and,
b) modifying the parameter value for the audio component in accordance with the user input command.

Typically the method includes, in the processing system:
a) determining at least one parameter associated with the audio component; and,
b) generating the video component using the at least one parameter.

Typically the video component includes an indicator at least partially indicative of at least one of:
a) a parameter value; and,
b) an audio event.

Typically an indicator position of the indicator is indicative of the parameter value.

Typically the method includes:
a) determining a modified indicator position in accordance with the input command; and,
b) determining a modified parameter value in accordance with the modified indicator position.

Typically the method includes, in the processing system, determining a user input command indicative of user interaction with the indicator.

Typically the at least one video component is a visualisation.

Typically the video events include changes in at least one of:
a) a video component colour;
b) a video component shape;
c) a video component size; and,
d) video component movements.

Typically the video content includes a plurality of video components, each video component being indicative of a respective audio component.

Typically the audio content includes a plurality of audio components presented simultaneously.

Typically the events include at least one of:
a) musical notes;
b) drum beats; and,
c) vocal rendition indications.

Typically the first information includes, at least one of:
a) note data;
b) timing data;
c) marking data; and,
d) instrument data.

Typically the first audio information includes midi data.

Typically the first audio information includes a time grid, the events being positioned on the time grid to thereby indicate the respective position of the event within the audio content.

Typically the time grid includes an associated tempo representing the tempo of the audio content.

Typically the method includes, in a processing system, modifying the presentation of the audio content by modifying at least part of the audio waveform.

Typically the audio component is at least one of:
a) an instrument track; and,
b) a vocal track.

Typically the method includes, in the processing system, modifying the presentation of the audio content by:
a) determining a part of the waveform representing the audio content to be modified;
b) modifying the waveform part; and,
c) presenting the second audio content using the modified waveform part.

Typically the method includes, in the processing system, modifying the waveform part by at least one of:
a) performing waveform manipulation techniques;
b) replacing the waveform part with another waveform part from the audio content;
c) replacing the waveform part with a waveform part generated using the first information.

Typically the method includes:
a) rendering a video component in accordance with midi data associated with a waveform; and,
b) presenting the rendered video component and the audio content, the audio content being presented at least in part using the waveform.

In a twelfth broad form the present invention seeks to provide apparatus for use in presenting audio content, wherein the apparatus includes a processing system for:
a) generating video content using first audio information representing the audio content, the first audio information being indicative of audio events and including at least one audio component, the video content including at least one video component representing the at least one audio component and including video events based on corresponding audio events;
b) causing the video content and audio content to be presented to a user, the audio content being presented at least in part using second audio information, the second audio information including a waveform of the audio content, the video and audio content being presented so that the video events are presented synchronously with corresponding audio events;
c) determining at least one input command representing user interaction with the at least one video component; and,
d) modifying the presentation of the audio content in accordance with the user input command.

Typically the apparatus includes a display for displaying the video content.

Typically the display is a touch screen display for providing user input commands.

Typically the apparatus includes an audio output for presenting the audio content.

### BRIEF DESCRIPTION OF THE DRAWINGS

An example of the present invention will now be described with reference to the accompanying drawings, in which:

FIG. 1A is a flow chart of an example of a process for editing video and audio content;

FIG. 1B is a flow chart of an example of a process for generating video content;

FIG. 1C is a flow chart of an example of a process for use in presenting video and audio content;

FIG. 1D is a flow chart of an example of a process for use in presenting audio content;

FIG. 2 is a schematic diagram of an example of audio content represented as first and second audio information;

FIG. 3 is an example of a processing system;

FIGS. 4A and 4B are a flow chart of a second example of a process for editing video and audio content;

FIGS. 5A and 5B are schematic diagrams of examples of user interfaces for use in editing video and audio content;

FIG. 6 is a flow chart of a second example of a process for generating video content;

FIGS. 7A and 7B are a flow chart of a second example of a process for use in presenting audio content;

FIG. 8A is a schematic diagram of an example of a user interface for presenting audio and video content;

FIG. 8B is a schematic diagram of a first example of a visualisation video component;

FIG. 8C is a schematic diagram of a second example of a visualisation video component;

FIG. 8D is a schematic diagram of example indicators;

FIG. 8E is a schematic diagram of a second example of a user interface for presenting audio and video content;

FIG. 8F is a schematic diagram of an example of the process for modifying an indicator on the visualisation video component of FIG. 8B;

FIGS. 9A to 9F is schematic diagrams of example interactions with the visualisation video components;

FIG. 10 is a flow chart of an example process of creating first audio information;

FIG. 11A shows an example of a waveform and its corresponding transient positions detected by waveform analysis software;

FIG. 11B shows an example of waveform and bar positions determined via analysis of the transient positions;

FIG. 12A shows an example of a waveform that may prove difficult for waveform analysis software to accurately detect bar positions;

FIG. 12B shows an example of the waveform of FIG. 12A with determined bar positions shown;

FIG. 13 shows an example of a waveform bar with smaller time grid positions interpolated;

FIG. 14 is a flow chart of an example process by which the ‘common’ tempo of a waveform may be designated;

FIG. 15 is an example of a MIDI time grid being appended to a waveform;

FIG. 16 is an example of an appended MIDI time grid in which the time/length is not consistent between bars;

FIG. 17 is an example of an appended MIDI time grid in which the time/length is not consistent between smaller time divisions than bars;

FIG. 18 is a schematic diagram illustrating that notes or drum sounds may not always fall exactly on the time grid they are played to during creation;

FIG. 19 is a schematic diagram of a representation of a waveform song retrofitted with an alternative MIDI score appended to the MIDI time grid;

FIG. 20 is a schematic diagram illustrating a retrofile broken up into arrangement sections via rendition part markers;

FIG. 21 is a schematic diagram illustrating the arrangement sections defined in FIG. 20 used to re-arrange the playback sequence of the waveform's arrangement sections;

FIG. 22 is a schematic diagram illustrating a retrofile broken up into solo sections via rendition part markers;

FIG. 23 is a schematic diagram illustrating that some events are within bars and need bar markers to define their timing and also markers to define when to start and stop playing waveform data;

FIG. 24 is a schematic diagram illustrating that events could be designated by designating their position inside MIDI tracks;

FIG. 25 is a schematic diagram illustrating that a retrofile can be broken up into track parts via track part markers;

FIG. 26 is a schematic diagram illustrating an example of the MIDI looping functionality derived from the fact that the waveform has been appended with a MIDI time grid;

FIG. 27 is a flow chart of an example process for the creation of a retromix file—a users file save of a retrofile;

FIG. 28 is a schematic diagram of an example multitouch-screen interface for a retroplayer utilizing an iPhone;

FIG. 29 is a schematic diagram illustrating accelerometer use for ‘scratching’ of one piece of the waveform song of a retrofile whilst the waveform song plays in the background as normal;

FIG. 30 is a schematic diagram illustrating accelerometer use to allow a user to tap their thigh with both hands and tap their foot in order to drum in like fashion (in terms of hand and foot use and placement) to a ‘real’ drum set;

FIG. 31 is a schematic diagram illustrating how parameter sweeps could be graphically drawn by finger using a multitouch-screen interface;

FIG. 32 is a schematic diagram illustrating an example of a ‘retroplayer keyboard’;

FIG. 33 is a schematic diagram illustrating an example hardware ‘Retroplayer Nano’;

FIG. 34 is a schematic diagram illustrating an example hardware ‘Retroplayer’;

FIG. 35 is a schematic diagram illustrating an example hardware ‘Retroplayer Professional’;

FIG. 36 is a schematic diagram illustrating an example of how a retroplayer collaborative process may occur;

FIG. 37 is a schematic diagram illustrating an example of how a playback process may be implemented; and,

FIG. 38 is a schematic diagram illustrating a retrofile with a non-uniform appended MIDI time grid being conformed to a uniform MIDI time grid such that bars/parts etc of the retrofile may be mixed with bars/parts etc of another retrofile that has also been conformed to a uniform MIDI time grid of the same tempo; and,

FIGS. 39A to 39C are schematic diagrams of example waveforms for the mixing of two songs.

### DETAILED DESCRIPTION OF THE PREFERRED EMBODIMENTS

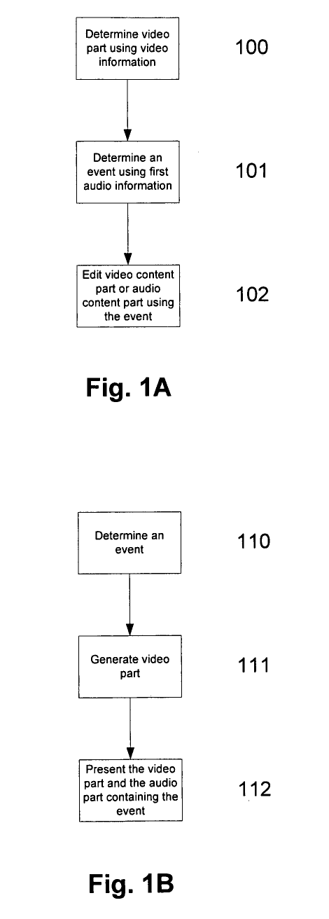

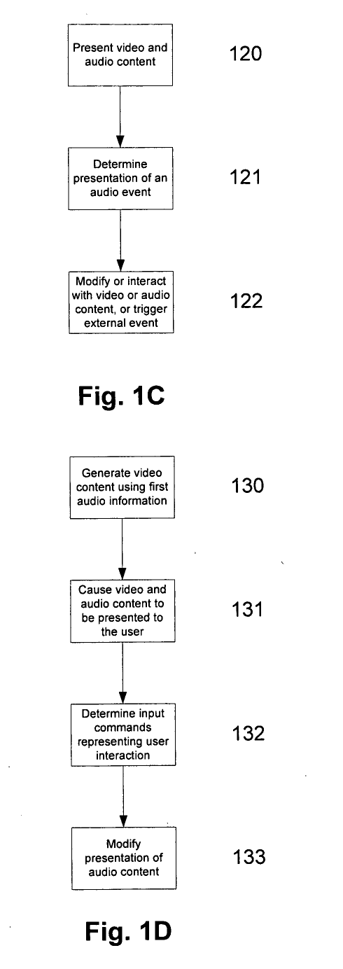

An example of a process for editing video content will now be described with reference to FIG. 1A.

At step 100, a video part is determined using video information indicative of the video content. The video information may be in the form of a sequence of video frames and the video part may be any one or more of the video frames. The video part may be determined in any suitable manner, such as by presenting a representation of the video information, or the video content to the user, allowing the user to select one or more frames to thereby form the video part.

At step 101, the process includes determining an event using first audio information. The manner in which the event is determined can vary depending on the preferred implementation and on the nature of the first audio information.

The first audio information is indicative of audio events, such notes played by musical instruments, vocals, tempo information, or the like, and represents the audio content. The first information can include information regarding note data, timing data, marking data and instrument data, and in one example are defined by commands within the first audio information which allow a representation of the audio content to be reproduced.

In one specific example, the first audio information is in the form of MIDI data, or other similar information, which indicates each of the notes that should be played by each of the instruments required to reproduce the audio content, allowing suitable musical instruments to reproduce the audio content. Additional events can also be represented, for example through the inclusion of timing data, markers or the like, as will be described in more detail below.

The first audio information can be provided together with second audio information, which is indicative of a waveform of the audio content. The audio waveform allows an actual recording of the audio content to be presented by a suitable playback device, such as a computer system, media player, or the like. Additionally, a reproduction of the music can be generated by one or more suitable devices, such as a computer system, media player or suitably configured musical instruments.

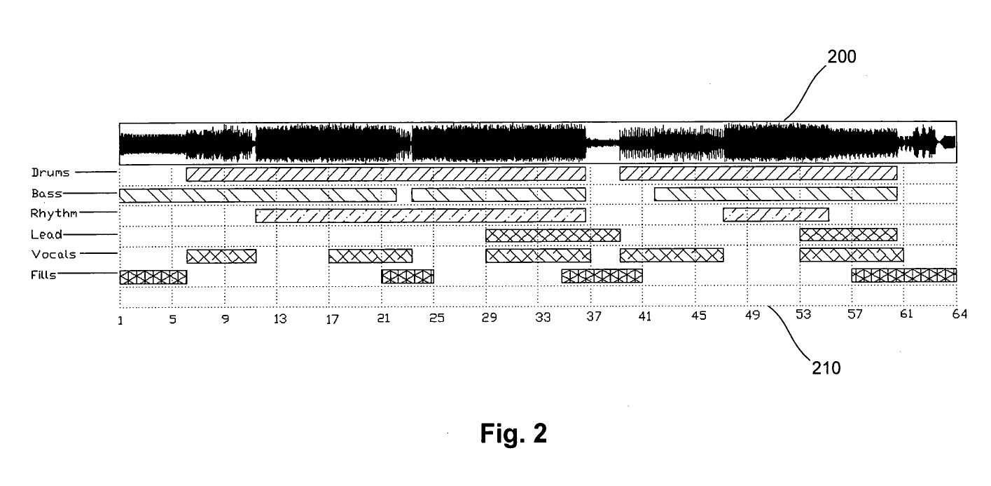

In one example, the first and second audio data can be provided as part of a single machine readable file in which the first and second audio information are arranged so that events in the first audio data align with corresponding events in the audio waveform. A schematic diagram indicative of this arrangement is shown in FIG. 2, in which second audio information 200, in the form of an audio waveform, is aligned with corresponding first audio information, in the form of midi data. This arrangement assists with additional editing or other audio manipulation techniques such as mixing, or the like, as well as generating video content, as will be described in more detail below.

Thus, in one example, the machine readable file is in the form of a MIDI song score synchronously appended to a digital song waveform, such as an MP3, WMA encoded waveform or the like. In one example, the file includes place markers on the associated MIDI time grid marking out bars, beats, catch phrases, solo indications, or the like. Additionally, the MIDI data can include further parameter values associated with the audio content, such as volume, mix level, fade, equaliser settings, or any other audio effects. Such parameters may remain constant over time, others may vary throughout the song, and some may repeat over bars or groups of bars (such repetitions are commonly called parameter ‘sweeps’). The MIDI and other additional information can be used to provide additional functionality, such as to perform mixing or editing as will be described in more detail below.

In one example, a representation of the first audio information is used by a user to select a respective event. The event could therefore correspond to a particular note played by a respective instrument, or alternatively could be in the form of the start of a verse, chorus or the like. Alternatively, the event may be determined automatically, for example by having a computer system perform a search of the first audio information in accordance with search criteria which identifies a particular type of event. Thus, for example, a user could select an event type with an indication of each event of the respective event type being presented to the user, allowing the user to then select an event as required.

At step 102, at least one of the video content part and audio content part are edited at least partially in accordance with the event. This could include, for example, aligning the video and audio content part. The manner in which this is performed will typically vary and this could include using an automated technique to allow a selected event and video part to be aligned. Alternatively, this could be achieved by assisting a user to manually align representations of the video part and the event, using a user interface provided by a suitable computer system.

Alternatively, this could include modifying either one of the audio and video content parts. For example, this could involve applying effects such as overlays, or other modifications to the video content, or mixing or otherwise adjusting the audio content.

Typically, in the above examples, if the audio content part is to be modified or aligned with the video content part, this is performed using second audio information indicative of the audio content, and which typically includes an audio waveform. This allows any modification or alignment to be carried out directly on the audio information, so that the audio and video content can be presented without requiring the first audio information.

Thus, the above described process can be used to assist in editing video content, and in particular, to allow video content to be synchronised with audio content, based on events identified in the first audio information, or to allow modification of the video or audio content to be performed based on events within the audio content.

An example of a process for generating video content will now be described with reference to FIG. 1B.

In this example, at step 110 at least one event is determined using first audio information. It will be appreciated that this may be achieved in a manner similar to that described above, for example by having first audio information presented to the user, allowing the user to select an event. Alternatively, the event could be detected automatically by a computer system or other video generating device. In this instance, the computer system will scan the first audio information during or prior to presentation of the audio content, and identify respective events within the audio information.

At step 111, a video part is generated based on at least one event. Thus, this allows the computer system to selectively generate video content, such as parts of video content, based on the currently determined event. The manner in which the video is generated will depend on the preferred implementation. Thus, in one example, a computer system may be used to generate video content, which is then displayed concurrently with corresponding audio content. The video content could therefore be in the form of visualisations, such as those presented by Windows Media Player, Apple i-Tunes, or the like. Alternatively, however, more complex video can be generated. Thus, in one example, the generated video includes characters representing members of a band with each of the characters being generated in accordance with corresponding events in the first audio information. This allows the characters to appear to be playing the corresponding audio content, as will be described in more detail below.

Once the video is generated, this can be presented together with the audio content containing the event at step 112.

An example of a process for use in presenting content will now be described with reference to FIG. 1C.

At step 120, video and audio content is presented, typically using a suitable playback device, such as a computer system. This is typically performed on the basis of the video information and an audio waveform provided in the second audio information. During presentation an event in the audio content can be determined at step 121, using the first audio information.

Thus, for example, when a part of the video content is being presented, an event within the audio content can be identified by having the computer system scan first information, provided in an encoded file together with the video and second audio information, and identify one or more events of interest.

Alternatively, the user can identify a video content part using a suitable input device, with this being used by the computer system to identify a corresponding audio event. For example, if the video content is presented on a touch screen, this allows the user to select a respective video content part using a user input command, such as touching the video content part being presented. The computer system will then use the selected video content part to identify the audio event.

Once an event has been identified, the computer system can be used to modify either a video content part or audio content part associated with the audio event, or alternatively allow interaction with the video or audio content, at step 122. The manner in which this is achieved, will depend on the preferred implementation but could include, for example, modifying either the sound presented, or modifying the video in some fashion, for example, by applying an effect overlay upon occurrence of a respective event within the audio content.

It will also be appreciated that this technique can be used to allow external events to be triggered, such as launching of fireworks, or the like, as will be described in more detail below.

Accordingly, the inclusion of the first audio information together with the video and audio content can assist in allowing user interaction with the video and/or audio content as the content is presented.

A further option is for the process to utilise first video information, which is similar to the first audio information in that it is indicative of a number of events within the video content. Whilst the first video information is not representative of the video content in the sense that it would not allow the video content to be reproduced, by allowing specific video events to be identified, this can further assist in editing, for example by allowing automated alignment of video and audio events.

To assist with this, the video events can be provided on a time grid. In one example, the time grid can correspond to a time grid used within the first audio information, if the corresponding video and audio content are provided concurrently, for example as part of a single common file, although this is not essential as will be described in more detail below.

An example of a process for use in presenting audio content will now be described with reference to FIG. 1D.

At step 130, video content is generated using first audio information representing the audio content. The audio and video content may be of any suitable form, but in one example includes music audio content and associated graphical visualisations the appearance of which changes based at least partially on the music audio content.

The first audio information is indicative of audio events, such notes played by musical instruments, vocals, tempo information, or the like, and in this example, includes at least one audio component, which can represent any portion of the audio content, such as different tracks, including instrument tracks, vocal tracks, or the like.

As in the previous examples, the first audio information can include note data, timing data, marking data and instrument data, defined by commands within the first audio information, and can therefore be in the form of MIDI data, or other similar information. The first audio information can also be provided together with second audio information, indicative of a waveform of the audio content. The first and second audio data can be provided as part of a single machine readable file, to assist with generating video content as will be described in more detail below.

In one example, the video content includes at least one video component indicative of the at least one audio component and includes video events based on corresponding audio events. The video component can be of any suitable form, but in one example represents computer generated visualizations, such as shapes, patterns, coloured regions, or the like, similar to those presented by Windows Media Player, Apple i-Tunes, or the like. The video events then typically correspond to changes in the appearance of the video components, such as changes in colour, shape, movement, position or the like. It will be appreciated from this that the video components are typically dynamic, with the appearance changing to reflect the audio content currently being presented.

The video content is generally generated in accordance with a predetermined algorithm, template or the like, which specifies characteristics of the appearance of the video component based on the occurrence of events and the value of parameters associated with the audio to content, as determined at least in part using the first audio information. Thus, for example, the video component can be a fractal image whose parameters are based on the notes played by a particular instrument and the values of the parameters associated with that instrument.

Although separate video components are typically provided for each audio component, this is not essential, and in one example, the visualization may include only a single video component indicative of events in the audio content as a whole. In this instance, the entire audio content effectively forms a single audio component, as will be appreciated by persons skilled in the art

At step 131, the video content and audio content are presented to a user. The audio content is typically presented at least in part using second audio information including a waveform of the audio content. The video and audio content are presented so that the video events are presented synchronously with corresponding audio events.

At step 132, at least one input command representing user interaction with the at least one video component is determined. This may be achieved in any suitable manner depending on the device used to present the audio and video content. Thus for example, this may be achieved through the use of a touch screen, or other input device, such as a mouse, or other pointer device.

The nature of the interaction may vary depending on the nature of the video component. Thus, in one example, the interaction could include moving all or part of the video component by performing a dragging operation using a pointer. In one example, the video component can include indicator corresponding to respective parameters or events, with modification of the indicator being used to manipulate the corresponding parameters or events. However, alternatively, the size, shape, position, or any other attribute of the video component may be modified, thereby modifying the events or parameter values accordingly. Interaction may be performed by moving the video components closer to or further away from each other. That is, the interaction may be based on the relative positions of the video components, the positions of the video components able to moved by the user.

At step 133, the presentation of the audio content is modified in accordance with the user input command. The nature of the modification will depend on the implementation, but could include altering parameters associated with the presentation of the audio content, such as the tempo, volume, pitch, or the like, or modifying audio events, such as the notes played, or the like. Typically this will involve modifying at least the audio component associated with the at least one video component, but may also optionally include modification of other audio components.

The manner in which the modification is performed will depend on the nature of the modification and could be achieved by modifying device settings, or by modifying the audio waveform, for example by substituting waveform parts, or generating new waveform parts, modifying existing waveform parts, or the like, with presentation of the audio content being performed using the modified audio waveform.

As part of this process, the video components may also be updated to reflect the changes made. Thus, for example, if the video component includes one or more indicators, a position or appearance of the indicator can be modified to represent the change in the parameter value, or event.

Accordingly, the above described process allows for video components to be generated based on audio events defined within first audio information. As the first information defines a greater amount of information regarding the audio content than can be derived based on existing techniques, such as waveform analysis, or the like, then the generated video content correspond more accurately to changes in the audio content than is typically with conventional arrangements.

Additionally, this allows different video components to be generated for different components of audio content, such as different instrument components, defined in the first audio information, which is not normally achievable using existing techniques such as waveform analysis. This in turn allows the video components to be used as controls to modify the presentation of the different components of audio content, either simultaneously or independently, which is not achievable with prior art techniques.

The visualisation may also be indicative of parameter values associated with the audio content presentation, such as pitch, tempo or the like, thereby allowing these parameter values to be controlled in a similar manner.

Accordingly, by providing the first audio information and allowing this to be used in generating video components, this not only allows video content to be generated which more visually represents the audio content, but which also allows control to be provided over the presentation of audio content, and in particular different audio components.

It will be appreciated from the above description that each of the above described methods allow interaction, such as video editing, video generation or video or audio manipulation based on audio events in audio content corresponding to the respective video content.

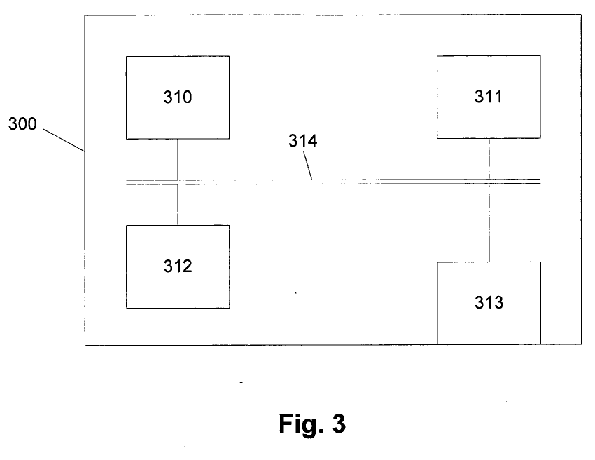

In one example, one or more of the above described processes can be implemented, at least in part, using a processing system. An example of a suitable processing system will now be described with reference to FIG. 3.

As shown in this example, the processing system 300 includes at least one processor 310, a memory 311, an output device 312, such as a display, and an external interface 313, interconnected via a bus 314 as shown. In this example the external interface 313 can be utilised for connecting the processing system 300 to peripheral devices, such as communications networks, databases or other storage devices, or the like. Although a single external interface 313 is shown, this is for the purpose of example only, and in practice multiple interfaces using various methods (eg. Ethernet, serial, USB, wireless or the like) may be provided.

In use, the processor 310 executes application software stored in the memory 311 to allow different processing operations to be performed, including, for example, editing and/or generating video content, based on audio content, as well as to optionally allow presentation of video and/or audio content. Accordingly, it will be appreciated that the processing system 300 may be formed from any suitable processing system, such as a suitably programmed computer system, PC, Internet terminal, lap-top, hand-held PC, smart phone, PDA, web server, or the like. Accordingly, the above described processes can be implemented using a suitably programmed computer system, or other similar device, such as a playback device.

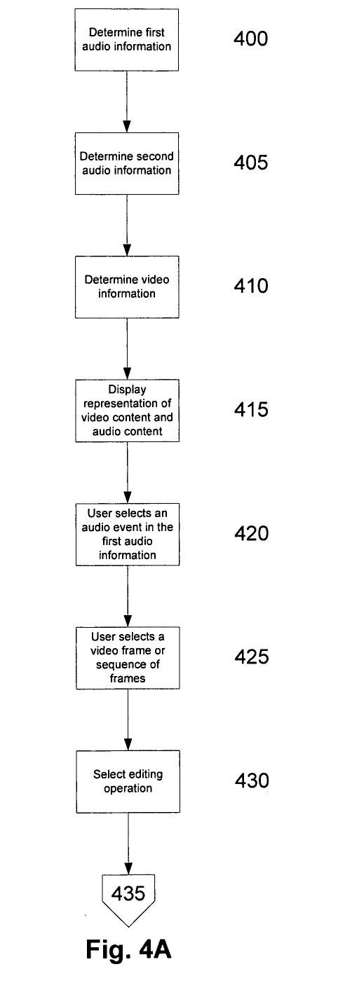

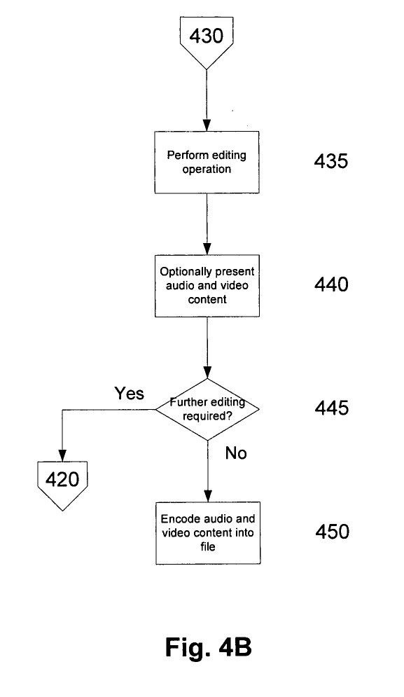

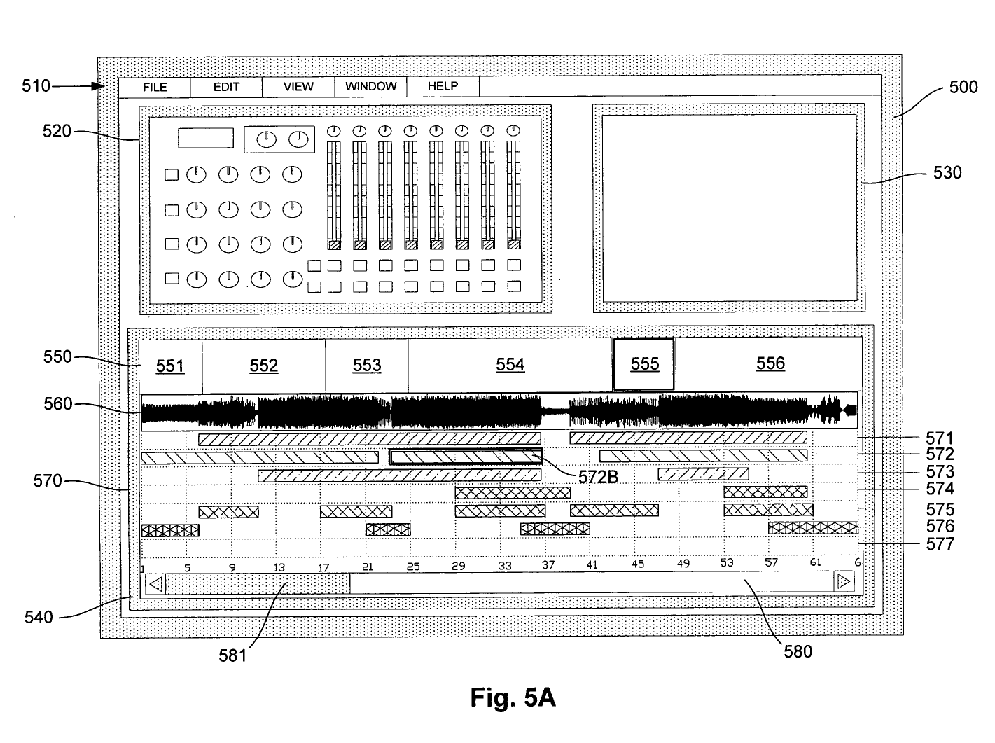

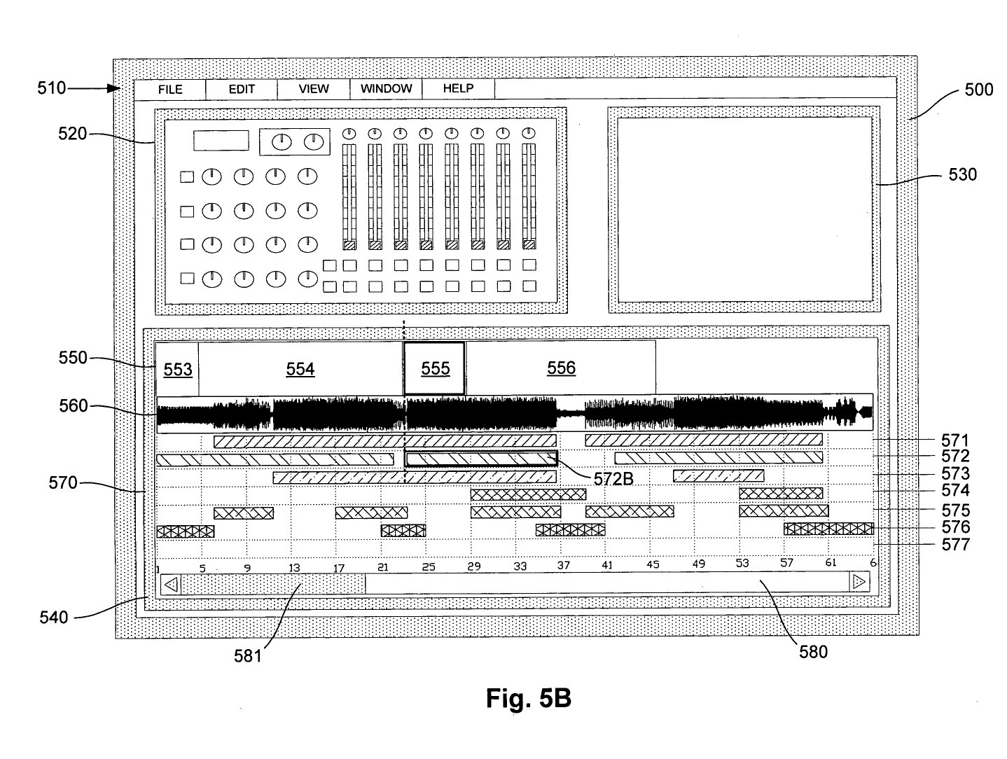

An example of a process for editing video utilising a computer system will now be described in more detail with reference to FIGS. 4A and 4B, and FIGS. 5A and 5B.

At step 400 the computer system determines first audio information, with second audio information being determined at step 405. This is typically achieved by having the computer system access a single computer readable file containing both the first and second audio information. In one example, the file can include the audio content as in MP3 or another similar format, with the file including additional meta-data representing the first information. The files may be generated in any suitable manner as described for example in more detail in co-pending application No. PCT/AU2008/000383.

The audio information may be determined in any one of a number of manners and this can include for example providing a list of available audio content to a user allowing a user to select respective audio content of interest. Once this has been completed, the computer system can then access the relevant file containing the first and second audio information.

At step 410, video information is determined. Again this can be achieved in any one of a number of manners but typically involves having the computer system generate a list of available video content allowing the user to select respective content with this being used to access the corresponding video information.

In one example, the video content would be in the form of a number of video content parts, such as edited video portions, that are intended to be combined in some manner. This could include, for example, editing video content parts recorded from different sources, such as multiple video camera positions, to provide a consolidated sequence of video footage. This is often used for situations such as sporting events, or the like. In this instance, it will be appreciated that the video content parts may be in different formats, and may require format conversion prior to editing.

At step 415 a representation of the video content and audio content is presented. This is typically achieved utilising a suitable Graphical User Interface (GUI) and an example of this will now be described with reference to FIG. 5A.

In this example, the Graphical User Interface 500 typically includes a menu bar 510 having a number of menu options such as “File”, “Edit”, “View”, “Window”, and “Help”. The user interface 500 includes a control window 520 which includes representations of a number of input controls, allowing the user to alter various parameters relating to either the video and/or the audio content. The manner in which these controls operate will depend on the preferred implementation and the nature of the editing performed and this is not important for the current example.

The user interface 500 typically includes a preview window 530 which allows the video content to be presented, with associated audio content also being provided via an appropriate output device, such as speakers.

The user interface 500 includes an editing window 540 which allows video and audio content to be edited. The editing window 540 generally includes a video representation 550 which is typically made up a number of video parts shown generally at 551, 552, 553, 554, 555, 556. The video parts may be determined in any suitable manner but are typically either indicated in the video information, as can occur if the video parts are identified during a recording process, such as the start and end of a particular video sequence, or maybe defined manually by a user, or a combination of the two.

In addition to this, the editing window 540 includes a second audio representation, representing the waveform of the audio content, and a first audio representation 570, representing the events defined by the first audio information.

Additionally, a slider control 580, including a position indicator 581, may be provided to allow the user to scroll through audio and video information presented in the editing window 540.

At step 420 the user selects an audio event in the first audio information. This can be achieved in any suitable manner, such as selecting the respective event utilising a mouse click or other suitable input command. Alternatively, the selection may be notional in that the user makes a selection, but does not identify this to the computer system. At step 425 the user selects a video frame or sequence of frames, and again, this may be achieved in any suitable manner, such as by selection of an appropriate video part.

In the event that the video part and audio event are explicitly selected through the use of appropriate input commands, the user interface can show an indication of this, as shown in FIG. 5A, in which the video part 555 and audio event 572B includes a border highlighting their selection.

At step 430, an editing process is selected, with this being performed at step 435. In one example, the editing process involves aligning the audio event with the video part, with this alignment being shown on the user interface, as shown in FIG. 5B, once the alignment has been performed.

The alignment may be achieved utilising a combination of manual and automotive processes. Thus, for example, if the user has made selections by designating the video and audio part in the representation, then the computer system can arrange to automatically align the video part with the corresponding event.

Alternatively, the user can then align the audio event and video part by simply dragging either one of the audio event or the video part into alignment. The computer system will then realign any other respective audio content and video content in accordance with the designation made by the user. The process of dragging the video part 555 and the audio event 572B into alignment can involve having the computer system attempt to snap the audio or video part into alignment with each audio event as the start of the corresponding audio event is reached, thereby assisting with the alignment process.

Alternatively, the editing could involve applying effects, such as increasing or decreasing the volume of the audio content, increasing or decreasing the playback speed of the video content and/or the audio content, or the like as will be appreciated by a person skilled in the art.

Accordingly, in this example, the user can selecting one or more events, and then apply effects to any audio content containing the events, or any video content associated with the events. Thus, for example, the user can select an event using an appropriate input device. The computer system then determines video content using either a recorded association between the event and any video content, or another indication, such as an alignment between the event and video content. Once the video content is determined, in this instance by the computer system, this allows the computer system to apply any selected effect.

It will be appreciated that in the above described examples, the events can be selected based on an event type or any other event criteria. Thus, for example, the user could select an event type, such as a chorus start, or a particular musical note played by a particular instrument. Having the user specify events based on criteria such as an event type, allows the computer system to identify all instances of events satisfying the criteria within the first audio information. The computer system can then identify all corresponding audio or video parts, allowing selected effects to be applied automatically.

At step 440 the computer system can optionally present the audio and video content in the preview window 530 allowing this to be reviewed by the user.

At step 445 it is determined if further editing is required and if so the process returns to step 420. Otherwise the process proceeds onto step 450 to allow the video and audio content to be encoded into a single file.

In one example, the video and audio content can include the video content and the audio waveform. Thus, the final file includes content based on the video information and the second audio information only. More preferably, however, the first audio information can also be included, so that events are also identified in the resulting file. This can be useful to perform further editing of the video and audio content, as well as to allow further manipulation of the content as will be described in more detail below.

As mentioned above, the process can also utilise first video information including events indicative of a number of events within the video content.

The events could be identified using either a manual approach in which a user identifies an event of interest and provides an indication of this to the computer system. Alternatively, the computer system may be able to detect some forms of event, such as pauses, transients, cuts between video portions, or the like, automatically, using a suitable video processing application.

In this example, the first video information can also be used in editing, for example by aligning events in the video content with events in the audio content. This could be performed manually, for example by allowing the audio and video content to be snapped into alignment. Alternatively, this could be performed automatically by aligning certain event types within the video with other certain events in the audio content.

Thus, for example, if a user is editing sporting video content footage to include audio content, the user may identify certain events in the video content, such as when a goal is scored. In this instance, the user may wish for a dramatic section of the audio content to align with the goal scoring event in the video content. Accordingly, the user can identify the previously marked goal scoring event, using the first video information, and then indicate to the computer system that this is to be aligned with audio content satisfying defined characteristics. The computer system can then identify one or more suitable audio events, and then align the corresponding audio content with the video content, using the corresponding audio and video event markers.

To increase the effectiveness of the alignment process, the first video information could include a time grid, such as a MIDI time grid, on which the events are aligned. The time grid would typically be set to have a given tempo, based for example on the tempo of popular music renditions, or selected by the user based on the nature of the video content. Thus, for example, an action video, such as a sporting video could have a high tempo, whereas other slower content would have a slower tempo. It will be appreciated from this, that when video content is to provided with associated first video information, the first video information will typically include two bits of metadata, namely a MIDI time grid, and video events markers positioned on this time grid.

This significantly assists with the editing process as it makes it far easier for users to subsequently mix video and audio information. For example, the audio information could be selected to have a similar tempo to the video content, with specific events in the audio content then be aligned with specific events in the video content.

It will be appreciated that the events in the first video information could include video edit points, such as locations at which there is a discontinuity between different video content parts, as well as any other information that might be useful for later editing, such as start and stop points for video effects, video effect type, or the like.

Accordingly, when editing video, the process could therefore include defining the video event markers. In general, the process would typically involve including as much information as possible as this would assist another person in performing editing, or attempting to re-render the edited video from scratch in the same fashion as MIDI can be used to re-render audio.

In order to re-render video from scratch, this would require that a file is provided including all the original video footage (with 10 seconds (or a suitable period of time) before and after each edited video part included to allow effects, transitions or the like to be applied between video parts. In addition to this, the file would need to include all video editing information including video edit points, video effect timing and type information etc. This would allow the video to be re-rendered based on the instructions contained in the file.

In this example, the actual effects applied when re-rendering the video may differ for those originally used, within the confines of the event markers. Thus, for example, an event marker may indicate that a transition is to be used between to video parts, but not specify the nature of the transition, such as wipe, fade or the like.

It will be appreciated that in this instance, the video edit is saved in a similar fashion to how it is temporarily saved during video editing, but in a standardised format thereby allowing edited video content to be shared between users. In this regard, this allows a user to produce a final edit of video content and forward this as a final file to allow viewing. However, this also allows others users access to the editing information, and in particular the video event markers, allowing other users to perform further editing, such altering the effects and transitions. This can be achieved by using effects and transitions based on those indicated in the event markers, so that transitions etc can be of the same type as those defined in the saved format.

However, in contrast to standard video editing techniques, the video event markers are provided in the form of a time grid, such as a MIDI time grid, appended to the finished video edit and all the other data is appended to that. In one example, the time grid is the same time grid as used for the audio data, and thus, in this instance, when video events are identified these are actually incorporated into the first audio information. In other words, the first video information can effectively form part of the first audio information and defines event markers for events in video content that is aligned with the audio content. However, this is not essential and the first video information may be stored together with the video content, in a manner analogous to creating a MIDI appended audio file.

In one example, when editing audio and video content, the user can therefore define a tempo for the video content, and identify any video event markers associated with the video content, thereby defining first video information. Once this is completed, the user can associate audio and video content, for example by selecting audio content having a similar tempo, and then aligning video and audio events, using the first audio information, as described above. Once this is completed, and the final edit is to be saved, the video events can be imported into the first audio information, so that the resulting file contains the video and audio content, together with first information containing both video and audio event markers.

It will be appreciated that in many instances, the audio content associated with the video content may include a number of different audio content parts, such as segments of different audio tracks. Accordingly, in this example, each different audio content part is typically associated with respective video content. Mixing event information could then be included in the first audio information specifying the mix points between respective audio content parts.

It will be appreciated that by providing a MIDI time grid and video events, this allows edited video to be provided to different users, allowing each user to attach their own mix of audio content using the above described techniques. This allows users to compare their different mixes to determine which has the best match to the video content. A wide range of other applications are also feasible.

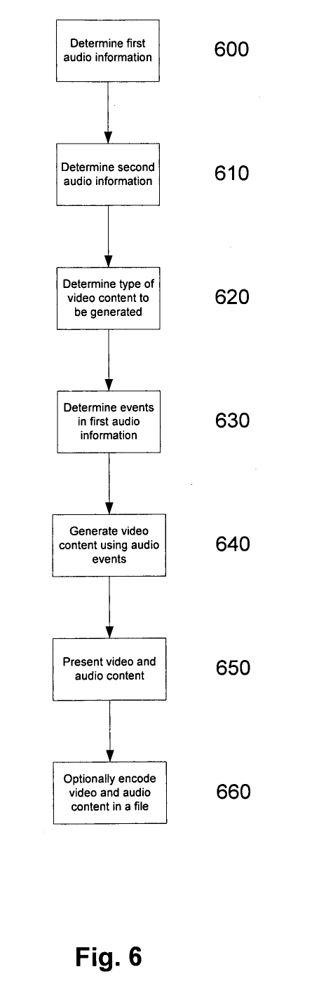

An example process for generating content using the computer system will now be described with reference to FIG. 6.

In this example, at step 600 first audio information is determined with second audio information be determined at 610. As described above with respect to FIG. 4, this can be performed in any suitable manner, but typically involves having the computer system display available audio content to a user. A user selects audio content of interest with this being used by the computer system to determine first and second audio information from a file representing the audio content.

At step 620, a type of video content to be generated is selected. This may include, for example, selecting a respective visualisation type from a list of available types displayed by the computer system, for example in a media player application.

At step 630, the computer system determines events in the first audio information. The manner in which this is performed may depend on the preferred implementation as well as the type of video content to be generated.

For example, certain visualisations may depend on certain audio event types. Thus, for example, a visualisation may be generated based on base notes, drum beats, guitar solos, vocal information or the like. Accordingly, at step 630 the computer system will typically determine those event types that are relevant to the particular content being generated and then examine the file to determine the location of each of these event types within the audio content.

In one example, the visualisation can include a number of components, each of which is controlled depending on a different event type. Accordingly, in this instance, the computer system may need to determine events of multiple event types.

At step 640 the computer system will then generate video content using the audio events. Thus, generation of the video content may include manipulating attributes of various components, such as the size, shape, colour or movement of different objects presented as part of the video sequence. Thus, for example, a sphere could be presented on the screen, with the size and surface shape of the sphere depending on the playback of base and drum beats. In this instance, each time a base or drum beat event occurs, the shape of the sphere is modified in accordance with a predetermined algorithm. In addition to this, the colour of the sphere could be affected by other events, such as the notes played by a lead or rhythm guitar. Additionally, either events might trigger other changes in the visualisation, such as changing the colour or appearance of other objects.

In another example, the components can include animations, or other similar representations of band members. The representations can include instruments for which corresponding events, such notes, are defined. The video content is then generated such that each band member appears to be playing the corresponding note that is presented as part of the audio content.

In one example, this can be used to provide a virtual band (actual 3D graphics software of band members and instruments) that each play their instruments exactly as they would in real life. This could be achieved using a suitable database of band members, allowing different styles of bands to be created. As actions of the members are controlled using the midi data, this would mean that the band could realistically play any song for which midi data is available.

Additionally, or alternatively, the characters can be stylized. For example, controlling complex sequences of drumming can be difficult when multiple drums are used. Accordingly, the drummer could be represented by a multi-appendaged character, such as an octopus, thereby avoiding the need to mimic the complex actions a human drummer undertakes when making a drum beat. For example, it could be difficult both to determine and then to simulate when a drummer is using both hands on a particular drum. One appendage per drum gets avoids this problem, although the drummer would drum in an unnatural fashion because drum rolls that would typically be done using two hands would be shown as being done with one hand (I.e. that hand would be moving faster than a human drummer ever could).

It will be appreciated by a person skilled in the art that this allows events to be used as input parameters for a video generation process. By allowing the different event types to be used as different independent inputs, this provides a greater degree of control over the visualisation that can be created than is currently possible when the visualisation is just based on audio waveform data. Additionally, analysis of the audio waveform data to produce a visualisation tends to be a complex process which can be avoided utilising the current techniques.

At step 650 the video and audio content are presented in synchronism, with the video and audio content optionally being encoded within a file at 660 to allow subsequent playback.

In the above examples, the video content can be encoded together with the first and second audio information. Inclusion of the first audio information allows interactions to occur during playback. Thus, for example, the user could select for certain interaction or modification to be applied when a certain event, or type of event, occurs. This can allow one or more events to be detected by the computer system, and applied during playback. For example, the user may select to distort the sounds of one of the instruments when a particular note is played. In this instance, the computer system, or other playback device being used to present the content, will examine the first audio data and detect the note in the first audio information. The computer system can then perform the distortion as the note is presented, in an appropriate manner.

A further option is to allow the user to interact with the video and/or audio content, based on the video content, again using events within the first audio information, or similarly, events within the first video information if this is present.

An example of this would be to allow users to interact with a number of different tracks simultaneously. In this instance, each track could be represented using video content generated based on the audio content, in the manner described above. Thus, this could include providing a display that shows a number of visualisations, or a number of components within a visualisation, each of which represents respective audio content, such as a respective audio track. Thus, for example, different tracks could be represented by respective shapes, or ‘blobs’ within a visualisation.

In this instance, the user can select one or more of the blobs, using a suitable input device, such as a mouse, or touch screen, causing the respective audio content to be presented. Another suitable command, such as increasing the size of the blob, could be used to adjust the volume of the respective track. Accordingly, this allows a user to perform mixing of audio tracks by interaction with visualisations of the audio tracks.

In one example, this process could be used in conjunction with a device such as a surface computer, which includes a large multi-touch screen. In this instance, different users could control the presentation of respective audio tracks, allowing the different users to dynamically mix the tracks.

In a further variation, the different audio tracks can represent different instruments within a single composition. This allows each user to feel as though they are controlling the respective instrument as part of a band. Again in this instance manipulation of the blobs can be used to modify the presentation of the audio content. For example, the screen could represent the space inside a 5.1 speaker setup, allowing users to position the particular blob where they want the source of the instrument to be represented in the speaker space.

Similarly, it will be appreciated that the techniques could be used to manipulate video and audio content parts, such as different audio parts/bars/phrases, or any other portion of the audio, in a similar manner to the use of “Reactable”.

Further manipulation can also be performed by identifying specific objects within video content, if these are treated either as events, or respective video portions. For example, a user could touch the drum set on a music film clip and manipulate its sound using a pop-up control set. This is particularly applicable in situations in which the video content includes multiple parts, each corresponding to a respective instrument, which is prevalent with DVDs, which often include multiple camera angles from a live music event, with each camera angle being included on the DVD and focusing on a respective band member.

Another option is for the video content to include video content parts that act as an overlay, and are presented on top of other video content parts. This allows the overlay content parts to function as input controls, allowing the user to interact with the video or audio content.

A further option is for either video or audio events to be used to trigger external actions. Thus, for example, the first audio or first video information could be used to trigger external events in a sequence that matches the audio or video events.

An example of this, is the control of a fireworks display. In general, this is normally achieved by having an operator manually define a timeline for activating specific fireworks events, based for example, on a user's perception of events in an audio waveform, and manual recording of the event within the waveform. However, by including the first audio information, this would allow the process to be automated to a large extent.

Thus, for example, the user can select a type of audio event and a corresponding firework event, allowing a computer system to automatically align subsequent firework events with similar audio events. In this instance, when the audio content is presented, then the computer system would detect the events within the first audio information, and use this to trigger the activation of the respective firework.

It will be appreciated that fireworks is an example, and the process could be used to match the timing or even trigger any sequence of external events, such as light shows, or the like.

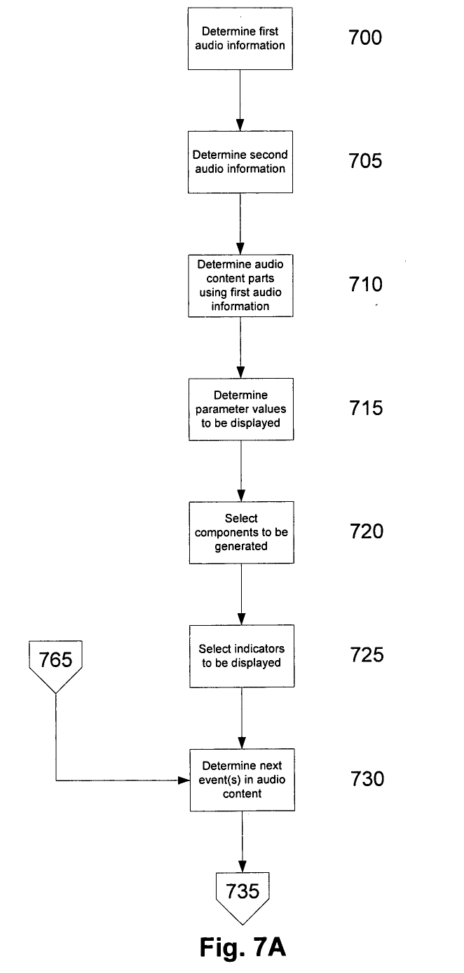

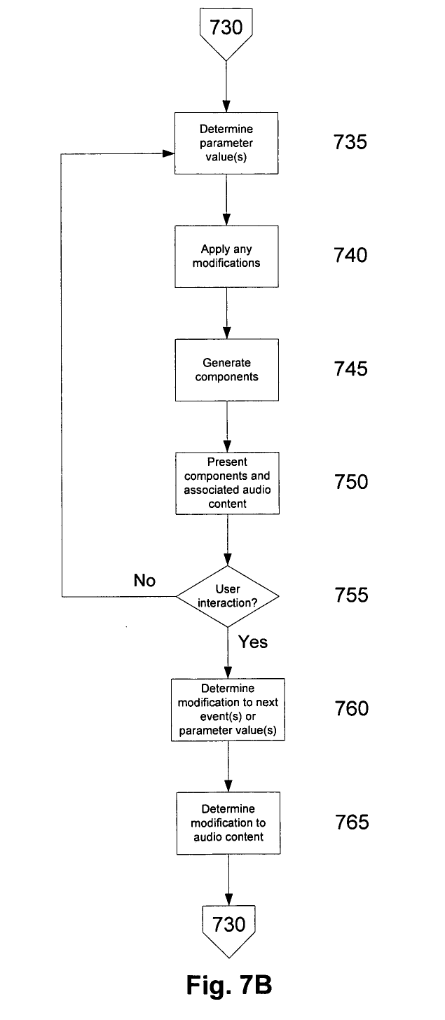

An example of a process for presenting audio and video content to allow modification of the audio content presentation will now be described in more detail with reference to FIGS. 7A and 7B.

At step 700 the playback device determines first audio information, with second audio information being determined at step 705. This is typically achieved by having the playback device access a single computer readable file containing both the first and second audio information. In one example, the file can include the audio content in MP3 or another similar format, with the file including additional meta-data representing the first information. The files may be generated in any suitable manner as described for example in more detail in co-pending application No. PCT/AU2008/000383.

The audio information may be determined in any one of a number of manners and this can include for example providing a list of available audio content to a user allowing a user to select respective audio content of interest. Once this has been completed, the playback device can then access the relevant file containing the first and second audio information.

At step 710, the playback device determines the audio components using the first audio information. At step 715 the playback device determines parameter values associated with the audio content and/or each audio component, such as the tempo, volume, mix level, fade, equaliser settings, or any other audio effects. The parameter information is typically provided as part of the first audio information, and may therefore be appended to specific MIDI tracks, or the like. Some parameters may remain constant over time, others may vary throughout the song, and some may repeat over bars or groups of bars (such repetitions are commonly called parameter ‘sweeps’).

At step 720 the playback device uses information regarding the audio components to select the video components to be generated. Similarly, at step 725 the playback device uses an indication of the parameter values to determine indicators that should be displayed at step 725

In this regard, the video components generated may depend on certain audio components, with respective video components being provided for base notes, drum beats, guitar solos, vocal information or the like, and accordingly, the playback device uses this information to determine the video components to be generated.

The video components generated may also depend on a visualisation type selected from a list of available types by the playback device, or a user. There may be provision such that users can generate custom video components themselves. For each type of visualisation, a definitions file could be used to define the details of each video component to be used for each possible type of audio component. Thus, for example, video components having different appearances may be used to represent different instrument and/or vocal tracks.

The definitions file may also specify the indicators that can be included on the video components. The indicators may also be determined at least partially based on the parameter values or events that are specified in the first audio information. Thus, for example, the playback device will not generate indicators if the respective information is not available. Additionally, and/or alternatively, the indicators that are displayed can be selected by the user, for example by allowing a user to drag and drop indicators onto the video components within a visualisation. Examples will be described in more detail below.

At step 730, the playback device determines next events in the audio content using the first audio information, before determining any parameter values associated with the audio content presentation at step 735, which can be defined based on playback device settings, and/or the first audio content.

At step 740, the playback device applies any modifications to the parameter values and/or events, as will be described in more detail below.

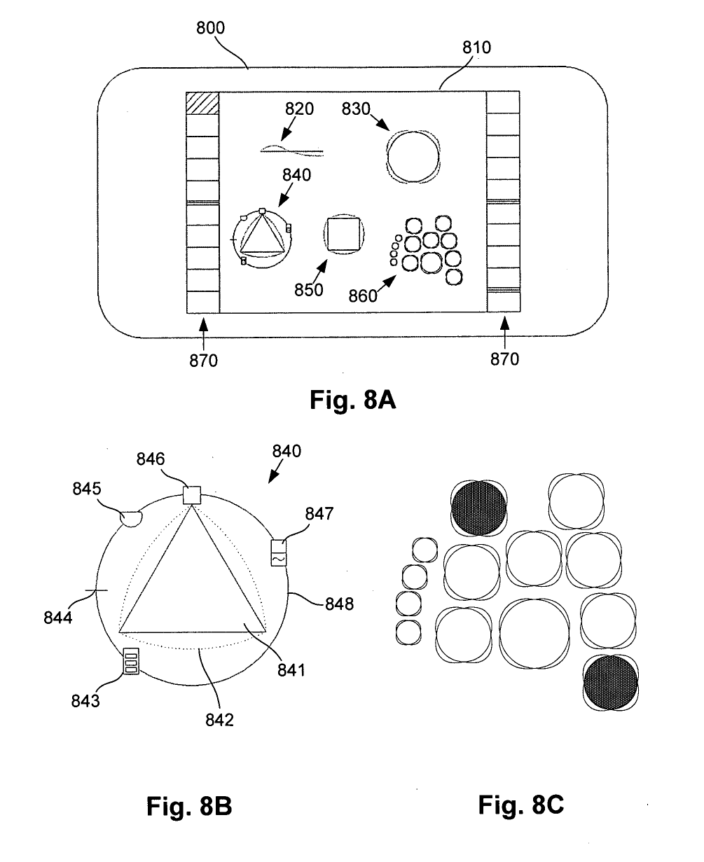

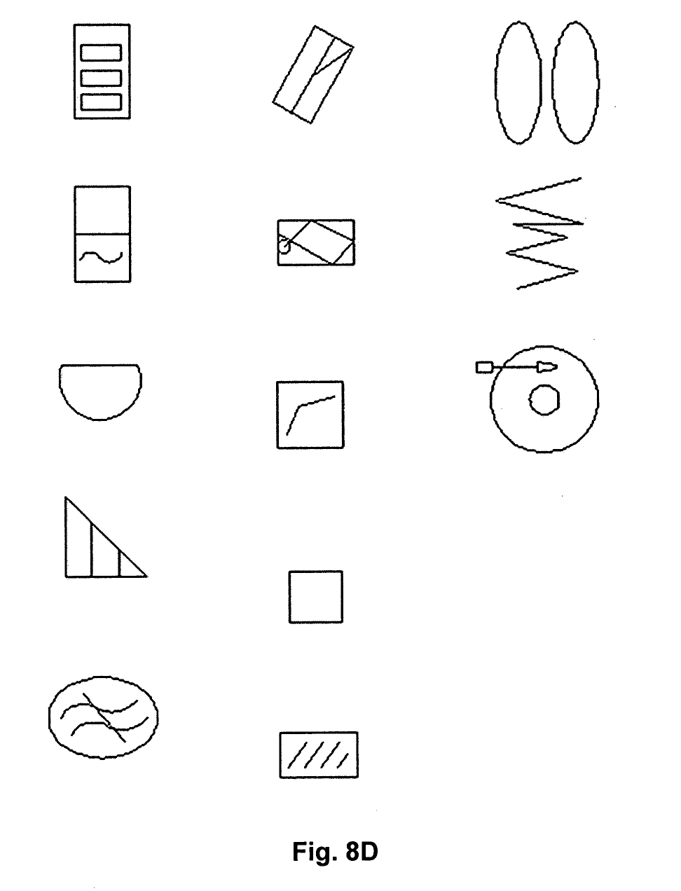

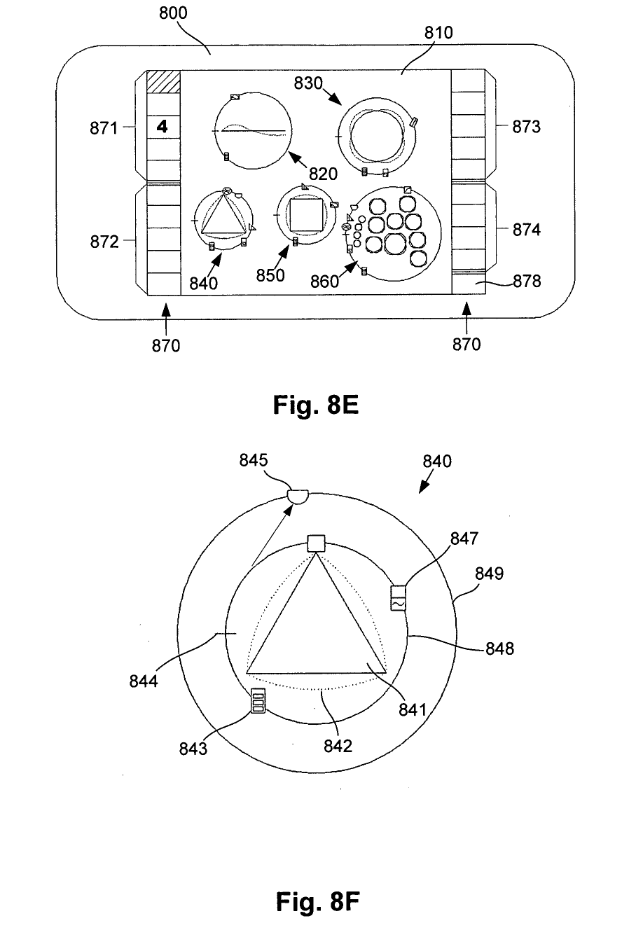

At step 745, the playback device generates the video components, which are then presented to the user together with the audio content. An example of the appearance of a user interface including a number of different video components will now be described with reference to FIG. 8A.

In this example, the playback device 800 includes a touch screen 810, which acts to display a user interface including the visualisation, and in particular the video components. Additionally, the touch screen 810 can be used to allow a user to provide input commands.

In this example, the screen includes five video components 820, 830, 840, 850, 860, which are used to represent respective audio components. It will be appreciated that the example video components are for the purpose of illustration only and are not intended to be limiting. The screen 810 may also include side bars 870 that display additional information or controls, as will be described in more detail below.

In this example, the video component 820 displays a graphical representation of an audio waveform that has an appearance based on the waveform of all or a component of the audio content. This, in one example, this could be used to represent the overall audio content, in which case the waveform will simply represent the audio waveform stored in the second audio information. Alternatively however, this could represent an audio component, such as a vocal track, or the like.

The waveform video component 820 can be generated directly based on the waveform data stored in the second audio information. However, this is not essential, and particularly if the waveform is representing an audio component other than the entire audio content, it may be difficult to extract a respective waveform from the second audio information. Accordingly, alternative the waveform may be simulated based on events in the first audio information.

In the above examples, the video components 830, 840, 850 include a shape, whose size alters in accordance with the occurrence of audio events. In one example, the video components 830, 840, 850 are indicative of respective musical instruments, such as guitars, keyboards, or the like, with the shape changing each time a note is played by the respective instrument. It will be appreciated that in this example, as notes for each instrument are specified separately in the first audio information, it is easy for the playback device to analyse the first audio information, determine when a note is to be played and modify the appearance of the shape within the respective video component accordingly. This same process applies to parameter tracks associated with and applied to MIDI tracks containing said notes.

The video component 840 is shown in more detail in FIG. 8B. In this example, the video component 840 includes a shape in the form of a triangle 841. An extent of the shape modification that can occur is shown by the dotted lines 842, highlighting that in this example the sides of the triangle can bend outwardly when a note event occurs. Additionally, and/or alternatively, the colour of the shape 841 may also change. The magnitude of any movement or other change can also be based on parameters relating to the note, such as the amplitude, pitch or the like, so that changes in the visual appearance of the video component are indicative of the note being played.

In addition, the video component 840 includes a number of indicators 843, 844, 845, 846, 847, positioned on a parameter circle 848. The indicators represent respective parameters or events, and example indicators are shown in FIG. 8D. These can represent respective parameters, such as: mix volume, cut-off frequency, resonance, delay (echo), distortion, overdrive, reverb, compression, surround position, phaser, tempo, ad lib, scratch, or the like. In this example, the relative position of the indicator is indicative of a parameter value or value associated with the event. Thus, for example, the position of the indicator 843 could indicate the mix volume of the respective audio component.

The video component 860 is shown in more detail in FIG. 8C. In this example, the video component 860 has the appearance of a drum kit, and is used to represent drum notes. In this instance, as shown in FIG. 8C, respective ones of the drums can be highlighted to represent the drum notes currently being played.

In the example of FIG. 8A indicators are provided for the video component 840 only. However, this is for the purpose of illustration only, and is intended to highlight that indicators are not required. Alternatively, however, as shown in FIG. 8E, indicators may be provided for each of the representations 820, 830, 840, 850, 860.

At step 750 the video and audio content are presented in synchronism, so that the video events are presented in time with corresponding audio events.

During the playback process, at step 755, the playback device detects any user interaction with the video components. The user interaction may take any one of a number of forms depending on the implementation and the nature of the video components.

For example, in the case of the representation 840, the user can drag one of the indicators 843, 844, 845, 846, 847 to a different position on the circle 848. This in turn allows the playback device to determine a change in a corresponding parameter values, and hence a modification that needs to be implemented during the playback process. In one example, this can be achieved via the touch screen 810, although this is not essential, and any suitable input technique may be used.

During movement of the indicator, the playback device may modify the appearance of the video component, to assist the user in controlling the movement. For example, as shown in FIG. 8F, as the user selects the indicator 845, they can drag this outwardly from the video component 840, causing a second circle 849 to be shown. The second circle has a larger radius, allowing the user greater control over the positioning of the indicator 845. In this example, once the indicator 845 is positioned and released by the user, the playback device will display the indicator 845 on the parameter circle 848, in the modified position.

In addition to interacting with the indicators, it can also possible to interact directly with the video component itself. For example, in the case of the video component 860, the user can select one of the drums in the drum video component, indicating that an additional respective drum beat is to be added to the audio content to be presented.

If no user interaction occurs, the process continues to repeat steps 730 to 750 allowing the video and audio content to be presented. Thus, the playback device determines the next audio events in the audio content, and uses this information to update the representations. As part of this process, the positions of indicators may vary automatically as parameter values associated with the audio content vary, or as events occur, whilst the shape, position, colour, or other aspects of the visual appearance of the video components may also alter as required.

In the event that user interaction is detected, then at step 760, the playback device determines corresponding modification that is required to either the parameter values, or the events. Thus, in the example of the drum beats, this will include determining new drum beats to be played, whilst in the case of adjusting the indicator 845 above, this can correspond to changing a parameter value, such as a resonance amount. Additionally, the modifications can include applying alternative preset parameter values, or the like.

At step 765, the playback device determines any modification that is required to the audio content, and in particular to the audio waveform. Thus, for example, if a new drum beat is to be added, this may require that a waveform representation of the drum beat is incorporated into the content waveform. In one example, the added drum beat could be generated based on the midi data, alternatively however, this could be isolated from another part of the waveform data, as will be described in more detail below.

The process then returns to steps 730 and 735, to determine the next audio events and parameter values for the next section of audio content to be presented. However, in this example, at step 740, the default parameter values and/or events for the audio content presentation are modified in accordance with the modifications determined at step 760. As a result, the parameter values used in presenting the audio content and/or events in the audio content are based on a combination of the original parameter values and/or events, and the modifications made by the user. Consequently, when the video content is generated at step 745 and presented together with the audio content at step 750, the content reflects the changes caused by the user interaction.

Accordingly, the above described process allows audio content to be presented together with visualisations. The audio content is represented by first and second audio information, with the first audio information being used to allow a structure of the audio content, including the timing and types of events to be determined, and the second being used to allow playback of the original audio content. This can be used to generate the visualisations allowing the visualisations to include video components representing respective types of audio content, such as different vocal or instrumental tracks within the audio content, with the appearance of video components being modified in accordance with the occurrence of events.

Additionally, the video components can be used as input controls, allowing either parameter values associated with the audio content to be altered and/or to allow modification of the audio content.

Examples of further features will now be described.

In the examples of FIGS. 8A and 8F above, the side bars can be used to display control inputs, or information relating to the playback process.

In one example, the side bar includes four sections, 871, 872, 873, 874. The top left group of buttons shown at 871 is representative of the different sections of the song (from top button to bottom button). The sections of the song could include any grouping of video components, such as bars, or the like. Thus, for example, the groupings could represent the chorus, versus, instrumental sections, or the like. In one example, the side bar section 871 includes a counter that counts down the number of bars until the next group of video components will appear on screen. If there is no user input this will go on through the groups of video components from top to bottom until the song is finished.

In general, the side bar section 871 can be manipulated by the user, for example to scroll up and down the video component groupings to allow different sections of the relevant song to be viewed. This provides a user with an easy method of interaction with audio content. For example, this allows the audio content to be played normally, with each section being presented in turn, whilst allowing the user to view when the next section is to be played, allowing the user to modify and/or control the presentation of the next section to be played. Alternatively, the user can jump ahead in video component groups and modify parameters.

The side bar section 872 can be used to display a list of the different parameter groups (including parameter changes over time) that correspond to each of the video component groups in the side bar section 871. The user can drag different parameter groups into the screen area and incorporated into the playback process. For example, a user can generate what will sound like original mixing just by applying the parameter set over time that would normally be applied to the bass track, to the guitar track.

The side bar section 873 is a list of preset parameter groups and their values over the preset time (say 4 bars), whilst the side bar section 874 lists the various parameters so a user can drag and drop particular individual parameters into interface, allowing these to be controlled. A single control button 875 may also be provided, to allow the side bars to be toggled between the mode shown and an alternative control move in which play, stop, pause controls are presented, as will be appreciated by persons skilled in the art.

In one example, the user can select to modify the parameter values completely manually. In this instance, the playback device will typically initially implement default parameters instead of those provided in the audio information. As part of this process, the playback device can compare parameter values defined by the user to those defined within the audio content, and provide an indication in the event that the user defined and audio content parameter values agree. This could be achieved for example by highlighting the respective indicators, for example by causing the indicator to flash. This can be used to allow users to control the presentation of the audio content in an attempt to simulate the actual audio content, and determine how accurately the parameter values are controlled, thereby allowing the user to assess their ability to control the audio content presentation in real time.

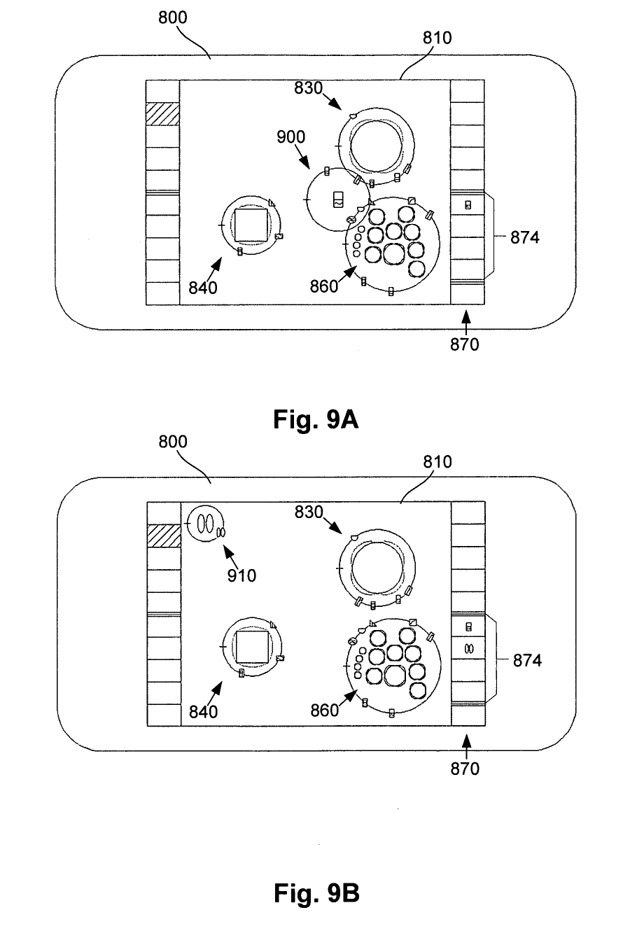

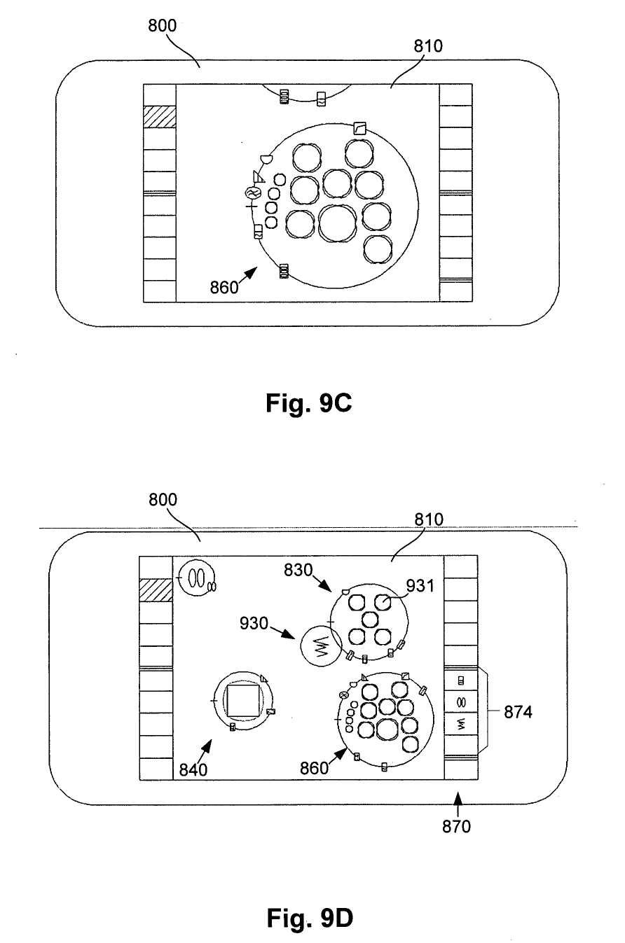

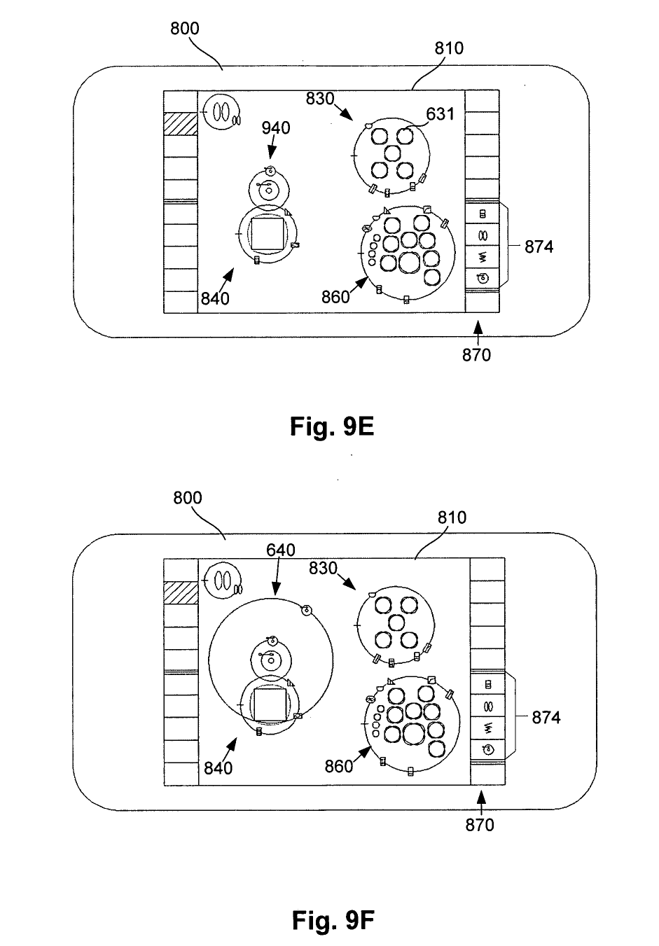

A further example will now be described with reference to FIG. 9A. In this example, the screen 810 displays a user interface including only three of the video components 830, 840, 860, for the purpose of clarity only. Parameters that can be controlled are displayed on a side bar 870, as shown at 874. This allows respective parameters to be dragged and dropped onto respective video components, allowing the parameter values associated with that corresponding audio component to be controlled.

In this example, a parameter indicator circle 900 is shown. If a user wishes to apply a parameter value to more than one type of audio content at the same time, the user can drag and drop the parameter to a suitable position on the user interface so that the parameter circle 900 touches the “parameter circles” of the video components 830, 860, thereby causing the parameter values to be applied to the corresponding audio components.

Alternatively, as shown in FIG. 9B, if a parameter indicator circle 910 does not touch any of the video components 830, 840, 860, then this can be applied to all of the audio content, allowing parameters of the overall content to be controlled in addition or alternatively to controlling the parameters for the different audio components independently.

In use, the user can also use other input commands to alter the appearance of the user interface. This can be used for example to zoom in on respective ones of the video components, to thereby provide greater control. An example of this is shown in FIG. 9C, in which the view is zoomed and centered on the drum video component 860. This is particularly useful when using the representation 860 to effectively add drum beats to the audio content.

The drum beats could be generated directly from the midi information in the first audio information, using the midi commands. However, in one example, as described in more detail below, the audio waveform can be analysed to isolate individual drum beats when other instruments are not playing. Individual waveforms of each drum beat can then be extracted from the audio waveform, and then a respective one of these is played when the user creates an additional drum beat. In this way, the generated audio reflects the actual instrument used by the band playing the music audio content, and is not an artificially generated drum beat.

In general, the other video components are not displayed in a manner that allows users to manually add notes such as drum beats. However, this could be achieved by providing an ad-lib parameter indicator, an example of which is shown in FIG. 9D. In this example, when the ad-lib parameter indicator 930 is dragged and dropped onto a video component 830, the appearance of the video component can be modified to define inputs 931 similar to the drums of the drum video component 860.

In this example, five ‘notes’ are shown to reflect the fact that the original track includes five notes/chords played in the particular track. As a result, when the user is ad-libbing, the user will select from the original five notes/chords and will therefore be adding notes/chords that are not only in key, but also correspond to the notes/chords used in the original track. This allows allow the user to generate notes/chords for the respective audio component, with the new notes/chords being of a form used in the original audio content, so that the added notes/chords fit in with the original audio content. Again, these may be generated based on either the midi data, or isolated portions of the audio content waveform. As an alternative to using the video components to performing ad-libbing, this could also be implemented using other input techniques, such as by a motion sensing module in the playback device used, or the like.

In the example of FIG. 9E, a scratch indicator 940 is dragged and dropped onto the video component 840. This allows to ‘scratch’ different audio components, either by moving the scratch indicator, or by using another input control, such as a motion sensing system to detect movement of the playback device.

In the case of scratching by finger the scratch parameter indicator is very intuitive to use. The scratch parameter symbol revolves around the parameter circle (from 0 to 127) once every bar of time. To scratch a user simply need touch the circle at any point and move it back and forth. In one example, the symbol and circle act as a turntable would in real life. However, in one example, the scratch parameter is arranged so that a single revolution equals a single bar multiple of time, as set by the user. Thus, for example, a single revolution of the scratch parameter around the parameter circle could equal 1 bar, 2 bars, 4 bars or the like, with the default generally being a single bar. The scratch indicator 940 can be increased in size prior to, or during scratching, as shown in FIG. 9F, allowing the user to implement more precise control.

It will be appreciated from the above, that the use of video components allows different audio components, such as vocals and instruments to be independently controlled. Furthermore, by allowing different parameters to be controlled through the use of appropriate indicators, further control can be achieved.

Additionally, the video components can be used to assist with performing mixing. In this instance, video components can be displayed representing different music tracks to be mixed. Thus, for example, a user can be listening to a first track and use the video components associated with a second track to mix this into the first track. By displaying video components for different portions of the track, this allows a user to visualise the mixing process, making the process more intuitive, particularly to novices.

For example, the visualisation can include video components that provide information regarding the tracks being mixed, such as the album cover, the name of the song, or the like. In one example, video components from each track are shown, with the video components merging as the track is mixed, thereby allowing third parties to view the mix. Alternatively, the video components associated with one track could be morphed into the video components associated with the other track as the tracks are mixed. As an example, the background colour associated with each track could be different, so that as a second track is mixed into a first track to replace the first track, the colour associated with the first track will change to that associated with the second track as the mix progresses. This allows the third parties to see the transition between tracks using the visualisation.

The use of visualisations can also have particular application when it is desired to mix music without the ability to hear one of the tracks being mixed.

It will be appreciated that the visualisations may be in any form, and that the use of shapes is for the purpose of example only.

In another example, the video components can include animations, or other similar video components of band members. The video components can include instruments for which corresponding events, such notes, are defined. The video content is then generated such that each band member appears to be playing the corresponding note that is presented as part of the audio content.

In one example, this can be used to provide a virtual band (actual 3D graphics software of band members and instruments) that each play their instruments exactly as they would in real life. This could be achieved using a suitable database of band members, allowing different styles of bands to be created. As actions of the members are controlled using the midi data, this would mean that the band could realistically play any song for which midi data is available. Track parameters can also be visualized in this setting, for example, ‘wah wah’ being applied to the guitar could result in the guitarist lifting the neck of the guitar to a level matching the level of applied ‘wah wah.’

Additionally, or alternatively, the characters can be stylized. For example, controlling complex sequences of drumming can be difficult when multiple drums are used. Accordingly, the drummer could be represented by a multi-appendaged character, such as an octopus, thereby avoiding the need to mimic the complex actions a human drummer undertakes when making a drum beat. For example, it could be difficult both to determine and then to simulate when a drummer is using both hands on a particular drum. One appendage per drum gets avoids this problem, although the drummer would drum in an unnatural fashion because drum rolls that would typically be done using two hands would be shown as being done with one hand (i.e. that hand would be moving faster than a human drummer ever could). These visualizations could also be used as a user input/control method.

In a further example, the visualisations may be used in a similar manner to generate audio content. In this example, the playback device can generate default video components representing respective instruments, with each video component including inputs allowing notes to be generated. By interacting with the visualisations, the user is able to define sequences of notes and mix these together to form music. Thus, for example the user could define a drum beat, and then guitar solo, mixing these together to form a music piece.

In this instance, the first and second audio content used to present the audio content could include definitions of different notes that can be generated, and corresponding segments of audio waveforms, allowing the notes to be subsequently played.

Examples of further features will now be described.

In the above described examples, the first audio information includes events that allow a representation, such as a reproduction, of the audio content to be generated. However, additionally, the process can utilise video event information that is indicative of events within the video content. In this example, the video event information can be indicative of timing data, marking data, chapter information, or the like. It will be appreciated that the techniques can therefore be applied to the use of video event information in a similar manner.

In the examples above, the first and second audio information may be obtained from separate sources, such as respective files. More typically however, the first and second audio information are provided in a common file. This can be achieved in any suitable manner, such as by appending an existing music file with additional meta-data indicative of the first information.

The common file can be created using any suitable technique, so for new music, this might include generating appropriate first audio information when the music is originally recorded to thereby generate the second audio information.

Alternatively, this can be achieved by retrofitting an ‘original’ waveform song (such as an MP3 file) with MIDI (or other digital music encoding format) and other optional data. The resulting file is known as a ‘retrofile’ file format, and allows additional video and interactive music functionality (hereafter called retrofile functionality) than can be achieved with the audio waveform alone.

A retrofile in its most basic form is essentially a waveform song (with included metadata such as in an MP3 file) retrofitted with an appended MIDI time grid. The MIDI time grid can then be further appended with the MIDI score of the song. The MIDI time grid must be properly and synchronously appended in order that the MIDI version of the song can be properly overlaid. If the waveform and corresponding MIDI version of the song are properly synchronized with the waveform song, the waveform song can be manipulated by manipulating the MIDI time grid and score and letting the ‘audio follow the MIDI.’ This means also that a playback device need only ‘process’ and communicate in MIDI.

It will be appreciated that the first audio information can be used at least in part in generating the components in the visualisations. In particular, this is required for determining the number of audio parts, and optionally, the type of each audio part, and hence the nature of the representation that should be displayed. Thus, for example, on determining the presence of drum events in the first audio information, the playback device will determine that a drum component should be displayed.

Additionally however, the file containing the first and second audio information may include additional visualisation data, specifying different details for the visualisation. This can define the components that should be displayed, as well as to provide specific interactivity custom defined for the respective audio content. This can allow bands to supply custom visualisations associated with their songs, with the visualisation being indicative of the band in some manner, such as including the band name of logo.

Similarly, the file might also include video information. In one example, the video and audio content are provided as part of an existing encoding protocol, such as MP4, WAV, or the like. Again, in this instance, data representing the first audio information can be appended to the video and audio data.

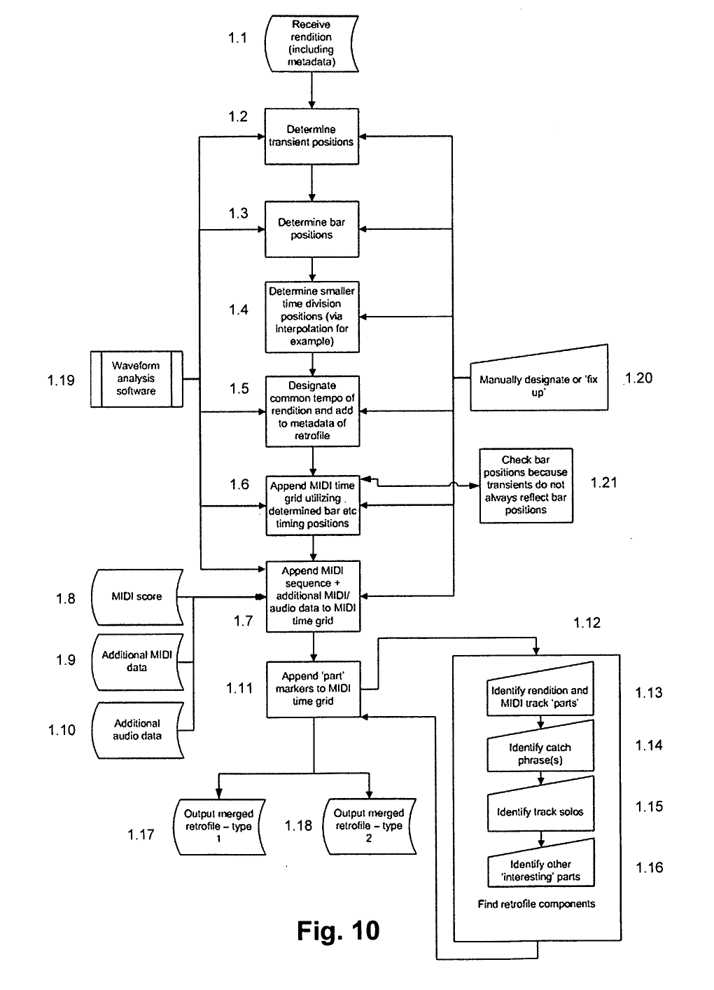

An example of the process for creating a retrofile will now be described with reference to FIG. 10. For the purpose of this example, the file is assumed to be audio only. However, it will be appreciated that this technique may also be applied to combined video and audio content in a similar fashion, allowing first audio information to be created, based on the combined audio content and video or representation content. Additionally and/or alternatively, equivalent first video information could be created in a similar manner.

1 . . . Receive an audio rendition such as an MP3 file 1.1.

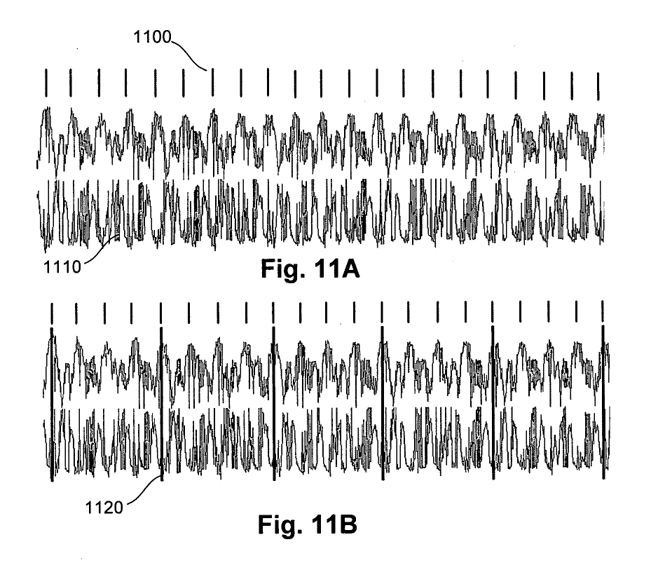

2 . . . Determine transient positions 1.2. Analyze the audio file using waveform analysis software 1.19 to determine the position of transients in the waveform. An example of detected transients utilizing waveform analysis is shown in FIG. 11A. In this example, detected transients 1100 are shown as vertical bars above a corresponding waveform 1110.

3 . . . Determine bar positions 1.3. Utilize the transient positions to determine the bar start/end positions of the rendition. If the rendition is tempo-consistent as in FIG. 11A, this process is easier as one bar position can be found and the rest extrapolated. This process could at the current time largely be undertaken by software. An example of this is shown in FIG. 11B. In this example, the bar positions 1120 are fairly easily determined (even by eye) and as soon as the start and end position of one bar has been determined the rest can be extrapolated.

If the rendition is not tempo consistent, has purposeful tempo changes throughout it or the waveform analysis software provides results of little use however, it is likely many bar positions will need to be determined individually and manually 1.20. In this example, human input is used to provide error correction of software analysis of bar position or human input determining bar position without the aid of waveform analysis software 1.20.

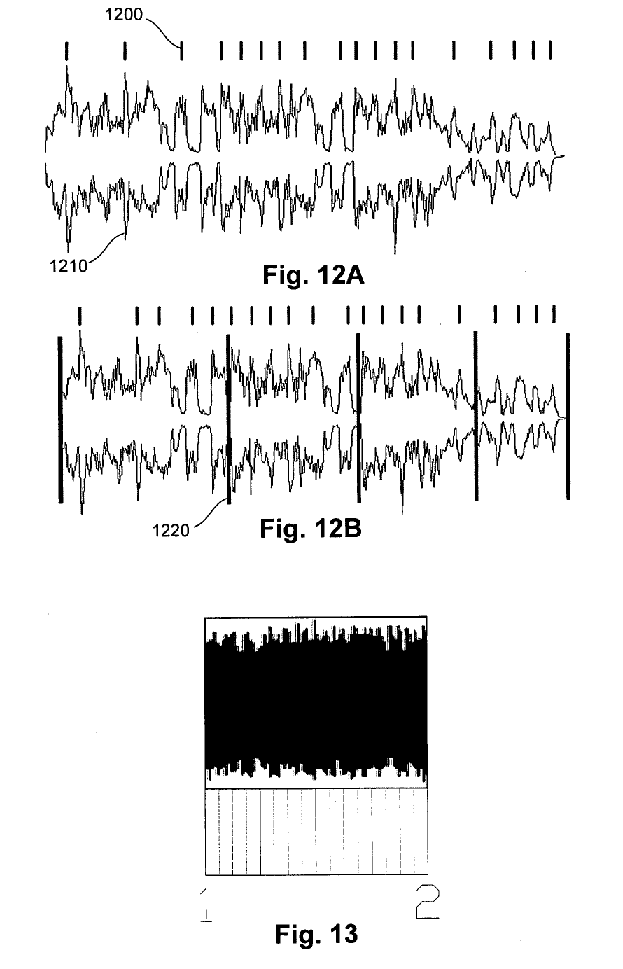

An example of a waveform that may prove difficult for waveform analysis software to accurately determine bar positions is shown in FIGS. 12A and 12B. The waveform 1210 is shown with transient detected positions 1200 in both FIGS. 12A and 12B. The correct bar positions have been appended as black lines 1220 in FIG. 12B highlighting the bar positions not only do not match the detected transient positions but are not uniform in separation.

4 . . . Determine the time grid between bar positions—to 1/16's for example 1.4. This process would in the vast majority of cases be as simple as interpolating smaller divisions between bar position determinations (such as 1/16's and 1/64's etc) however in some circumstances the grid may need to be corrected at this fine level manually 1.20 to some degree or via analyzing the results of waveform analysis software 1.19 due to errors in the recording of the original rendition for example. FIG. 13 shows an example of a waveform bar with interpolated divisions to 1/16's once bar positions (1 and 2 in this case) have been determined.

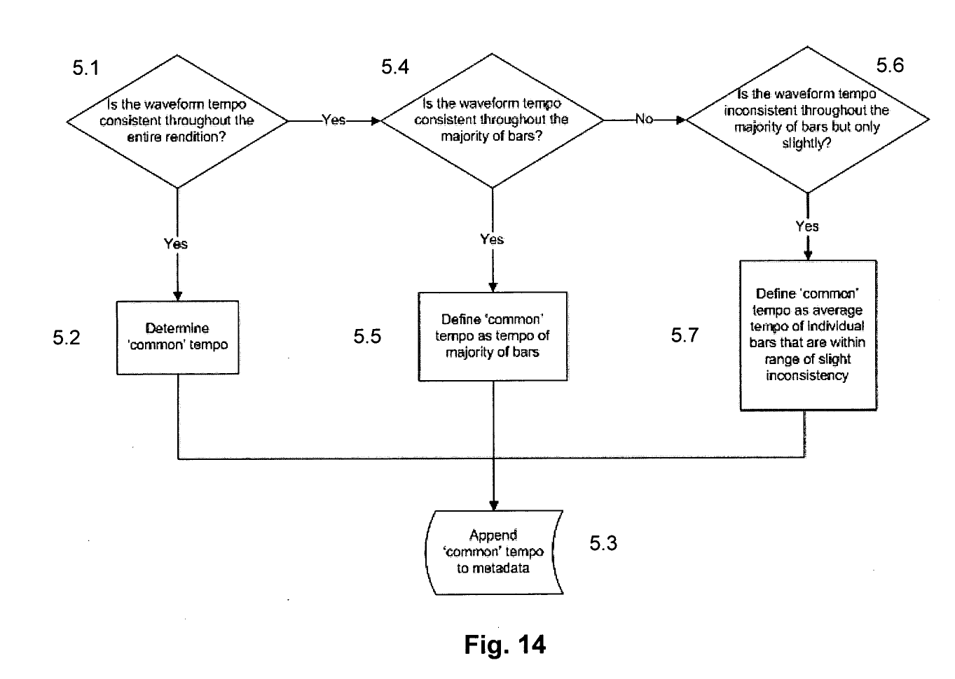

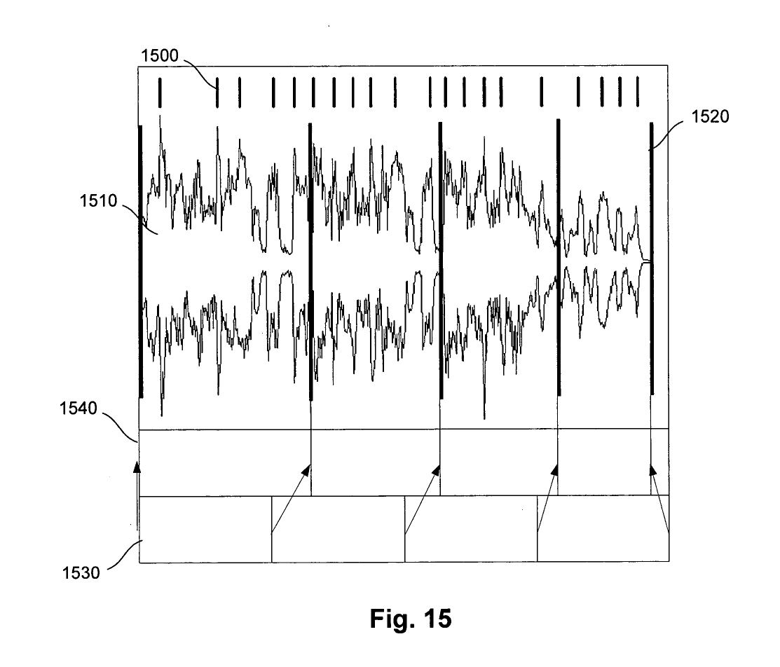

5 . . . Designate a ‘common’ or average tempo of rendition and add to metadata of retrofile 1.5. This is a tempo derived from the most commonly used and consistent tempo in the waveform file (I.e. some songs may have a tempo change somewhere in them but are otherwise consistent)—the ‘common’ tempo, or the average tempo of a rendition with slightly inconsistent tempo (such as a rock and roll song not recorded in time to a computer for example) is designated as the ‘common’ tempo. This process is shown in FIG. 14.

If the waveform tempo is consistent throughout the entire rendition 5.1 the common tempo is determined as that particular tempo 5.2 and appended to the metadata 5.3. If the waveform tempo is not consistent throughout the entire rendition 5.1 but is consistent throughout the majority of bars 5.4 (E.g. the song may have a ‘break’ section where the tempo changes but other than that the tempo is consistent) the common tempo is defined as the tempo of the majority of bars in which the tempo is consistent 5.5 and appended to the metadata 5.3. If the waveform tempo is slightly inconsistent throughout the rendition 5.6 (such as in a rock and roll song not recorded to a metronome) the common tempo is defined as the average tempo of individual bars that are within range of slight inconsistency 5.7 (meaning that such a song may have a ‘break’ where it departs from the main average tempo and these bars are ignored) and then appended to the metadata 5.3.

The purpose of finding a common tempo and appending it to the metadata of the retrofit file is that upon playback such information can be used by a file search filter, TCEA or collaboration process to determine a likely ‘tempo fit’ between two songs. It also provides a user with this knowledge for any purpose.

6 . . . Append a ‘MIDI time grid’ to the audio rendition in synchronous fashion 1.6. A MIDI time grid must be accurately mapped onto the waveform. This process entails appending the determined bar positions found using waveform analysis software 1.19 and/or human 1.20 input with MIDI bar positions. An example of this process will now be described with reference to FIG. 15.

In this example, a waveform 1510 is shown with transient detected positions 1500 and correct bar positions 1520. A tempo consistent MIDI timeline would normally have consistent bar lengths like those shown at 1530. However when appended to a waveform song with inconsistent bar lengths the bar positions are appended to wherever the particular start/end of the waveform song bar is located and may therefore differ in length like the MIDI bars of shown at 1540. The process of appending a MIDI time grid also entails appending smaller time divisions such as 1/16's, 1/64's etc. Similarly to the case for MIDI bars appended to the waveform song it may be the case that appended smaller time divisions such as 1/16's are of differing lengths.

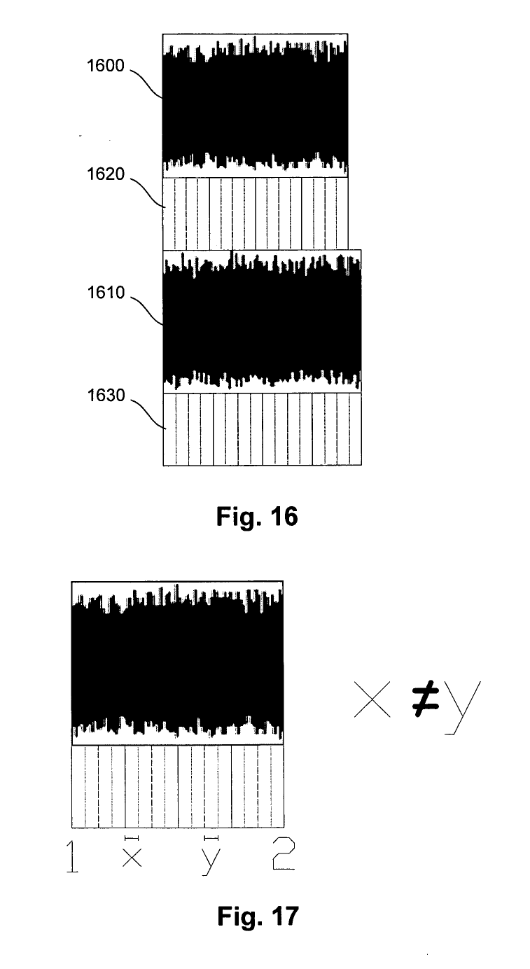

In a retrofile, MIDI data is appended to the waveform song to match the time elements of the waveform song regardless of the placement of these events as to ‘true’ time. It must be the case that MIDI bar 21 (for example) starts at exactly the same moment as waveform song bar 21. Two bars of a particular waveform song may be of slightly different tempos and therefore play for slightly different amounts of time, however when appended with a MIDI time grid both bars are appended with 1 bar of MIDI time. An example of this is shown in FIG. 16, in which two waveforms 1600, 1610 are shown, each appended with 1/16 divisions 1620, 1630 representing one bar.

This type of MIDI time grid matching must occur on all scales—from the arrangement timing level right through to bars, beats, 1/16's and 1/64's etc and may require human input 1.20 as well as computer analysis 1.19.

FIG. 17 illustrates MIDI time grid matching such as in FIG. 15 at the small scale and shows 1 bar of a waveform song appended with MIDI. Two ‘lengths’ of waveform song time are shown; x and y. Both x and y are 1/16's of a bar. Although both x and y are 1/16's in terms of the timing of the waveform song, they are not actually the same length of true time (I.e. one 1/16 of the waveform is slightly longer or shorter than the other). The appended MIDI must take this account, and exactly match the waveform song; therefore MIDI 1/16's x and y also do not equate to each other in length. This is to make up for variations in the waveform song at the bar/note event level.

It is the case however that tempo inconsistencies at smaller time divisions (such as 1/16's) would be rare and hard to detect by ear in any case so in the vast majority of circumstances as long as the MIDI bars are appended to the waveform correctly the smaller MIDI time divisions could simply be interpolated.

If a MIDI time grid is correctly matched/appended to a waveform song, a playback device need only interpret and process the MIDI and the resulting ‘audio will follow the MIDI.’ If a retrofile is used by a playback device to loop any particular bar, the resulting waveform data (following the looped MIDI) will loop correctly and ‘sound right.’

Upon playback, retrofile MIDI bars will be conformed to user or process defined tempos in order to match and mix with other retrofile MIDI bars from the same or different songs. In this case TCEAs will be used to expand or compress the waveform audio so that the MIDI timeline will be uniform and consistent in length and time at every scale (from 1/64's to bars to arrangement sections). It is by making retrofile MIDI bars uniform in time at every scale via TCEAs during playback that it is possible to mix any two bars from any two songs and have them match each other in tempo and bar by bar synchronization and ‘sound right.’

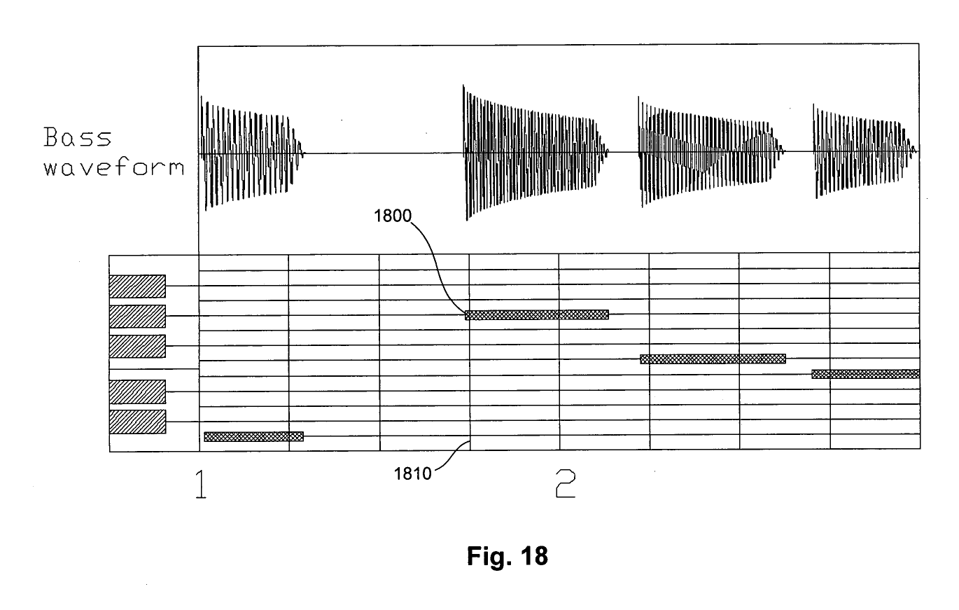

Normally transient markers are used by TCEAs etc in order to achieve this. It is preferable for a TCEA to use an appended MIDI time grid rather than transient markers however, as transient markers are not always a true guide to bar start/end positions. This is because it is not always the case that note or drum hit events fall exactly on the time grid they are being played to during creation (and hence upon playback). An example of this is shown in FIG. 18, in which events in the form of drum hits 1800 do not align with the time grid 1810.

In fact playing notes or drum hits slightly off the time grid is often referred to as giving the music some ‘feel’ or ‘funk.’ Therefore when appending a MIDI time grid to a waveform song it cannot be assumed that events such as notes or drum hits that start a bar fall exactly at the start of a bar on the time grid. Note and drum hit events are a good guide, but cannot be relied upon as being exact. Therefore bar positions should be checked before the MIDI time grid is appended 1.21. This will likely require human input.

7 . . . Append the MIDI score/sequence 1.8 of the original rendition to the appended MIDI time grid in synchronous fashion 1.7. A MIDI version of the waveform song 1.8 must be mapped onto the appended MIDI time grid 1.6. The added MIDI is essentially unchanged; it is only during playback that its timing might be altered due to differences in the timing of the appended MIDI time grid. From this point on, it is only necessary to analyze the appended MIDI time grid and added MIDI score/sequence because during playback the audio simply follows the MIDI. Therefore, in order to designate parts such as verses and choruses, a process only need analyze the appended MIDI time grid and added score/sequence to add MIDI markers designating the beginning and end of verses, choruses etc.

FIG. 2 is a representation of a waveform song retrofitted with MIDI data. In similar fashion to modern Digital Audio Workstation (DAW) software (such as Apple's Logic Pro) each MIDI track is shown as a horizontal row with events in the form of track ‘parts’ contained within each row. Each track contains time vs. pitch or time vs. sample data in a form similar to FIG. 18. The MIDI version of the waveform song need not be limited to note events and can take advantage of all aspects of MIDI such as note velocity and aftertouch, parameter levels over time (for example cutoff frequency and resonance) and playback data such as effect levels over time etc. MIDI data is in common use in modern sequencing and other software and its form and functionality is not described in detail here.

In one example, the timing of each MIDI event in each MIDI track matches its corresponding waveform song event as closely as possible. Again this can be achieved via the aid of computer analysis of a waveform song 1.19 but human input is likely to be required 1.20. As described earlier, in many instances the timing of a musical event does not exactly coincide with the time grid (such as a MIDI time grid) used to describe the timing of the events of the music. Whether by accident or by design it is often the case that musical events do not exactly match these timing increments. Musical score however does not provide this information. Musical score provides information in time increments of the time grid the song is based/constructed in, for example ⅛'s and 1/16's for a song in 4-4 timing. A song played back in such fashion (with every note exactly conforming to the time grid) is often described as having no ‘feel’ and as sounding unnatural and ‘computerized.’ A retrofile song takes this into account by using both computer analysis 1.19 and when required human input 1.20 in its construction in order that MIDI score events match their waveform song counterparts and not always necessarily conform to the MIDI time grid. The following are some example methods of how this might be achieved (not exclusive):
The MIDI can be created in the first instance by a human playing a keyboard whilst reading the score for example or matching events on a computer screen by eye to get them as close as possible and then adjusting them to match the event timing of the waveform as closely as possible by ear 1.20.
Utilizing waveform analysis software 1.19 to provide positions of individual notes and then fixing them up/adjusting them 1.20 to match the event timing of the waveform as closely as possible by ear.

8 . . . Append any alternative synthesis/playback data for original MIDI tracks 1.7/1.9.

A retrofile file could come with pre-arranged example ‘play-sets’ for MIDI tracks based on the original waveform song as a learning tool and guide as well as a means of interacting with a rendition in a pre-defined fashion. Play-sets could be pre-arranged remixes that a user could first simply playback (filter and effects parameters for example) such that the user could hear how various parameters (such as filter cutoff frequency) effect the playback of particular tracks etc and then manipulate and interact whilst staying within the pre-set guidelines of the ‘play-set.’

9 . . . Append any additional/alternative MIDI or waveform tracks and associated MIDI data to the appended MIDI time grid 1.7/1.9/1.10.

It is in this section of the retrofile creation process that additional/alternative MIDI 1.9 and/or audio 1.10 can also be appended to the MIDI time grid time-wise via marker and added to the file, if so desired.

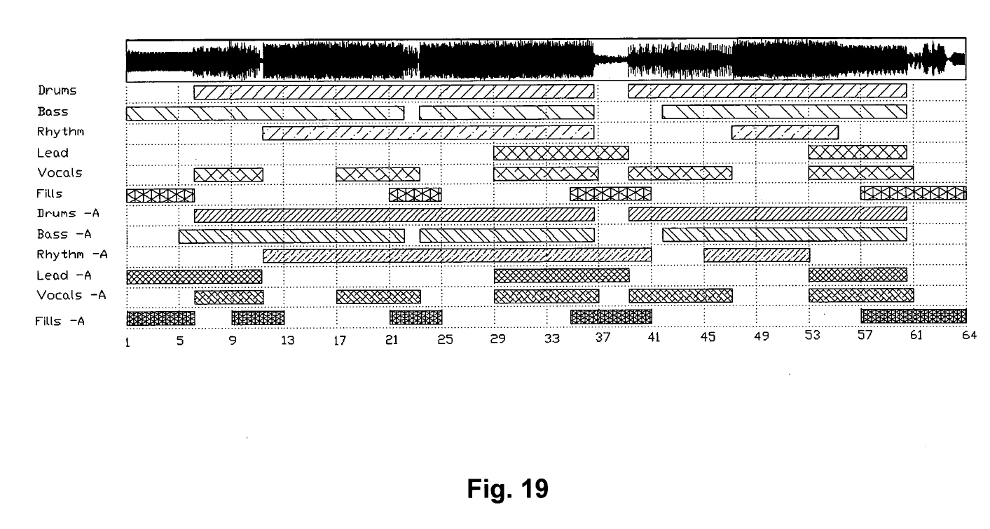

In order to make the user ‘feel like a professional DJ’ with as little skill, knowledge and talent as possible it may be beneficial to add alternative MIDI tracks (and associated synthesis and playback data etc or waveform samples) or waveform tracks or parts. An example of this is shown in FIG. 19, in which the audio content of FIG. 2 is modified to include additional first audio information. In this case a user can mix in alternative tracks with the original waveform song such that to another listener it would appear that the user is adding entirely new tracks/parts to the remix and the users input sounds good. In this fashion the user could output tracks that others would interpret as requiring the skill, knowledge and talent of a professional DJ whilst in fact the user has merely activated a track and indeed has utilized very little skill, knowledge or talent.

Furthermore the user can interact to a large extent with the additional/alternative tracks creatively whilst still always sounding good (it is virtually impossible to sound bad as the added tracks/samples etc are always in the correct timing, scale, pitch, progression etc). Here the lines between requiring a little to no and a lot of skill, knowledge and talent become blurred because although it is virtually impossible to sound bad, it is possible to use skill, knowledge and talent in a creative fashion to make the additional/alternative or indeed the original tracks or overall rendition sound better.

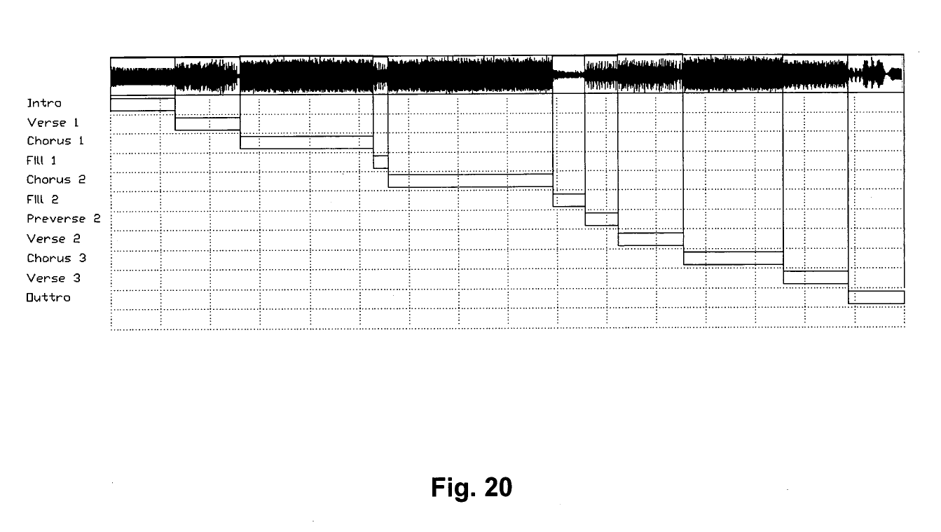

10 . . . Append rendition part markers to the MIDI time grid 1.11/1.13. An example of this is shown in FIG. 20. This data would typically be in the form of MIDI time grid start and end position values associated with the rendition sections of a waveform song 12.1. The names of the rendition sections and other metadata describing them (minor/major, key, structural part, genre etc) would also be included in the retrofile for ease of reference and for filtering during part selection for remixing. Part markers and arrangement sections can relate to any part of the waveform song (and can overlap and be included inside one another) and would certainly include the waveform songs main ‘arrangement parts’ such as intro, verse 1, chorus 1, break down, verse 2, chorus 2, crescendo and outtro.

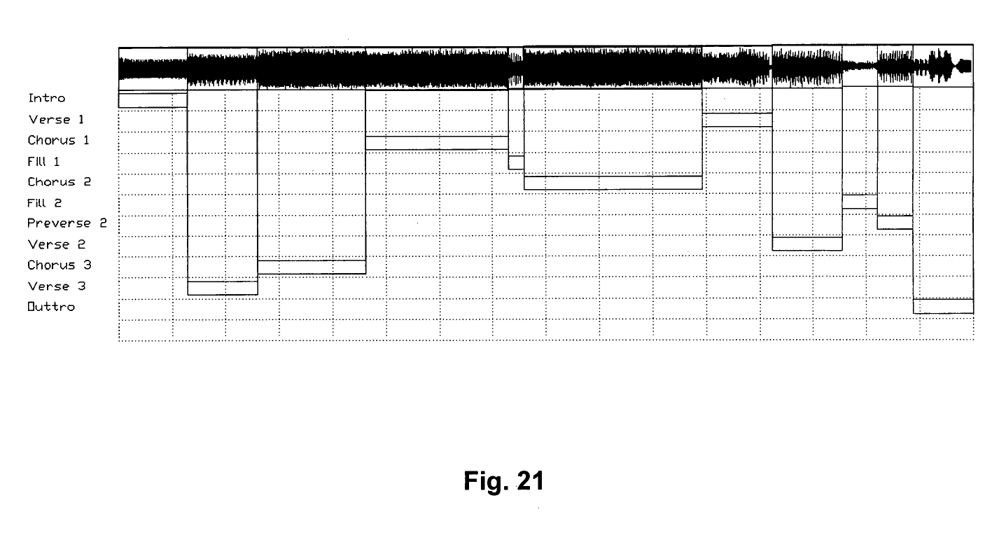

These can be used to allow the order in which the music is played to be altered as shown in FIG. 21.

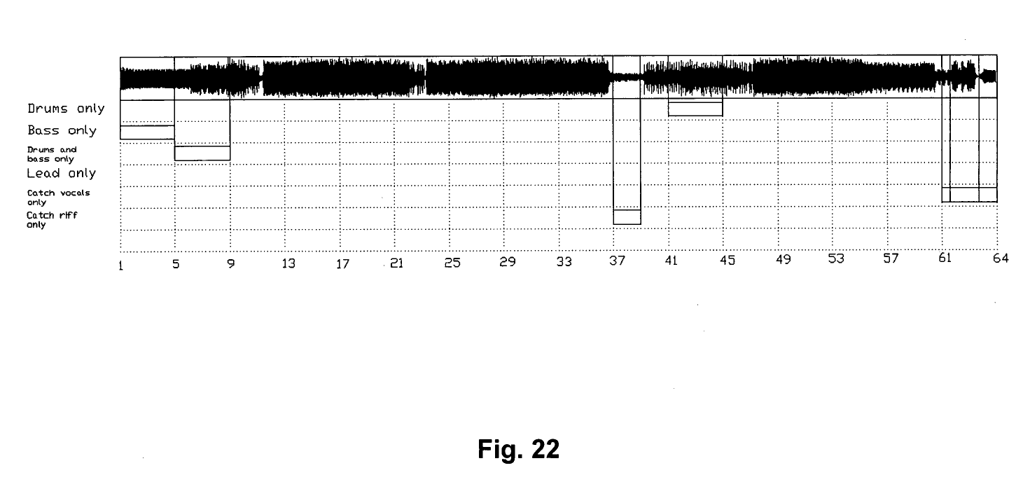

In one example, rendition part marking is used to identify track solos for different instruments. An example of this form of rendition part marking is shown in FIG. 22. In most songs, at some point or another it is only the bass that is playing, or the drums, or the vocal catch phrase etc (or a combination of only 2 tracks etc). If these parts can be isolated and designated as component parts they can later be played back together to reform a particular verse, chorus or other song part. Thus, the parts of the song can be highlighted as only containing audio information relating to a given component or track within the song.

In this instance, if these parts are played back in an appropriate sequence they will sound the same as another part in the rendition when they were actually played together in the original rendition. Having separated and remixed them however gives the end-user the ability to alter/‘tweak’ one track of the part (say the guitar) without altering the others and therefore give the user the impression of improvising within a ‘band,’ or of ‘being in the room’ and playing an instrument when the waveform song was originally recorded.

In addition to identifying solo parts, the markings can be used to isolate drum beats down to their individual component parts, such as a snare hit, bass hit, high hat etc. This allows individual component parts within the audio waveform to be extracted for subsequent presentation. This could be used for example to allow a user to modify the drumming sequence associated with audio content, whilst allowing the modified drumming sequence to sound as though it is played by the original instruments.

This also applies to other tracks—for example—if a synth or bass line for example played by to itself during a recording—a good ‘sample’ of the synth sound (at all the various pitches used in the original recording) could be marked out via markers and retriggered by users to play back another synth line using the same pitches. In this fashion the user would output a sound that would sound like the original recording (because it in fact is, just mixed up) and it would be hard to sound bad when remixing back in with the original recording because all the same pitches would be used as in the original recording.

If however a user wished to use different pitches to that in the original recording, TCEAs could be used to modify the pitch of notes without changing their length. If 5 notes were available from an octave, the rest of the octave would be filled in by applying the transformation to the closest note from the original recording. (I.e. pitch sifting notes too much results in the outputted sound not sounding quite right (with current software)—it is best to use notes as close as possible to the note you intend to pitch shift to.)

In the event that it is not possible to isolate parts of the song in which only a single component, such as a single instrument, is being played, then it may also be possible to apply this technique to parts of songs in which a limited number of instruments, such as only two instruments, are being played. This allows duet parts to be identified and then modified in a similar manner.

In any event, it will be appreciated that the above described process allows a song structure preset to be generated, in which parts of the song corresponding to solos (or duets or the like) are identified. This in turn allows the original notes of the instruments as played in the original song to be recreated, so that if these notes are played back in accordance with the MIDI information, the song is re-created to sound exactly like it would originally. However, by making these from the original parts, this allows the parts to be easily modified so that the user can utilize inputs, such as the visualizations, to control each component separately. This allows users to manipulate a particular track or tracks within the song, at any point in the song, thereby providing greater flexibility on interaction.

Rendition part markers also can include or identify any part of a song that is considered ‘interesting.’ For example, there is generally part of a song that most people will hum or sing in order to attempt to let someone else know what song they are thinking of—a catch riff, melody or phrase. These would typically be rendition part marked.

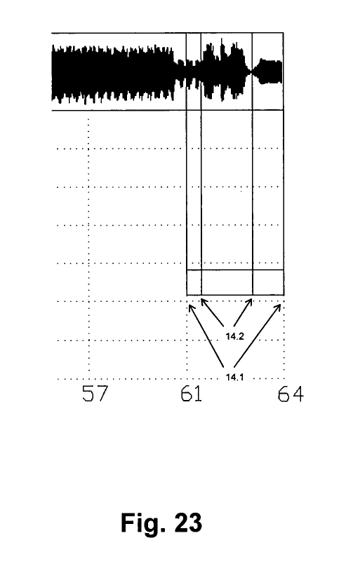

Some events are within bars and need bar markers to define their timing and also markers to define when to start and stop playing the waveform data within their associated bar markers. An example of this is shown in FIG. 23. Vocal catch phrases are a good example of this. A catch phrase 1.14 is always in timing with the bars however typically does not start and end at the beginning and end of a bar but rather somewhere in the middle. In order to meaningfully define a vocals catch phrase (for example) such that it can be played back in synchronized tempo with any other bar of any other song and only that piece of waveform is played two sets of markers are required, one set inside the other. The first set being on the outside, the bar markers so that the catch phrase can be timed with other bars 14.1, and the second set inside the first, denoting when to start and stop playing the waveform inside the particular bar(s) 14.2.

Many part markers however are already in place simply because a MIDI version of the original rendition has been appended to the MIDI time grid appended to the waveform song. As can be seen in FIGS. 2 and 19 many parts could be isolated by a user simply selecting a particular MIDI track part.

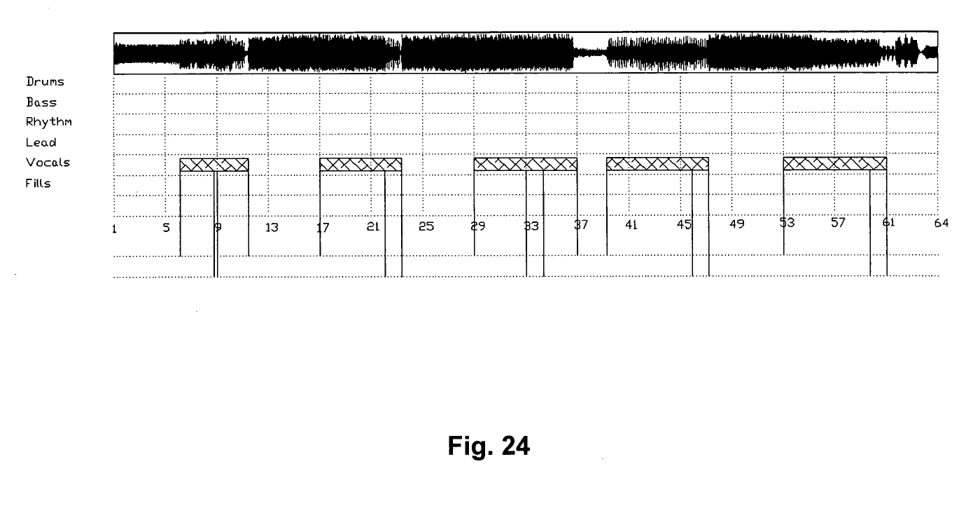

Furthermore vocals parts or other catch phrases 1.14 could be denoted by denoting their position inside MIDI tracks. This is shown in FIG. 24.

Any other interesting rendition parts could be designated as per the above process 1.16.

In one example, multiple different rendition markers can be provided in respective layers, each of which relates to respective information. Thus, for example, in a first layer, rendition markers could define large parts of the songs, such as identifying the verse, chorus, etc. Further layers may then be provided showing bar markers, solo part markers, ‘phrase’ markers, ‘beat’ markers, or the like. This allows a user to select a respective layer of events and then perform operations such as editing on the basis of the events in that layer. By displaying the different layers on the user interface shown above in FIGS. 5A and 5B, this allows the user to easily perform editing on the basis of a range of different events with minimal effort.

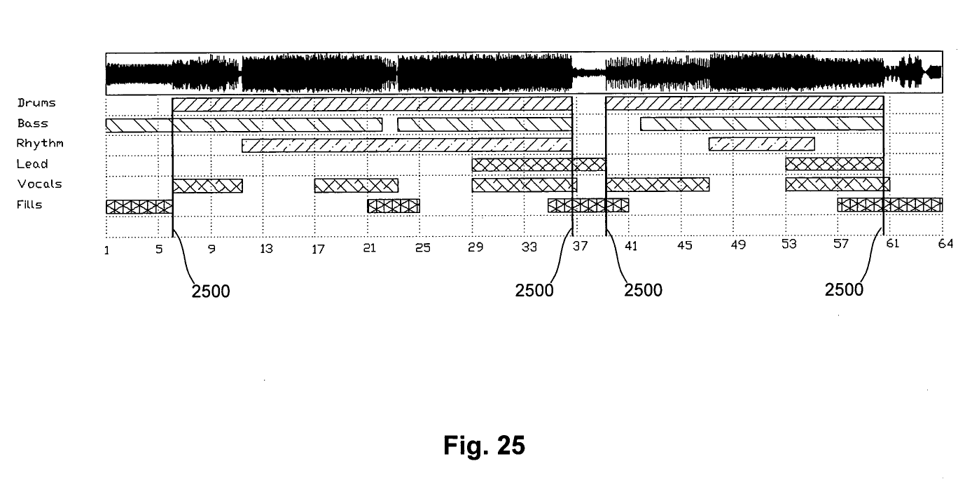

11 . . . Append track part markers to the MIDI time grid 1.11/1.13. This is the process of finding, designating and appending MIDI time position markers defining parts of all the individual MIDI tracks and added/alternative MIDI/waveform tracks. A track part is essentially defined by whether the track is being played or not at any particular time. MIDI track parts would also have associated metadata in similar fashion to rendition parts. An example of this is shown in FIG. 25 for drum track parts 2500.

Any other interesting track (MIDI or alternative MIDI or audio) parts could also be designated as per the above process 1.16.

12 . . . Output the file as either a type 1 retrofile or type 2 retrofile. Type 1 retrofiles files contain both the original rendition and the retrofile data. Type 2 retrofiles contain only the retrofile data and a reference marker such that if a user owns both the type 2 retrofile and the associated original waveform rendition, the two files can be synchronized and retrofile functionality can be achieved by using both files either separately or pre-merged by a specific file merge process. The advantage of creating type 2 retrofit files is that the audio/waveform and MIDI/other data are separated; therefore the original waveform rendition copyright is separated from the retrofile data. This is advantageous for the sale and transfer of files both in the retail market and between end users.

The above example process is representative of a concept and any retrofit of data that enables manipulation/interaction/addition to etc of a waveform song and is not intended to be limiting.

By way of example a retrofit file therefore contains the following data (not exclusive):
Waveform data (if type 1 retrofit file).
Reference marker to line up MIDI time grid with waveform song (if type 2 retrofit file).
Metadata.
Transient markers.
Common tempo of rendition.
MIDI time grid including bar markers and 1/16 markers etc.
The complete MIDI score of the rendition.
Rendition part markers as MIDI positions. This will include for example - intro, verse 1, chorus 1, break down, verse 2, chorus 2, crescendo, outtro as well as
MIDI track part markers.
Alternative MIDI synthesis/playback data. ‘Play-sets.’
Additional/alternative MIDI parts or tracks (and possibly associated samples—for MIDI instruments for example) and/or additional/alternative waveform tracks.
Metadata for rendition part markers, MIDI track part markers, alternative MIDI synthesis/playback data and for additional/alternative MIDI parts or tracks and/or waveform tracks.
Metadata for defining visualisations associated with the audio content.

A retrofile will not take up much more memory than its original waveform rendition counterpart (an MP3 file for example) however due to the fact that the additional data in a retrofile (in most cases largely comprising MIDI data) requires comparatively very little storage space.

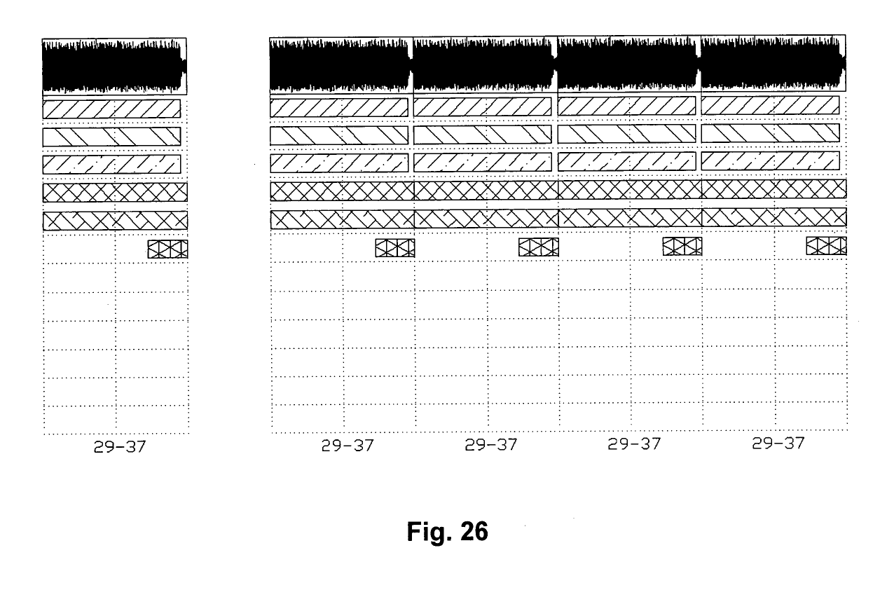

The interactive playback features/functionality the retrofile format will provide includes (but is not limited to) the following:
1. MIDI looping. The capability for a portion of a song to be ‘looped’ upon user request via the user designating loop start and end points on the MIDI time grid (for example bar 1-4). This capability stems from the fact that a MIDI time grid has been appended to the particular waveform song. The waveform song (which is synchronized with the MIDI) will ‘follow the MIDI’ and loop accordingly. This provides a user an easy means of isolating a section of a song for repetition. FIG. 26 shows an example of this functionality. Due to the fact that the waveform song of FIG. 13 is appended with MIDI data, if a user of the retrofile calls for bars 29-37 to loop then a playback device only need process the looping of the MIDI data and the waveform song will follow accordingly.
2. Parts and arrangement sections. The capability for a song to be arbitrarily broken up into its primary ‘arrangement’ sections (such as verse 1, chorus 1 etc) and re-arranged. This capability stems from the fact that rendition part markers have been added to the appended MIDI time grid of the particular waveform song. A waveform song broken up into arrangement sections corresponding to MIDI time grid points is shown in FIG. 20. A re-arrangement of the waveform song of FIG. 20 using these arrangement sections and corresponding MIDI time grid start and end position values is shown in FIG. 21. A user's interaction with a song may be as simple as tapping on the next section of the song they want to listen to as the song plays and nothing else.
3. Track parts. The capability for the various MIDI (possibly also waveform/synthesis etc) tracks that have been appended to the waveform song to be arbitrarily broken up into ‘parts.’ This capability stems from the fact that a MIDI version of the particular waveform song has been mapped onto the MIDI time grid appended to the song. For example—the vocals MIDI track may be arbitrarily broken up into verse 1, chorus 1, fill 3 etc. These parts may coincide with waveform song arrangement sections due to the nature of the structure of music however this will not always be the case. Track parts provide a user quick access to various parts of MIDI tracks. For example, the MIDI tracks of FIG. 2 have been broken up into MIDI parts that have been designated length and position based on the existence of a group of MIDI events (such as notes or synthesis data) at those positions. A retrofile can also include retrofit data which breaks up MIDI tracks into parts based on more specific reasons however such as by the type or description of the part. For example the vocals MIDI track might be broken up into verses, choruses, fills etc. Further still, MIDI tracks might be broken up into smaller parts within the larger parts. This is shown using the vocals track as an example in FIG. 24. For example, within the chorus rendition parts, there may be one line of vocals that might be considered the ‘catch phrase’ of the song. This is the vocals line that people often think will be the name of the song. Even though this part may be accessible through the ‘chorus 1’ vocals track part for example, a user may want quick access to it and it alone and therefore a retrofit file may have it specified as a separate part as additional retrofile data. Track parts can also be applied to additional/alternative tracks/parts.
4. MIDI track remix. Using a retrofile and a retrofile playback device equipped with

MIDI instruments such as synthesizers, samplers etc and audio manipulation functionality such as filters/effects/LFOs etc; the capability of ‘remixing’ the provided MIDI (as re-rendered audio) back into the song. This is dependent on the waveform song having been retrofitted with a MIDI version of the song. The MIDI retrofitted to the waveform song need not only be event data but can also include all the other forms of MIDI data that can be preset (such as note velocity and after touch, filters, LFO's and effects playback data etc—MIDI parameters of any type). In this fashion the playback device can deliver professional sounding renderings of MIDI tracks (which mimic the original waveform song tracks) that a user can remix back into the original waveform song. Due to the fact that the user of the retrofile is using the musical score of the original song synchronized with the waveform song, it is ‘hard to sound bad.’ The level at which the user decides to manipulate playback parameter's of the various MIDI tracks at their disposal is at their discretion. The level to which it is available to the user to manipulate in this fashion is determined by the level of sophistication of the playback device. A basic example of the sort of functionality this provides is that a user can let a song play as normal and add a synthesized copy of the original bass line into the mix and apply filters and effects to it in order to creatively interact with the original recording.
5. Alternative MIDI track remix. The MIDI provided with the audio can be more than just the original MIDI and can include remix alternatives. For example, the retrofile could come with a completely new bass line that is pre-programmed by a professional to sound good with the particular song. The MIDI track (bass line for example) could come with filters, effects, and parameter sweeps etc all preset by the professional that can be taken advantage of by a user as little or as much as they like. The alternative MIDI tracks could also come with more than one set of parameter settings, and parameter settings could be selectively applied to different parts of the song based on user input. In this fashion a user can interact simply by choosing from bar to bar or from group of 4 bars to 4 bars etc which preset settings the alternative MIDI track will play back in. Thus a user is interactively participating with the playback of and creatively adding to an original waveform song in an environment in which it is again ‘hard to sound bad.’ This caters for musical novices. Alternatively, a more skilled/experienced user can modify the parameter settings of the alternative MIDI track quite dramatically. This caters for more skilled/experienced users all the way through to music professionals such as DJs. FIG. 19 is a representation of a retrofile (in terms of MIDI) similar to FIG. 2 that includes alternative MIDI tracks. Of course the level to which the user can manipulate/modify the MIDI track and its resultant audio is dependent on the features incorporated in the playback device.
6. Waveform tracks can be retrofitted to the waveform song to be remixed back in with the original waveform song and other parts of the retrofile song.
7. A synthesis track can be retrofitted to the waveform song to be remixed back in with the original waveform song and other parts of the retrofile song.
8. Other types of tracks can be retrofitted to the waveform song to be remixed back in with the original waveform song and other parts of the retrofile song.
9. Tempo adjustment. The computer system or playback device can be used to adjust the tempo of components of the retrofile song (or the whole song) whether they are looped sections of the MIDI time grid, arrangement sections or track parts. This is done by adjusting the MIDI tempo and letting the ‘audio follow along.’ A TCEA would need to be utilized by the playback device such that an adjustment in tempo does not induce a corresponding change in pitch of the waveform song. This is the premiere element of retrofile functionality. Two bars of any two songs of different tempos can be played back in bar by bar synchronization by compressing and expanding each of their appended MIDI time grids to timing uniformity and then compressing or expanding one or both of their MIDI time grids to exactly match the other in terms of bars and beats. If the waveform portions corresponding to each part of the MIDI time grid is compressed and expanded ‘following along’ then the result will be two waveform loops that exactly match each other in terms of tempo and bar by bar synchronization.
10. Combination of various ‘elements.’ Different elements of a retrofile song to be put together in an interactive and creative fashion. Elements of a retrofile song include looped segments of the MIDI time grid, arrangement sections, tracks and track parts etc. An important example of this functionality is the capability for mixing solo segments back together. For example, solos (section of the original song in which only one track is playing) from the same song (drums, bass, riff) could be mixed together to recreate a section of the song in which those elements are actually played together in the original rendition—the mixed result should sound close or exactly the same as the part of the original song in which the different elements are actually played together depending on whether the solo parts of the original song are the same as when played with other tracks of the original waveform song. Different parameters could then be applied to the different elements in order to creatively interact with the remix in a fashion that would give the impression of ‘being in the room whilst the original song was being recorded.’ Jamming with your favorite band. Alternatively, a section of a particular song containing only drums could be mixed with another section of a different song containing only a bass-line for a more original remix.
11. Dynamic recording and static saving of remixes. The structure of a retrofile enables the capability of the file itself being altered by a playback device and non-destructively saved in an altered format (I.e. the original retrofile is preserved as well). This means users can save their remixes. The structure of retrofiles also enables playback devices to have the capability of saving alterations dynamically via recording MIDI and other data (depending of course on the playback device also supporting this functionality). This means that a user can press play/record and the playback device will record the user's alterations/additions/manipulations ‘on the fly.’ In this fashion a user can record a session on the fly whilst concentrating on the bass line, save the dynamic recording, and play back the altered version whilst concentrating on something else (and so on until every last detail the user wanted to alter has been attended to). A user must be able to access, alter and save any part of the retrofile—a good example of this is users adding their own MIDI track creations for remixing.
12. File sharing capability. The capability that users can share their retrofile mix files (retromix files) with others. This capability can be implemented by saving alterations of an original retrofile song as just that—alterations. Due to the fact that the ‘audio follows the MIDI’ an altered retrofile need not contain any original waveform data but only instructions for altering MIDI and retrofile data. Thus a retromix file can be shared without infringing any copyright over the original waveform song data as no original waveform song data need be transferred. Obviously this would be a different file type to both type 1 and 2 retrofiles. Such files could be given a different file extension.
13. Playback devices can change waveform note pitches or drum sounds/timing during solos using TCEAS. This capability stems from the fact that a MIDI score has been appended to the appended MIDI time grid. In one example in which waveform audio signals are available for each instrument and/or each note and/or each component instrument within a collection, such as each type of drum within a drum kit, then this allows the relevant audio to be separated from the second audio information, and the audio waveform manipulated directly.

The above described functionality allows for a greater degree of flexibility when editing video content or generating visualisations.

For example, if audio content is being added to video content, it is often desirable to mix the audio content, for example so that the audio content maintains a constant tempo. Accordingly, the tempo can be determined from the first audio information for a number of different music tracks, allowing tracks having a similar tempo to be selected. Following this any tempo modification required can be applied. Additionally, the first information can be used when mixing the tracks together to ensure that the tempo and beat matches as songs mix.

Using the first audio information also allows parts of the video content to be easily synchronised with respective events in the audio content. This can be achieved for example by selecting specific events, or types of events, allowing video parts to be aligned with these as required. Thus, this allows a new video content part to be aligned with a respective part of the track, such as the start of a chorus, or a bar within the music.

The first audio information can also be used to apply video and/or audio effects, either during editing, or in real time during playback of the video and audio content. This can be used to apply effects to the audio content in time with the audio events, allowing effects such as surround delay (echo) and dynamic effects (that need music timing info such as MIDI) such as phaser, flanger etc, to be applied. Similarly, effects could also be applied to the video content, such as image distortion, rippling or the like. This can be performed in accordance with events in the audio content. Thus, not only is the effect applied in time with the event, but also the nature of the effect may depend on the nature of the event, so that for example the magnitude of the effect is based on the volume or pitch of a specific note event.

The application of effects in this manner can be achieved in a highly automated fashion, for example, by using suitable selection mechanisms to apply a selected video effect to bars, ½ bars, ‘A bars, beats etc. This is functionality that previously was a very time consuming thing to do as it had to matched with the audio waveform manually, so the automated process vastly reduces the amount of time required to perform complex editing procedures.

This form of editing is also more resilient than traditional editing processes. For example, by aligning video content with specific events in the audio content, the video and audio content will remain aligned even if the video or audio information elsewhere in the project is edited.

For example, in traditional techniques the audio content is typically aligned based on a time. If additional video is included in the project prior to the audio, the audio content will remain in its previous position, whilst the video portion moves. This can result in a time shift between the actual and intended audio locations, resulting in subsequent misalignment between the video and audio content. In contrast, using event alignment the inclusion in additional video results in a corresponding movement of the audio content. To account for this, additional audio content may be included, such as extra looped bars, or alternatively, the speed of the video or audio can be adjusted. This can be performed automatically, for example based on user preferences, thereby vastly simplifying the process of aligning video and audio content.

In the example of generating visualisations, the first audio information helps identify events in the audio content which are to influence the visualisations, and allows corresponding video events to be generated, which can then easily be synchronised with respective events in the audio content for presentation.

The visualisations can also be used to apply audio effects during playback of the audio content. This can be used to apply effects in time with the audio events, allowing effects such as surround delay (echo) and dynamic effects (that need music timing info such as MIDI) such as phaser, flanger etc, to be applied. This can be achieved in a simple manner be Moving the position of an indicator.

Further audio manipulation will now be described and it will be appreciated that similar techniques could also be applied to editing audio content in conjunction with video content, to editing the video content itself, or when using visualisation to control audio processes.

Auto-Mixing

The first audio information can be used to allow automated mixing of tracks to be performed. In particular, as the first audio information contains information regarding the tempo of the encoded song, and in particular, the location of the bars and beats of each song, this allows a software application to align bars in different songs, and then mix the tracks using a cross-fading.

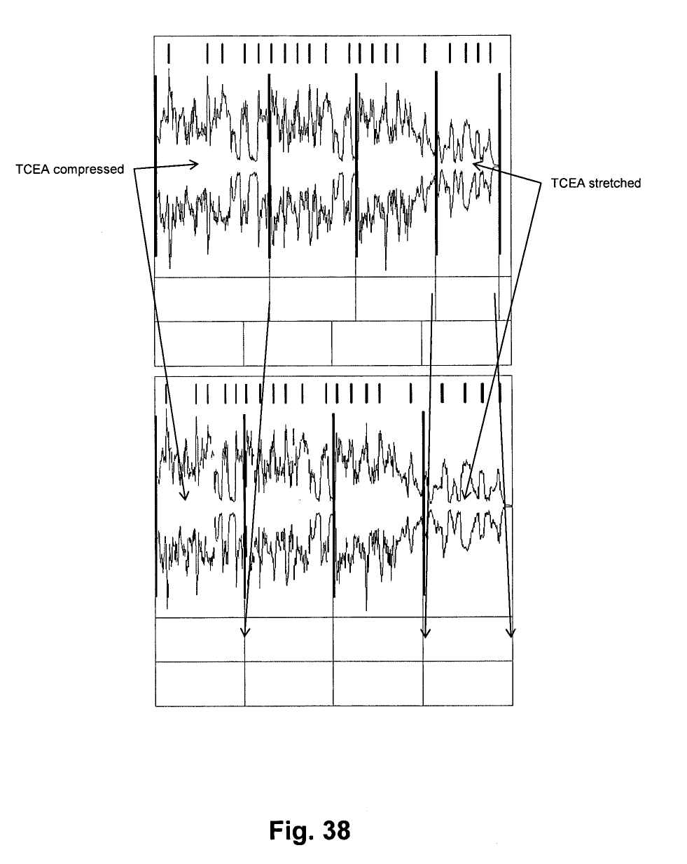

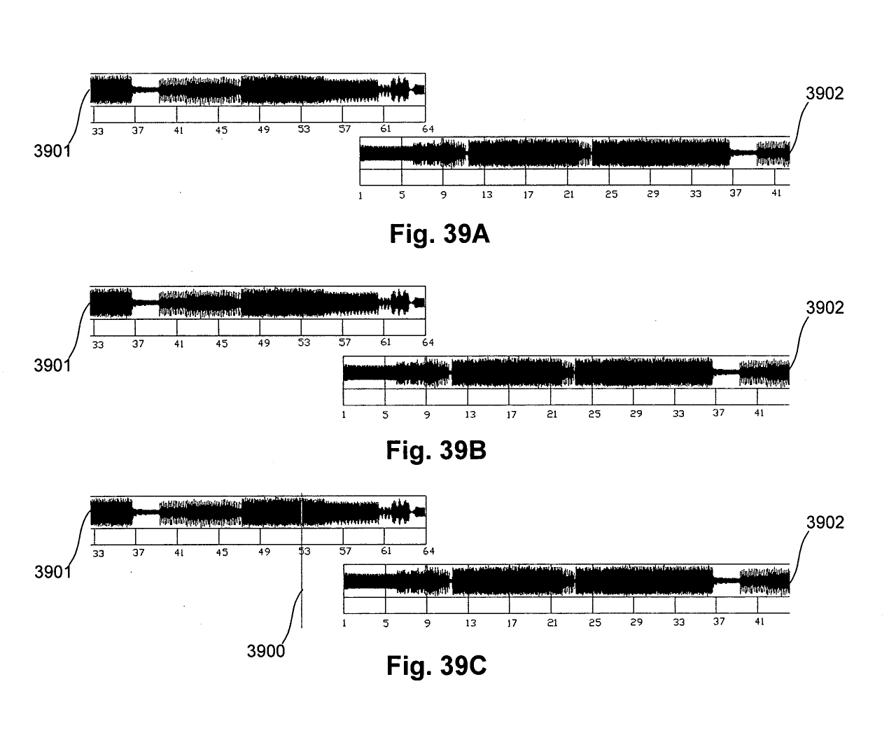

An example will now be described with reference to FIGS. 39A to 39C.

In the example, of FIG. 39A, a prior art technique for mixing is used where simple cross-fade technique is applied to two songs 3901, 3902, without reference to bar and tempo information. In this instance, the tempo and bars of the different songs do not align, and as a result, the mix sounds unappealing as the two songs are not in tempo or bar and beat synchronization. Even if songs are accidentally in the same tempo the cross-fade still typically sounds awkward.

Accordingly, in one example, the playback device can extract the tempo and bar information for the songs from the first information, typically using the part rendition markers. Once this is complete, bars and beats within the second song 3902 can be aligned with bars and beats within the first song 3901, as shown in FIG. 39B. In this instance, as playback of the first song nears the end, as shown at 3900, the playback device adjusts the tempo of the first song 3901 using a TCEA so that by the time the line gets to bar 57 of song 3901 it will be in the same tempo as song 3902. Consequently, as a ‘cross-fade’ is performed between the two songs, (typically over the first 8 bars) it will sound like a professional mix as the songs are in bar by bar, beat by beat and tempo synchronization.

The ability to provide for automated mixing of this form allows a user or venue, such as a pub, club or the like, to put together any playlist of songs. A suitable playback device can then automatically cross-fade one song into the next like a professional DJ at a club does. Normally, the ability to perform such mixing is a skill that takes a long time to learn on turntables or a lot of preparation on digital DJ equipment. Accordingly, by being able to perform this automatically, using the bar and beat position and tempo information from the first information, this avoids the need for a skilled user. This in turn allows unskilled users to perform mixing, which can in turn save money venues such as pubs and clubs by avoiding the need to employ a professional DJ.

Additionally, similar techniques can be applied to individual bars within music compositions, allowing a user to select any two bars of audio from any two songs in tempo and bar by bar and beat by beat synchronization via the appended markers and TCEAs.

Gaming

It will be appreciated that the appended MIDI information could be used to provide game like interactivity. Thus, for example, this can be used to allow a guitar hero type game to implemented for any music track that has the appended MIDI information. In this instance, the MIDI information can be used to display indications of the user inputs required in order for the music to be played correctly, with the gaming system then assessing the accuracy of the user input based on the MIDI information. This could be utilised to allow a user to import any appended music file into a guitar hero type game.

It will be appreciated that in one example, this functionality can be coupled together with the visualisations, generated as described above, so that the gaming system can generate visualisations relating to the music being played, and allowing such visualisations to be used as alternative and/or additional input devices.

Additional gaming functionality can also be achieved, such as to allow collaborative music ‘gaming’ or creation, based on MIDI appended files. This can include allow collaborative mixing or the like.

File Save

If one or more retrofiles are used by an end user to create a mix, the user may wish to save the mix in order to show or share with other end users. In order that no copyrighted works (audio or score or a mix of the two) are being transferred it is desirable that the saved mix is merely a set of instructions as to how to use a retrofile or retrofiles in order to render the mix.

By way of much simplified example a user may use 2 retrofiles in the following fashion:
Start.
Mix bar 7 of song 1 with bar 18 of song 2 and play these bars for 4 bars of time whilst increasing filter cutoff frequency for 2 bars and decreasing for two bars as per dynamic recording of cutoff frequency parameter alteration by the user.
Play bar 8 of song 1 for 1 bar.
Stop.

If a retrofile mix file (retromix file) is only saving instructions as per the simple example set out above there is no need for any audio or score to be saved and therefore retromix files can be shared amongst end users without breaching any form of copyright. Retromix files would contain MIDI data in order to record parameter changes over time and bar positions etc but no audio or MIDI from the original rendition. A user who obtains the retromix file would need either the type 1 retrofiles for songs 1 and 2 or the type 2 retrofiles for songs 1 and 2 and the corresponding waveform files for songs 1 and 2 in order to re-render the mix.

There could be 2 types of retromix files and the user saving the file could choose which file type to save a mix in. The first could be such that a secondary user can simply listen to the re-rendered result of the retromix file and the second could be such that a secondary user can open the retromix file just as the author had left it before saving it, as a retrofile. This means that the secondary user could press play and simply listen to the re-rendered mix or further add to and interact with the mix.

A simple form of coding for the retromix file format might be (this file format is by way of simple example and is not exclusive):
1. Song number, bar or part number for each bar or part in a linear fashion. I.e. 1:8:1181247 would mean that bar 1 of the retromix file would be bar 8 of song number 1,181, 247. Thus a layout of a song could be coded as a comma separated sequence of bar:song:song-bar references. If two bar numbers were the same, this would indicate that these 2 song-bars should be mixed together.
2. Parameter changes over time in MIDI format.
3. MIDI (or waveform) additions (if any). E.g. an improvised additional melody with accompanying parameter-change data etc. Each addition would need to be assigned a bar or part number such that it can be placed in the linear outlay of the song by song number, bar or part number.
4. Song number, bar or part number for each bar or part placed in the non-linear section of the user interface. This would only be necessary for a type 2 retromix file—one in which it was intended other users could further change and interact with.

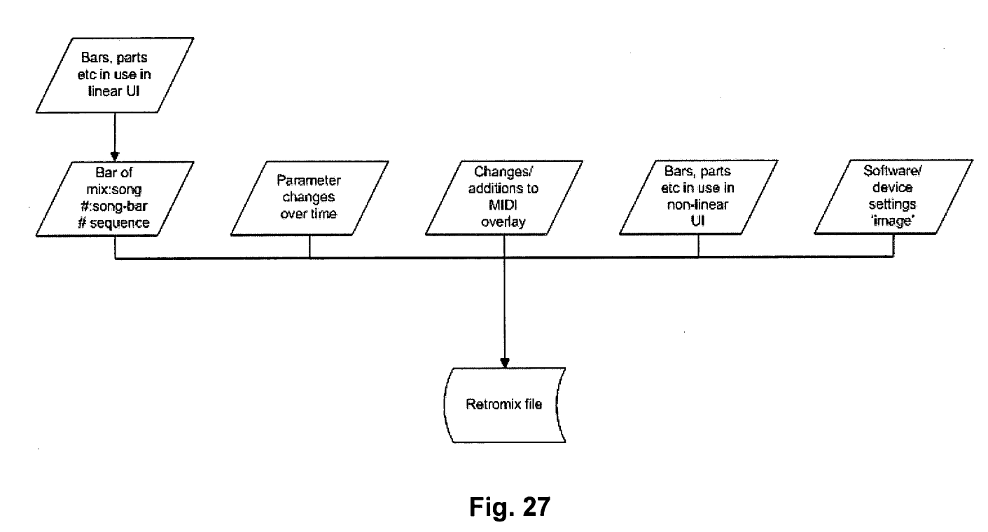

An example process for the creation of a retromix file as per the above is shown in FIG. 27.

Audio and Score Copyright Merge

It is an inherent property of the retrofile format that it merges two forms of copyright, audio and music score (as MIDI). The music industry currently makes the vast bulk of its money via selling audio, not MIDI. The process of merging the 2 forms of copyright gives the music industry the opportunity to sell every song ever made, all over again! Currently, a song costs 99c on iTunes for example. Let us presume that you could sell a type 1 retrofile (waveform and retrofile data) for $1.50 or just the retrofile data for songs (type 2 retrofiles) for 50c. This creates a rather large income stream for ‘copyright owners’ that was previously unavailable. In fact, up till now, copyright owners have been unable to obtain any more than a minimal income stream from the massive amounts of ‘mixing’ that goes on around the world. Copyright owners only receive money from the original sale of works even though in many cases mixed works would not be considered original enough under copyright law to be considered a compilation and be copyright exempt. This is because it is extremely difficult for copyright owners, or even particularly law abiding end users to keep track of all the music that is mixed for whatever purpose. It would be impractical in terms of time and cost for copyright owners to try and retrieve this income because they would have to sue each infringing individual, which basically means investigating each and every user of modern music creation software.

Retrofiles provide the remedy to this situation. If end users mix using retrofiles not only do copyright owners get a cut from files used in a mix but they get their cut in advance, all the time, even when the mix is considered original enough to be a compilation and thus avoid copyright law. This is a good arrangement for copyright owners!

Web based file format sales repository

For every retrofile that is sold a waveform song would need to have been appropriately retrofitted with a MIDI time grid, the. original MIDI of the song and potentially other retrofile data (part markers/alternative MIDI tracks etc). This would require a cost outlay for each and every retrofitted waveform song.

An alternative to this cost outlay could be to build the ability to construct retrofiles into Logic Pro for example and give Logic Pro users incentive to create retrofiles. This solves one of the hurdles of the introduction of the retrofile format being that the retrofile format system works best if there is a large collection of retrofiles to choose from so everyone gets to use their favorite songs rather than being limited to only a small collection of songs. If the company distributing retrofiles were to make the files itself users could certainly use the pool as it grows and it is probable that as the format became more popular and the company gained more revenue the pool of retrofiles would increase exponentially. It may be the case however that the fastest route to a large pool of retrofiles is to enable Logic Pro users (for example) to create the files and give them incentive to do so such as by paying them to do so. It would seem that the number of struggling musicians that this would provide an income stream for would lead to a quickly established and formidable pool of retrofiles! Of course each retrofile would need to be screened for errors and retrofile creators could obtain rankings for quality and consistency of work. Indeed, it would seem probable that 3rd party companies could make a profit be making a business of creating retrofiles. 3rd party companies could not only create retrofiles but create alternative tracks to go with them and get a return on the extra revenue derived. 3rd party companies such as music production studios (Sony etc) could encourage the composers of the original waveform songs to provide the alternative

MIDI/waveform/synthesis tracks themselves (as opposed to the creators of the retrofile data composing them). Such additions could be sold at a premium.

Distribution

Retrofiles could be sold in a similar fashion to that in which MP3 files are sold, via an online retailer such as iTunes for example.

There are two options for the distribution of retrofiles:

Type 1 retrofiles: The first option is to sell the waveform song and appended MIDI/retrofile data together in a ‘combination’ retrofile. This would mean that appropriate copyright laws would need to be adhered to as the original audio work would be being distributed. Users who already own the audio of a particular song however may only have to pay an upgrade fee to get retrofile functionality. I.e. Users who had already downloaded a song from iTunes for example (and could prove it) may only need to pay for the upgrade (from a waveform song to a waveform song/retrofile data combination file—type 1 retrofile). Type 2 retrofiles: The second and most likely preferable option is to sell type 2 retrofiles which will enable retrofile functionality when the retrofile is used in conjunction with its corresponding waveform song. Although the original waveform song is required to be used for the creation of a type 2 retrofile, a retrofile of this type can later be separated from its corresponding waveform song and can be distributed independently. I.e. this type of retrofile would consist only of the additional data required to provide retrofile functionality (MIDI time grid/retrofile data etc). All that is needed to fully enable retrofile functionality is a reference in the type 2 retrofile that enables a playback device to appropriately utilize the retrofile and its corresponding waveform song in a synchronized fashion. In this way a user can obtain a waveform song and its corresponding type 2 retrofile completely independently of one another, and as long as a user has the correct waveform song and the corresponding retrofile a playback device can apply retrofile functionality to the waveform song, by using the data in the retrofile file to appropriately manipulate the waveform song. The two files (retrofile and waveform song) need never be recombined. The retrofile simply ‘uses’ the waveform song. Selling the retrofile as a separate entity (without the waveform song) means that there are no copyright issues involved as the original audio work would not be being distributed, merely data designed to ‘use’ the original audio work.

Another distribution method for retrofiles is retrofile pieces. For example, when a user obtains a retromix file, the user may need retrofiles in order to play or open it. Instead of forcing the users to buy the whole retrofile of each and every retrofile used in the piece, retrofiles could be sold in pieces. When a user opens a retromix file they could be automatically prompted to download the retrofile pieces they need to play or open it. It could be the case that once a user owns a certain percentage of a particular song they can download the rest of the song for free.

Complete copyright avoidance

Copyright issues can be completely avoided by using a proprietary time designation format (thereby not using MIDI if this causes any sort of copyright issue) and only providing alternative tracks. Thus neither copyrighted waveform songs nor copyrighted musical score are used in any way.

Online user community

The fact that users do not have to save their works containing any waveform or original MIDI data provides the basis for a dynamic and popular online user community via a specific website or websites.
Online remix competitions could be held.
Online live collaborative remix competitions could be held.

Portable audio devices

Whether retrofiles are sold as type 1 or type 2 files, users could transport, store and listen to/use the original waveform songs (and with appropriate implementation if necessary their own creations) on a portable audio device such an iPod or iPhone. If for example type 1 retrofiles were sold the retrofile could be designed such that a current iPod or iPhone (I.e. built before the retrofile format comes into existence) would read a retrofile as an MP3 file and simply playback the original waveform song as normal.

An important consequence of using a portable audio device such as an iPod or iPhone to store and transport retrofiles is that a more sophisticated playback device could be designed such that an iPod/iPhone could dock with it. This provides that users can transport their work to other playback devices (even playback devices of a completely different type) and continue to play them as is or manipulate them further. This is all available using current iPods/iPhones. Thus, the portable audio device need not have any added functionality for this to occur; current portable audio devices could be used.

Perhaps coming generations of iPods/iPhones could be outfitted with very basic functionality provided by the retrofilefile format such as looping 4 bars at a lower volume on the press of a button as an option instead of pause. Another simple use of the functionality the retrofile format provides in a device is for an iPod/iPhone to use the arrangement section markers in an iGruuv file to flick back and forth to the beginning of arrangement sections in the song much like the chapter back and forth function on a DVD player. Also future iPods could be introduced that are able to play retromix file formats.

Online Updates and Enhancement

A retrofile playback device (hereafter referred to as a retroplayer) could also get updated and enhanced functionality via connection to the Internet. For example, in the case of retroplayer collaboration, the master retroplayer could check at the iTunes website (for example) for the most suitable start tempo for mixing two songs together by accessing a tempo calculated by user data/suggestions if so desired.

A retrofile could be a dynamic entity that is updated on a continual basis with new alternative MIDI/waveform/synthesis tracks, bug-fixes, timing error fixes and perhaps user add-on tracks and remixes. This could be used as further reason to make users want to legitimately own their files—it could be that a user needs to ‘validate’ to access updates, remixes, share files and other downloads and to be able to collaborate online in the same fashion as ‘Windows Genuine Advantage’ or an online multiplayer game.

An online retrofile user community could be pushed forward in the same fashion as youtube or wikipedia—‘user generated.’ The retrofile online user community could be the next generation of music mixing, online collaboration and composition. Certainly this would be the goal.

Interactive Music Playback Device.

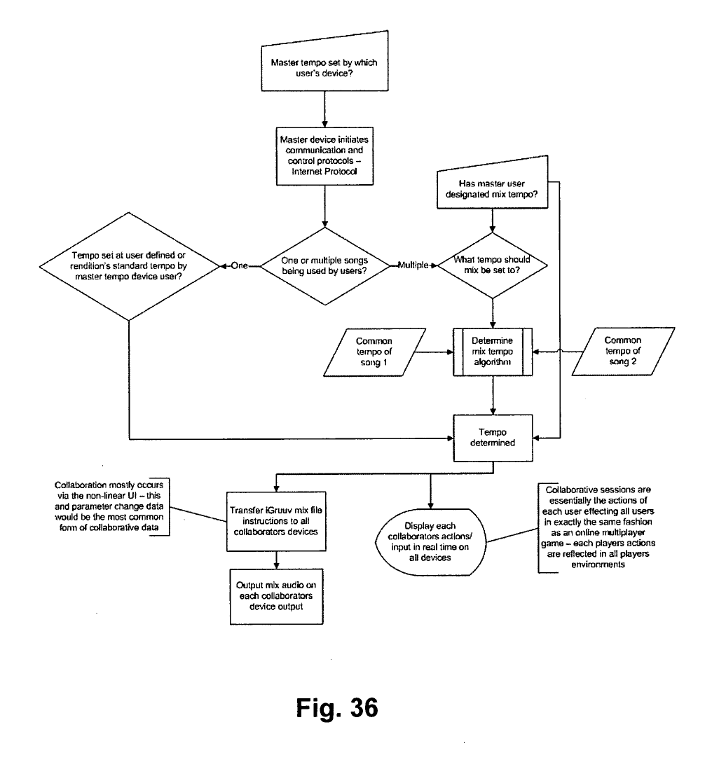

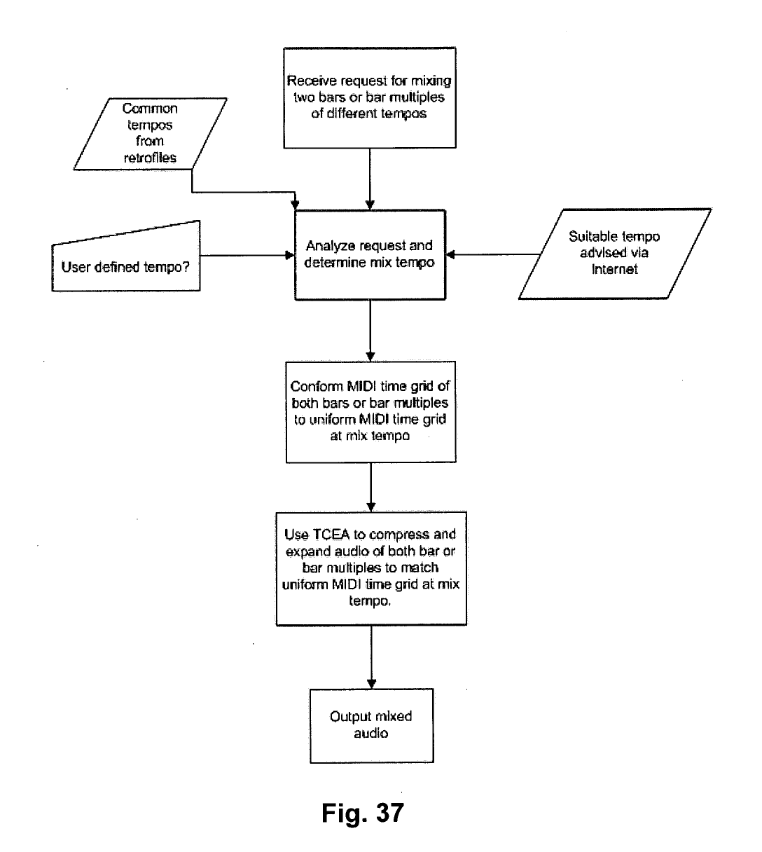

The premiere feature of the retrofile format is the ability it gives to playback devices to mix any two bars, multiples of bars or pre-designated ‘parts’ from any two songs at the same tempo and in bar by bar synchronization. In order to achieve this, a playback device must undergo the following process (shown in FIG. 36):
1. Receive request for two bars (say bar 1 and bar 2) of different songs (say song 1 and song 2) to be mixed together. 29.1
2. Receive user input 29.2.2, input via Internet 29.2.3 or determine most suitable mix tempo using common mix tempos of retrofiles 29.2.1. 29.2.
3. Conform MIDI time grid of both bars to a uniform MIDI time grid at mix tempo. This is shown in FIG. 37. 29.3.
4. Use TCEA to compress and expand audio of both bars to match uniform MIDI time grid at mix tempo. This should be applied to the audio using the smallest time divisions of the retrofiles MIDI time grid to preserve audio quality. 29.4.
5. Play back mixed audio. 29.5.

One of the most advantageous features of the retrofile format is that the level of functionality it provides is determined by the features of the playback device, or software implemented using the computer system. This means that a variety of playback devices can be used to implement the file format that can be designed to appeal to the full spectrum of users; from children to music beginners of all ages to professional music producers/DJs. Such playback devices could be sold at incremented costs tailored to the market to which they are designed to appeal; less expensive devices for children, more expensive devices for music professionals etc. Another advantageous feature of the retrofile format is that regardless of the level of sophistication of the playback device if the user does nothing, the retrofile playback device will simply play back the original waveform song in its entirety. If the user wishes to interact with and add to the song however; a vast array of interactive and additive features are made available by the format. It is apparent to the author that the preferable way to roll out the retrofile system is by introducing it as primarily an advanced media player with interactive capability and letting the end users slowly discover and themselves popularize the advanced interactive and collaborative functionality the platform provides.

iPhone:

In one example the retrofile playback device is a multitouch-screen computer. Since the launch of the iPhone platform it has become apparent to the author that the preferable multitouch-screen computer platform for a retrofile playback device is the iPhone or another device with the same or similar features. This is because of what the retrofile system intends to achieve which includes (not exclusive):
To bring music interaction (mixing/manipulation) to the masses by making music interaction available all the time and instantly (or at the touch of a finger). One way to achieve this is to make the retrofile system a software application on a device people carry around with them all the time, like a cell phone, in this case an iPhone.
To bring music interaction to the masses by requiring very little skill, knowledge or talent from the user.
To make music playback an interactive experience that provides a feeling of ‘instant gratification’ to the user by making them feel like a professional DJ - instantly, by making them sound like a professional DJ - instantly.
To bring music interaction to the masses by making people feel like they are interacting or ‘jamming’ with their favorite band/music. The intention is to make people feel like they are ‘in the room’ when the particular song was originally recorded.
To be a collaborative platform where users can ‘jam’ together either in the same room or across the Internet.
To make interaction with music an activity an average person will undertake on a frequent basis. The scope of this intention is given much aid by implementing the retrofile system on a platform such as the iPhone, a platform end users will carry with them all (or a lot of) the time and everywhere they go.

Using the iPhone as a platform for the retrofile system brings music interaction to the masses very efficiently as it does not involve the user setting out to specifically buy a piece of software or hardware and carry it around with them. A user does not even have to choose the various retrofiles they wish to use in advance. Due to the way Apple intends to roll-out iPhone applications (as of 6 Mar. 2008) a user can download iPhone applications straight to their phone over the cell phone network. This means that not only can a user download the retrofile platform itself as an application but they also have access to the retrofile pool all the time.

The intention to make interaction with music an activity an average person might undertake is quite a challenge. The retrofile system as an application on an iPhone provides that it has a better chance of catching on in this way because:
It is always there.
You are not required to interact with it.
When not in use as a music interaction tool, a retroplayer is simply a media player and this is for most people how it will start life - in fact it will likely be initially rolled out as simply an advanced media player with the enticing add-on of interactive capabilities. A new media player, which offers opportunity for new and exciting ways to pass the time whilst on the train to work. A particular advantage of the multitouch interface is that a very sophisticated piece of software can present itself at varying levels of complexity.
A user might try out a very simple retroplayer function such as ‘scratch a part over a song’ which is described in more detail later but involves simply waving your iPhone around to scratch an audio part as a counterpart to the particular song you happen to be listening to. Completely intuitive, requires no instruction and a lot of fun.
It is the hope of the author that this will encourage the user to experiment with more advanced retroplayer functionality and due to the fact that utilizing retroplayer functionality requires essentially no musical skill, knowledge or talent that the user is not scared away in the same way people are scared away from learning a musical instrument (because learning a musical instrument requires time, effort, skill, knowledge and talent). Also people are interacting with songs they get to choose and are familiar with which can only help.
Once retroplayer begins to catch on and the ability to collaborate anytime, anywhere and without interfering with anyone else (no-one else can hear) becomes known, it is the authors hope that retroplayers will become a new and advanced social utility.

In order to have full functionality as intended on a multitouch platform a retroplayer requires (not exclusive):
A computer—memory, processor and storage powerful enough to meet retroplayer system requirements.
A high level operating system featuring advanced audio.
An audio out jack.
A multitouch screen.
Wireless internet (wifi).
Wireless internet (through cell phone network).

The iPhone has all of this and more. In terms of computing power (memory, processor and storage) it has ample, it features a cut-down version of Mac OS X which runs Logic Pro 8; it has an audio out jack and a multitouch screen.

By way of example, the retrofile music interaction system as an application on an iPhone (retroplayer) could have the following general features (not exclusive):
Every user interface slider, knob, toggle etc would enlarge upon touching it so a user can make more precise adjustments in similar fashion to how the keys on the QWERTY keyboard of the current iPhone enlarge when depressed for easy visual confirmation a user has pressed the intended key.
Each area of GUI would enlarge to full screen upon an appropriate command. ‘Two-finger touch-and-expand’ or press the ‘full screen’ tab at the edge of each GUI area are good examples. A variety of methods could be used to achieve this however.

By way of example, the retroplayer could have the following windows that can go full screen (not exclusive):
x,y parameter manipulation touchpad.
Interactive keyboard.
The entire screen would be cut up into 16 (for example) pads for tap drumming.
Non-linear music playback section.
Linear user playback section.
Oscillator section.
Effects section.
Send effects section.
Filter section.
Filter and amp envelope section.
Module flow section.
Waveform part selector section.

Example iPhone Multitouch-Screen Interface Application:

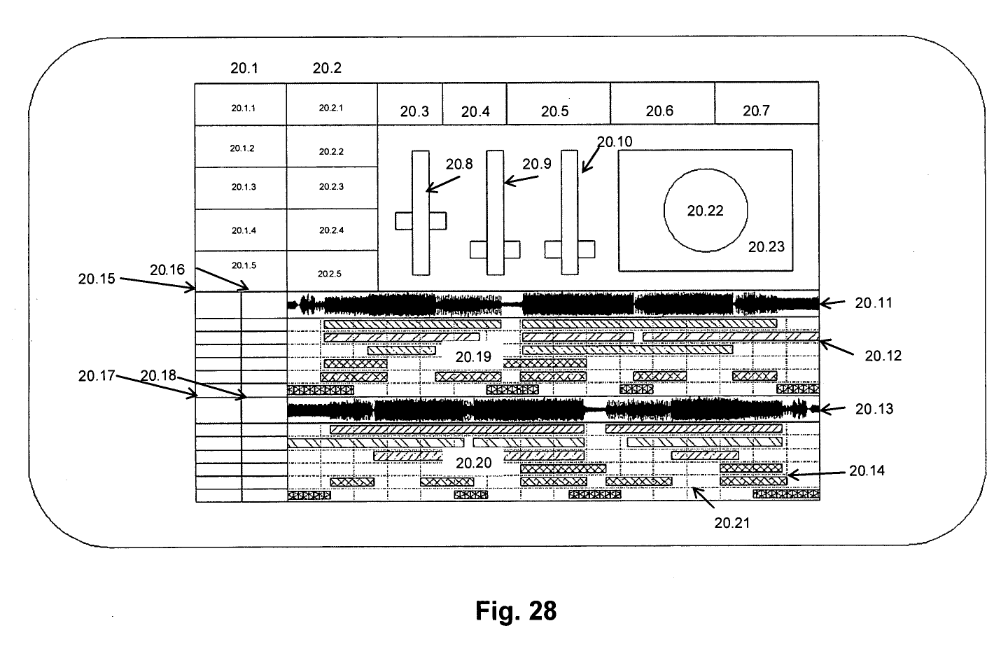

An example multitouch-screen user interface for the iPhone is shown in FIG. 28. [It should be appreciated that this interface is merely by way of example and a person skilled in the art would be able to see the myriad of interface possibilities available to a retroplayer using the multitouch interface.] A particularly relevant and useful advantage of the multitouch screen for a retroplayer is that whilst the entire graphical interface shown all at one time may take up some considerable space, a multitouch screen lends itself to flipping between various layers of complexity and the different interface sections with ease. Again, this makes it possible for a very complex program to present itself at varying levels of complexity and via many windows which can go full screen or enlarge when touched for use. This means the one platform and one program can provide interfaces for music interaction suitable for musical novices through to music professionals. It is the contention of the author that the simplicity of the interface will mean the interface novices will use will also be the base interface music professionals will use.

In the example interface of FIG. 28 the multitouch screen is broken into 3 primary sections, the non-linear interface section at the top left of the screen containing columns 20.1 and 20.2, the parameter interaction section at the top right of the screen containing 20.3 through 20.10, 20, 22 and 20.33 and the linear interface section which fills the bottom half of the screen.

In this example the user is currently using 2 retrofiles from their particular retrofile collection; both retrofiles (20-19 and 20-20) are shown on the display with their waveforms (20-11 and 20-13) on top of the appended MIDI time grid 20.21 and added MIDI score (20-12 for 20.19 and 20.14 for 20.20). These could have been chosen from a split screen where the users retrofile collection is shown on the left and the files to be used are shown on the right and are placed there in drag and drop fashion. If the user had chosen 1 or 3 retrofiles, 1 or 3 retrofiles would now be being shown on the bottom half of the display.

The simplest way to interact with the retroplayer from ‘rest’ is to touch the circle 20.22 within the x,y touchpad 20-23. Upon being touched the circle enlarges into a circular play, stop, pause etc touch circle similar to the iPod. If play is chosen the unit begins to play. By default only the waveform track of the top-most retrofile 20.19 will play, in this case waveform 20.11 will play in normal unaltered order from left to right. Retrofiles and their associated waveforms can be rearranged in vertical order via drag and drop. In this scenario the retroplayer is acting simply as a media player and the track on/off column (under and including 20.15) will be dim except for 20.15 which will be lit. The track could be interacted with by adjusting global track parameters on the default parameter interaction screen such as filter cutoff frequency 20.8, filter resonance, 20.9 and effect level 20.10. An entertaining way to interact with the platform in first instance is to touch the x,y parameter pad 20.23 anywhere outside of 20.22 (the transport circle 20.22 will disappear at this point) and ‘strum’ the pad in time with the rhythm. The default parameters set to the x,y parameter pad such could be such that the users strumming introduces slight but noticeable oscillations in frequency and resonance to the global output.

This does not however begin to utilize the functionality provided by the retrofile format. At any time the user can add a midi track to the mix by simply touching its on/off toggle switch in the column 20.15 (whereby waveform 20.11 is in row 1 of column 20.15). By default the next column 20.16 is set to track volume and so touching row 3 of column 20.16 will bring up an enlarged slider and MIDI track 2 (from the top) of retrofile 20.19 can be gradually brought into the mix by raising the slider. By touching anywhere in the adjust level columns 20.16 and 20.18 and any of the aeas 20.3 oscillator, 20.4 envelope, 20.5 filter, 20.6 effects or 20.7 EQ the top right panel will change from the 3 sliders and circle/x,y pad to either the oscillator, envelope, filter, effects or EQ section for that particular track. Here a user can adjust MIDI or waveform track parameters or change the default slider in columns 20.16 and 20.18 to any other by dragging that slider, knob etc to the appropriate surface in the column. The second waveform song can be brought into the mix simply by touching its corresponding on/off toggle. The above example of interaction is linear manipulation however and still a user has barely scratched the surface of the functionality the retrofile format provides.

It is the ability to match tempo and provide bar by bar synchronization of any two bars/parts etc of any two waveform songs that is the premiere functionality the retroplayer provides. Not only is this the retroplayers premiere functionality but it is a functionality that is intuitive and easy to use and provides for ‘instant gratification’ by making an average user sound like a professional DJ ‘instantly’ with very little skill, knowledge or talent. This functionality is best utilized in a non-linear user interface as provided by the 5 rows of columns 20.1 and 20.2. 20.1 starts as the ‘playing now’ column and 20.2 as the ‘playing next’ column. Let us assume the user has used 20.22 to press stop and a play session can be started again from scratch. Since the diagram is black and white a lot of the interface cannot be shown but assume that the different arrangement sections of waveform 20.11 for example were broken up as per FIG. 2 and different sections were shown in different colors. The different breakups of waveform 20.11 (arrangement sections, solos etc) into colored sections could be toggled between by pressing anywhere in the waveform and 20.15 at the same time. A user could move an arrangement section of waveform 20.11 into row 1 of the playing now column 20.1 (to start with) by simply dragging and dropping. A user could ‘grab’ a section of the waveform or any MIDI track ‘by bars’ by touching the waveform or MIDI track with two fingers at left and right bar locations. When this occurs the waveform or MIDI track expands in view between and around the users fingers and the precise by bar location of the left boundary/finger and the right boundary/finger can be located (the selected area would automatically snap to bar positions and to suitable numbers of bars such as 1, 2, 4, 8, 16 etc) before dragging and dropping the bar or bar multiple into a row of the playing now column.

In this example let us assume the user has dragged two bars of a ‘drums only’ section of waveform 20.11 into row 1 of 20.1 and 4 bars of a ‘bass only’ section of waveform 20.11 into row 2 of 20.1 using either drag and drop by arrangement/waveform section or drag and drop by bars and pressed play using 20.22. Music will begin to play. Both sections dragged into the playing now column 20.1 will play in tempo and bar by bar synchronization. The 2 bars of drums only waveform will repeat twice in order to match the 4 bars of the bass only section. Therefore with a few intuitive touches a user has already created a unique and ready to be creatively manipulated mix based on waveform 20.11. Say now the user presses row 2 of 20.1 and pad 20.5 at the same time. The section containing the 3 default sliders and default x,y and transport controls will change to the filter section corresponding to row 2 of column 20.1. If the user now presses the cutoff frequency slider (which as always will enlarge upon being pressed to provide more precise control) and moves it upward the user will be manipulating the sound of the bass-line of waveform 20.11. Say now the user drags chorus 2 of waveform 20.13 into row 1 of the playing next column 20.2. This action will not affect playback or ‘enter the mix’—yet. If the user swipes downwards along column 20.2 the retroplayer will begin playing the mix collated in the playing next column 20.2 at the next common bar multiple of the parts playing in the playing now column. I.e. the retroplayer will move from the end of the multiple of bars in column 1 20.1 into playing chorus 1 of waveform 20.13 (being all that has been added to column 2 20.2) in perfect tempo and bar by bar synchronization. Now the playing now column has become the playing next column and vice versa. More columns can be added if necessary. Indeed effects could have been applied to chorus 1 by touching row 1 of column 2 and 20.6 at the same time and choosing and manipulating an effect in advance of bringing it into the mix.

The application is set up so that once play is pressed all manipulations are dynamically recorded (as ‘instructions’—as per above) so that once stop has been pressed the user has the chance to save the dynamic recording. The user can then replay the retromix file which will replay any dynamic manipulations; the user can then introduce further dynamic manipulations which can be saved in the same retromix file. This means a user can concentrate on manipulating one part of a mix and then replay and concentrate on another area to slowly build up a complicated set of interactions/manipulations. The user would also have the option of saving static mix settings.

Advanced Interactivity Options Provided by the Combination of the Retrofile Format and the Features of the iPhone:

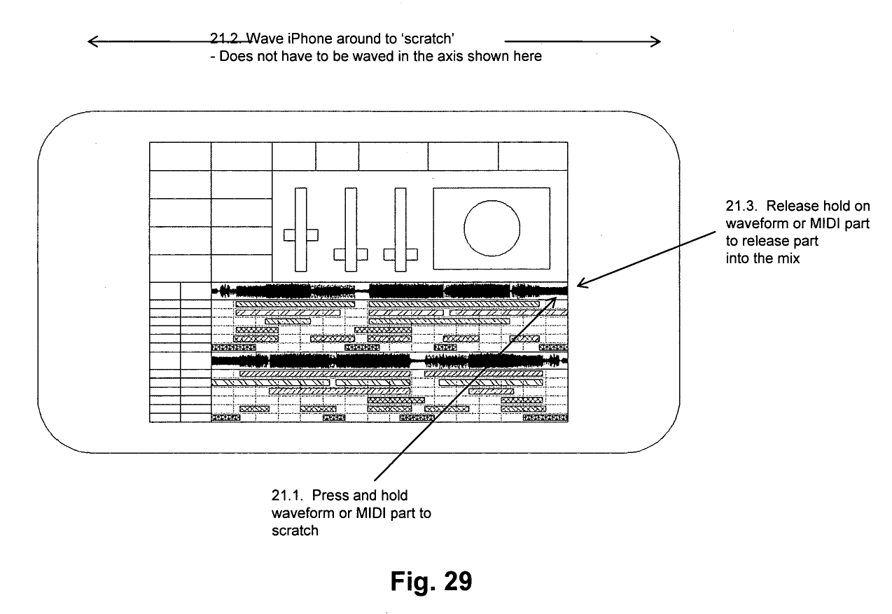

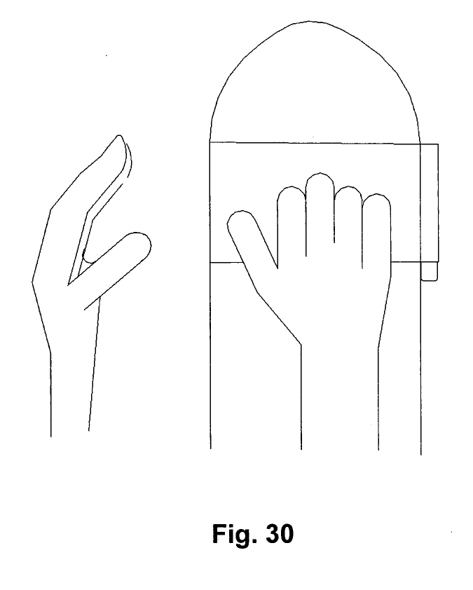

The x,y,z (3 axis accelerometer) in the iPhone can be used to interact with the retroplayer in several unique and exciting ways:
An audio ‘part’ could be assigned to the x axis of the accelerometer and waving the iPhone from side to side could be linked to the playback position and thus the particular audio ‘part’ would be ‘scratched.’ Undoubtedly one of the most appealing aspects of mixing with ‘turntables’ is the natural and intuitive feel and general fun associated with scratching. It is apparent to the author that regardless of any other functionality that the retrofile format provides the simple act of listening to your favorite song whilst waving your iPhone around in order to add in scratches of an appropriate audio ‘part’ and then ‘letting the sample go’ and have it seamlessly blend into the mix in perfect timing would be irresistibly fun for the average person. Scratching a single audio stream never sounds good because the flow and tempo of the song is interrupted. In order to make a scratch sound good the song needs to continue to play while another audio part is scratched along with it. With retroplayer and the functionality the retrofile format provides a user can choose which part of the song to scratch (a vocal catch phrase/a sound effect) at the touch of a finger whilst the rest of the song continues to play as normal, and scratch it by waving the iPhone around. This will sound good and a user can make it happen from thought to scratching to sounding great in the time it takes to think about it. An example of this simple functionality is shown in FIG. 29. For continuity let us assume the user is using the same interface and 2 retrofiles however at this time is simply using the retroplayer as a media player and waveform 20.11 is playing in normal linear fashion. To scratch an associated part into the mix the user must simply press and hold their finger on that part 21.1, say the vocals catch phrase as specified in FIGS. 22 and 23, and wave the iPhone around to scratch 21.2. (Scratch axis could be user defined or ‘all or any.’) The part can be released into the mix (by default to loop play once and stop) by releasing hold of the part 21.3. This functionality could also be achieved by waving a finger across the multitouch screen starting from the audio ‘part’ the user wishes to scratch.
A parameter can be assigned to each axis such as cutoff frequency, resonance and lo-fi depth (an effect). By moving/waving the iPhone around you can interact with the music (a MIDI or waveform part or track) in a very intuitive fashion. Getting used to all three axes may take some time so a user could start with just assigning high cut filter cutoff frequency to the x axis of the iPhone for example, applying the parameter to the bass line and waving the iPhone slightly from side to side in time with the music. [Single (or more) axis parameter changes over time via accelerometer input could be dynamically recorded.]
A user could ad-lib improvise a bass line or riff for example by assigning pitch to the y axis (in increments of the notes used in the part being interacted with, whether scales or just particular notes—so the user cannot play a note that would not sound right) and cutoff frequency to the x axis to emulate a rhythmic feel and effect depth to the z axis. Or one axis at a time to make it easier. [It would be necessary that either only the pitch increments used in the part or in the scale used in the part are assigned to the ad-lib increments—in this manner the user cannot play a note that will sound ‘wrong.’ This is described in more detail later.]
A user could combine all 3 of the above and assign a scratch to one axis, a parameter to the second axis and an ‘ad-lib riff creator’ (series of automatically created pitch increments used in the part being played) to the 3^{rd} axis.
The accelerometer could be used for drumming. A user could hit their leg with the iPhone—this could be assigned to be a bass drum. The iPhone has a 3 axis accelerometer so the face of the iPhone the user hits their leg with can be made to affect the resultant output.
Alternatively a user could place or preferably strap the iPhone on/to the top of their right thigh (touch-screen down) and tapping it from the top using their right hand could provide a bass drum sound and tapping it sideways from the left using their left hand could provide a snare drum sound for example.
Another option is to have the iPhone strapped to the right hand side of a user's right thigh. In this fashion the user could introduce accelerometer data into the iPhone by tapping their top and inside thigh (of their right thigh) and let the accelerometer receive data through the thigh tissue. Clearly the thigh tissue would alter the received accelerations however this is likely a good thing. Tapping down is one axis. Tapping across is another axis. Tapping your foot on the ground would provide the 3^{rd} axis. This exactly matches a bass drum, high hat and snare drumming set up in terms of hands, feet and the actions they perform on a ‘real’ drum set. Therefore a drummer who has previously utilized real drums would have no problems in moving from real drums to iPhone virtual drums. In this fashion a retroplayer user could drum along to a retrofile song. Depending on the sensitivity of the accelerometer in the iPhone, perhaps scratching (rubbing your hand back and forth) across the surface of your top thigh could be interpreted as ‘scratching data.’ The input from such an arrangement could also be used for other purposes such as triggering events or providing ad-lib input data. Such an arrangement is illustrated in FIG. 30.

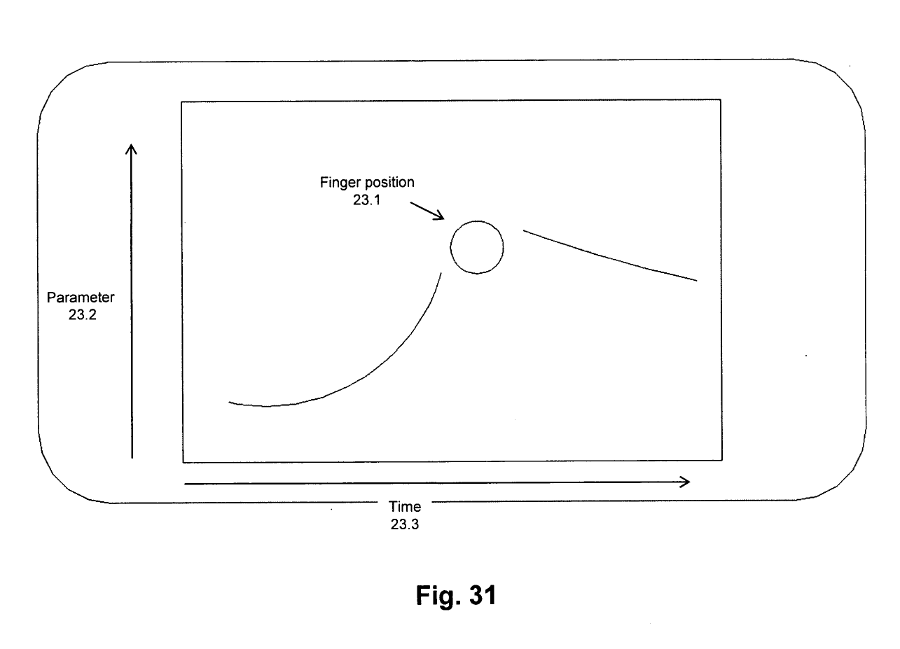

Capacitive multitouch screen—this provides a number of unique opportunities for the iGruuv interface:
A good capacitive touch screen can detect the presence of a finger before it touches the screen and any changes in the shape of the finger after touching the screen. This data can be used to provide velocity and aftertouch parameters when the screen is in keyboard mode. [This also means that areas of the screen can be enlarged as a user goes to touch them for precise control rather than enlarging the area after the screen has already been touched.]
The screen can be used a keyboard with velocity, aftertouch etc.
The screen can be used as a pad drum kit with velocity, aftertouch etc.
The x,y parameter pad can be used to designate parameter sweeps over time like on a graph. A general property of a multitouch screen is that parameter changes over time can be ‘drawn.’ Cutoff frequency if often used (particularly in the electronic music genre) to create rhythmic fluctuations in an instrument track such as a riff or bass line. These can be created via simply drawing the parameter changes over time on a graph with parameter level on the y axis and time on the x axis. Such parameter changes over time are often referred to as ‘parameter sweeps.’ Drawing on a graph on a multitouch screen is particularly useful for creating parameter sweeps for retrofile parts. A simple example is shown in FIG. 31.

The above is merely an example of the very beginning of the functionality the iPhone could provide as a platform for the retrofile system. A person skilled in the art will immediately see the large and varying user interface and graphical interface possibilities provided by the combination of the functionality provided by the retrofile format and the utility provided by the iPhone as a platform.

Multitouch Screen Laptop:

Of course another device which contains all the features necessary for the full implementation of retrofile functionality as described above for the iPhone is a multitouch-screen laptop. Whilst a multitouch-screen laptop has a larger multitouch-screen and therefore more versatile interface and of course more computing power, it suffers the disadvantage that it is not something that a user is likely to have on them and use all the time in the same fashion as a cell phone. The intention of bringing music interaction to the masses in a fashion whereby people do it on a regular basis is harder to realize on a laptop than a cell phone.

Hardware Playback Devices Designed to Implement Retrofile Functionality:

Whilst a multitouch-screen interface is the preferable embodiment the current invention can also be implemented in older generation hardware device embodiments. Due to the very recent advent of the multitouch laptop and the iPhone (particularly the iPhone SDK public release—6 Mar. 2008) it is worthwhile describing the retroplayer in its hardware embodiments because they bring to light many features which could be used in the multitouch-screen interface.

The hardware retroplayer could store the retrofiles itself or a portable audio storage device such as an iPod could dock with it in order to provide the necessary files or both.

The retroplayer can also have important features that were not explained under the ‘file format’ heading above:

A retroplayer could be equipped with a ‘retroplayer keyboard’ which can provide an interactive learning experience and an easy means of playing ‘ad lib’ with no knowledge of musical theory such as scales, chords etc as well as a means to add to the remix in a fashion musicians are more familiar with.

Notwithstanding that inclusion however a ‘retroplayer keyboard’ is essentially an included (with the retroplayer device) or plug-in keyboard for the retroplayer device that has a series of LEDs or other signaling apparatus on each key. Due to the fact that a retrofile comes with a MIDI version of its corresponding waveform song it can be quickly determined (by the playback device or beforehand and included as data in the retrofile) which notes are used to play each particular track of a song. For example, if each of the 12 notes of every octave has a green LED on it and if a user has set the retroplayer to a bass line MIDI track, the notes that are used to play (ONLY the notes that are used to play) the particular bass line can be lit up across every octave of the keyboard. This may only include 5 notes of every 12 note octave (for example). In this fashion a user can play along with the song (jam with their favorite band) by tapping on the lit notes on the keyboard. Due to the fact that the user will therefore only be using the notes used to create the particular track of the original waveform song which will therefore be in the right ‘key’ (the same key the original waveform song is in), to a large degree it does not matter in what order or timing the user presses the notes in, the result will not sound out of place. Indeed the result is likely to sound good. A user could even turn down the volume of the bass line they wish to play ad lib whilst still having the appropriate keys lit up such that they could attempt to replace the said bass line with their own creation using the same notes. Any original creation in terms of timing and order of notes will be in the same key as the original song and using the same notes as the particular track of the original song (the bass line in this example) and therefore is likely to sound good.

A further function of the retroplayer keyboard is to have the same LEDs change color (or another set of LEDs for each key of a different color light up) when the notes of the original waveform song are played. This means that not only the 5 notes used in a 12 note octave are lit green such that a user can see which notes are used to play the particular track, but that as each note is used in the playback of the song the corresponding note's LED changes color for the length of the note depression. This means that if a user could press the keys as they light up, in time with their lighting up, the user would be playing the particular track just as it is played in the original waveform song. Again this means that a user can turn down the volume of the particular track whilst still having the keys light up as they are being played in the original waveform song and attempt to play along with them. If a user succeeds in doing so, they will be playing the bass line of the original waveform song.

The user could of course turn both the LED functions on or off. An important advantage of retroplayer keyboard is that the skills learnt in playing a retroplayer keyboard would be fully transferable to a regular keyboard. I.e. if a user learnt the bass line of their favorite rock and roll song on a retroplayer keyboard, they could then play it on any other keyboard (or piano or other analogue instrument) and it would sound the same.

Both of these functions could obviously be used for alternative MIDI tracks etc.

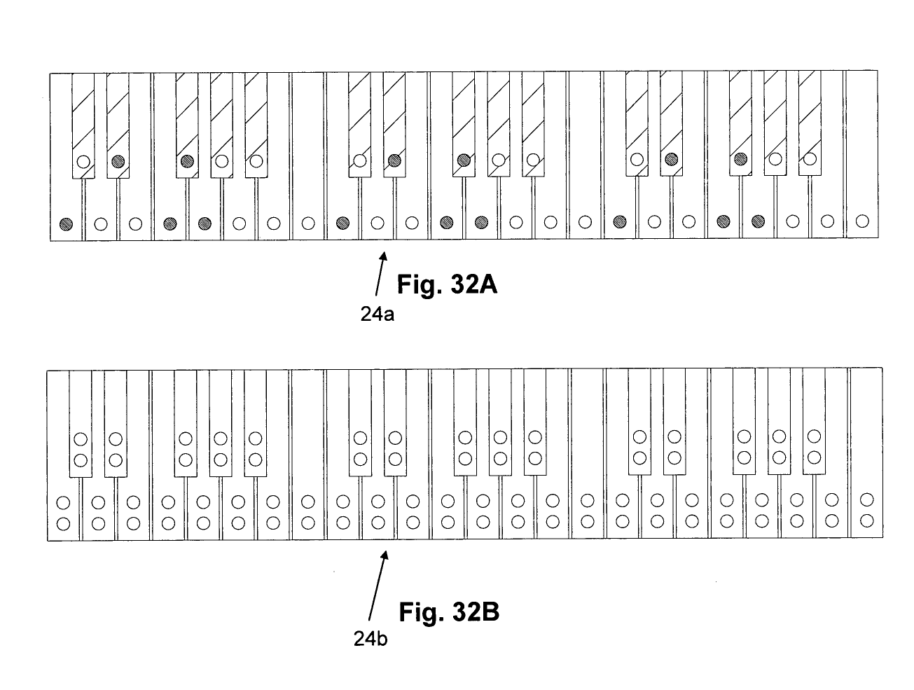

A keyboard with LEDs on each key that could be implemented in the fashion described above is shown in FIG. 32. FIG. 32A shows 5 keys of each octave lit to indicate the 5 keys used in the creation of an original waveform song's bass line as per the above example.

The LEDS of FIG. 32B change color when the particular note is actually played during the playback of the particular track in the song. FIG. 32B shows a retroplayer keyboard in which two LEDs are utilized, one to indicate which notes are used in the creation of the original track, and another to indicate when they are actually being played.

The idea behind a retroplayer keyboard could be applied to other MIDI instruments that could be designed to interface with the retroplayer - a MIDI guitar with LEDs behind each fret on the fret board for example.

This could also be implemented on any multitouch-screen user interface. The idea of only lighting up notes that are used in a particular track translates into the ad-lib function for the to iPhone either in x,y touchpad or shake the iPhone accelerometer mode in the sense that only the notes that are used in the particular track are applied to the pitch axis. Thus the user cannot play a ‘wrong note’ even whilst frantically waving a cell phone around for example.

A Range of Playback Devices

The following is an example list of the functionality a retroplayer device could deliver using the functionality the retrofile format provides for:
By arrangement section rearrangement.
MIDI looping. The waveform song ‘follows the MIDI.’
Static saving of remix settings.
Dynamic recording of remixes. (For example, parameter changes such as cutoff frequency over time.)
File sharing capability.
MIDI track remix.
Alternative MIDI track remix.
Alternative waveform or synthesis track remix.
Track parts. (Catch phrases, main riff etc)
Combination of various ‘elements.’ (E.g. mixing loops with section arrangements.) An ‘element’ is a ‘part’ that the retrofile format provides and includes MIDI (and thus waveform) loops, arrangement sections, track parts, MIDI and waveform tracks etc.
Tempo adjustment. (Utilizing the MIDI time grid as a guide.)
Mixing two retrofile songs together. (Conformed to a user defined tempo by utilizing tempo changing software/hardware and using the MIDI time grid as a guide and letting the ‘audio follow the MIDI’
Collaborative mode.
Retroplayer MIDI keyboard (and other MIDI instruments).
Microphone input, dedicated vocals mixer channel and vocoder.

Not all of the functionality the retrofile format could provide is listed above and the list above should only be taken by way of example.

A range of playback devices could therefore be introduced to the market to appeal to a range of people (from children through to music professionals) and the retrofiles (altered and saved or left unchanged) would be fully transferable amongst the different devices as would be the skills learnt by users of the various devices. The amount of functionality that the retrofile format provides implemented in the playback device could vary between playback devices in order to both appeal to different user markets and graduate cost. Fortunately the cost of the unit would rise in proportion with the likelihood of the target user being able to spend more money on the unit. I.e. a playback device designed for children could be made with a small amount of functionality and therefore less expensively whereas a playback device designed to utilize the full suite of functionality provided by the retrofile format and therefore appeal to a more sophisticated user would be more expensive. An example range of hardware devices is listed below:

Retroplayer Nano

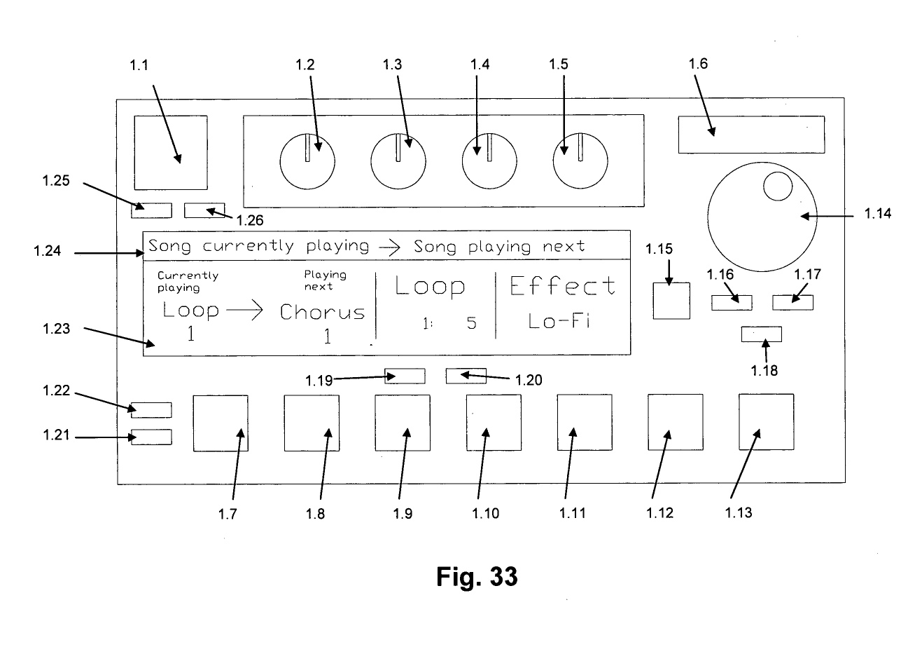

The Retroplayer Nano could be a relatively unsophisticated version of the retroplayer aimed at children (say 9-14). This device could be limited to simply implement section rearrangement and MIDI looping combined with a filter and a few effects. An example of a Retroplayer Nano is shown in FIG. 33. An iPod is used as the storage means for iGruuv files in this example and docks with the Retroplayer Nano at 25.6. The power button 25.1 is used to turn the unit on and off. The 4 knobs to the right of the power button are volume 25.2, cutoff frequency 25.3, resonance, 25.4 and effect level 25.5. The rotary switch 25.14 is the universal selector. The bottom row of buttons are arrangement selection/loop buttons which are pre-assigned to arrangement sections such as intro 25.7, verse 1 25.8, chorus 1, 25.9, verse 2 25.10, chorus 2 25.11, crescendo 25.12, outtro 25.13. The buttons to the right of the LCD screen are effect select 25.15, stop 25.16, play 25.17 and record/save 25.18. In operation the user turns the unit on and selects the first ‘element’ to play (loop or arrangement section). The user has a choice of the 7 arrangement sections or a loop to play first. The 7 arrangement sections are selected simply by pressing the corresponding selection button 25.7-25.13. Loop hotkeys are assigned via first toggling the 7 arrangement section/loop buttons between arrangement section and loop setting by choosing loop 25.21 from the 2 buttons to the left of the arrangement section/loop buttons (arrangement section 25.22 and loop 25.21). Holding a loop button down (25.8 for example) causes ‘Loop’ to flash in the remix display 25.23 and then a loop ‘boundary’ is selected by pressing the left loop boundary button 25.19 and rotating the universal selector until the left boundary is appropriately selected (in this case bar 1) and then pressing the right loop boundary button 25.20 and rotating the universal selector until the right boundary is appropriately selected (in this case bar 5). When play 25.17 is pressed, the unit will play either the chosen arrangement section or the chosen loop in a repeating fashion until either another arrangement section or loop is chosen to play next. If for example another arrangement section is chosen by pressing its corresponding button near the bottom of the unit, the device will finish playing its current arrangement section or loop and then move onto the next chosen arrangement section. In this example the unit is currently playing the loop of bars corresponding to loop hotkey 1 (bars 1 to 5) which is displayed on the screen under “Currently playing” and the unit is to play arrangement section chorus 1 next (displayed under “Playing next”). The user can manipulate cutoff frequency 25.3, resonance 25.4 and effect levels 25.5 to interact in a manner other than by rearrangement of the particular waveform song. Such manipulation however is limited to manipulation of the waveform song in this example however and the user cannot manipulate (or even add) the MIDI version of the waveform song. Effect type is chosen by pressing the effect selection button 25.15 and rotating the universal selector 25.6. Songs can be played in sequence by pressing the current song button 25.25 and rotating the universal selector 25.14 to choose the song currently playing and the next song can be selected by pressing the ‘next song’ button 25.26 and using the universal selector 25.14 to choose the song to play next. The 4 parameter knobs are set to apply to the element or song currently playing if button 25.25 is pressed and to the element or song to play next if the 25.26 button is pressed. If none of the parameter settings of the segment to play next are modified, the next element or song will play beginning with the default parameter settings. If the record/save button 25.18 is pressed during or before playback the unit will record the dynamic manipulations of the user (knob movements/button presses as to time) and if the record/save button is pressed when the song is finished or stopped the unit will save the remix and prompt the user to enter a filename to save it onto their docked iPod.

The iGruuv Nano thus has the following functionality from the above list:
Section rearrangement.
MIDI looping.
Static saving of remix settings.
Dynamic recording of remixes.
File sharing capability.

The ‘Retropleyer Nano’ playback device described above is merely an example and should not be taken to be limiting of the scope of this invention.

Retroplayer Mini

The iGruuv Mini could feature much the same functionality as the iGruuv and look and feel much the same at a lesser cost. All the same functionality could be provided, just less of it; synthesizers with less presets, effects modules with less effects etc.

Retroplayer

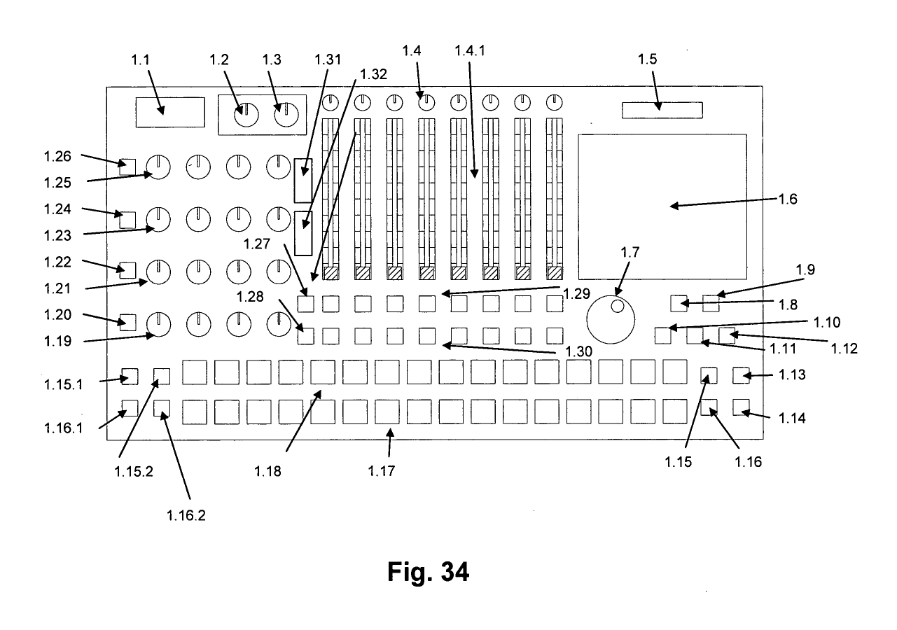

The Retroplayer could be the mainstream hardware version of the playback unit and feature all of the functionality the file format provides in a professional package (I.e. the included electronics package, MIDI synthesis, effects etc would cater for novices to professionals). An example layout of a Retroplayer is shown in FIG. 34. The power button 26.1 is used to turn the unit on and off. The two knobs to the right of the power button are volume 26.2 and tempo 26.3. The row of knobs 26.4 above the volume (and other parameter adjust) faders 26.4.1 are pan knobs for each of the tracks. Each of the faders 26.4.1 and pan knobs 26.4 would typically be assigned to a particular track. The faders are toggled between effecting MIDI tracks and waveform loops/arrangement sections by toggle button 26.31 and toggled between tracks 1-8 and 9-16 by the track toggle button 26.32. An iPod docking pod 26.5 is included so that an iPod can be used as a transport and storage vehicle for iGruuv files. The unit may also be equipped with USB ports (and other media readers) such that users could also utilize USB memory sticks etc as transport and storage media. A large LCD screen 26.6 provides the graphical user interface (GUI) for the device. A MIDI piano roll could be displayed onscreen when desired as a learning tool for iGruuv keyboard. A universal selector 26.7 and enter 26.8 and exit 26.9 buttons are provided in order for a user to interface with the GUI. The device may also come with a mouse port if desired for easier interface with the GUI. Stop 26.10, play 26.11 and record 26.12 buttons provide means for basic control and dynamic and static recording of remixes or parameter settings. There are two layers of 16 buttons at the bottom of this example iGruuv which perform several important functions. Each layer of 16 buttons (26.17 and 26.18) represents 16 different elements of two different songs, such as arrangement sections or loops. (If the iGruuv is only being used to play one song however the bottom layer is used as a drum sequencer as commonly found in machines such as Roland's MC-505.) Toggle buttons 26.15 and 26.16 toggle the two layers of 16 buttons between arrangement section mode and loop mode. When in loop mode each of the buttons represents 4 bars so to easily setup a loop of particular song a user simply defines the loop space by holding down the corresponding loop selector button (26.15.1 or 26.16.1) and choosing the loop boundaries by selecting two of the 16 buttons in the particular layer. If for example a user selects buttons 5 and 7 of the 16 buttons the song will loop between bars 21 and 29. Loop hotkeys are selected by holding down a particular button in the loop layer and using the universal selector 26.7 to designate loop boundaries. The hotkey is then recalled by first pressing the hotkey select button for the particular layer (26.15.2 or 26.16.2) and then the desired hotkey. When each layer is in arrangement mode the arrangement sections are automatically assigned in chronological order from left to right along the 16 arrangement section buttons for each song. Buttons 26.13 and 26.14 are used to select which song all the buttons/faders/knobs etc on the entire iGruuv are to apply to, song 1 26.13 or song 2 26.14. If a MIDI track, alternative MIDI track or other synthesis or waveform track is selected all the buttons/faders/knobs etc on the entire iGruuv will apply to that track. This example iGruuv has 4 effects knobs in a row 26.19. These start off at default effects such as delay, reverb, compression and overdrive however are customizable by holding down the effect select key 26.20 and rotating the desired effect knob until the desired effect is shown on the LCD screen 26.6. Above the layer of effect knobs 26.19 are 4 knobs 26.21 in a row for 4-pole parametric equalization. When these are adjusted a frequency graph will be displayed in the LCD screen 26.6. Above the layer of EQ knobs 26.21 is an envelope (attack, decay, sustain, release) layer of 4 knobs 26.23 which are toggled from amp envelope to filter envelope via toggle button 26.24. Above the layer of envelope knobs 26.23 are 4 knobs 26.25 which are cutoff frequently, resonance, LFO depth and LFO rate from left to right. Button 26.27 toggles the top layer of buttons 26.29 below the faders 26.4.1 between part select and part mute. The bottom row of buttons 26.30 below the faders 26.4.1 mute the various parts of the MIDI drum track (kick/snare/hi-hat etc). The element of the same or other song that is ‘playing currently’ or is to be ‘played next’ would be controlled in the same fashion as described for the iGruuv Nano above.

The ‘iGruuv’ playback device described above is merely an example and is should not be taken to be limiting of the scope of this invention.

Retroplayer Professional

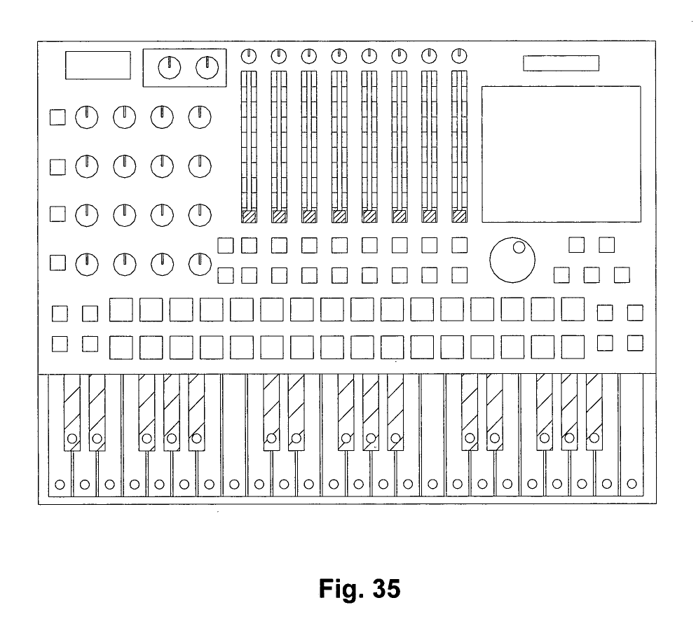

The Retroplayer Professional could be the flagship Retroplayer product aimed at DJs and music production professionals. It could be essentially the same as the Retroplayer however have in/out/interface options more suited to integration in a studio environment such as fire wire interface with DAW software, ADAT in/outs etc. The Retroplayer professional could also be equipped with an inbuilt retroplayer keyboard. An example embodiment Retroplayer professional is shown in FIG. 35.

Transferable Skills/Files between Devices

It is a considerable advantage of the retrofile format (and therefore range of playback devices) that all the skills that a person may learn or employ on one device will be fully transferable to another device in the retroplayer range. More importantly however it is also the case that any remix files that a person creates on one device are fully transferable to any other playback device. It is only the functionality that a user can later apply to a retrofile that will differ between devices. This provides a level of comfort for the purchaser of an ‘Retroplayer’ for example in that their skills, knowledge and ultimately remixes and original creations are not of any less value on a machine of different functionality. A ‘Retroplayer’ user can seamlessly move to being a ‘Retroplayer Professional’ user for example. This is a good reason for having the different named devices look much the same and have only the level of functionality differ between them.

Software Retroplayer

A retrofile play back device could also be provided as software. Such software could interface with 3rd party or dedicated external control surfaces etc. A software retroplayer could be designed to easily interface with DAW and other similar software such as by being a (Virtual Studio Technology) VST instrument.

Example use of a hardware Retroplayer described above:

The following is an example of how a user could use the example Retroplayer playback device above to creatively interact with a waveform song:
Find a section of a waveform song (song 1) in which it is only the bass-line that is playing and designate a loop boundary around the section and assign it to a loop hotkey.
Set the iGruuv so that all its parameters are to act on waveform song 1 and bring the cutoff frequency down to around 20%.
Bring all MIDI track faders down to the bottom (no volume) and mute them.
Raise the MIDI drum track fader to 80% volume and mute every drum sound except the kick drum. (An alternative MIDI drum track could be used if so desired.)
Press play/record. Only the looped waveform bass-line section will play with a filter acting on making it sound ‘dull.’
Slowly increase the cutoff frequency (of the waveform song bass-line loop) up to full level over a number of bars.
Release the mute on the MIDI drum track (only the kick drum will play).
Wait a number of bars and then release the mute on the other drum sounds at the same time as muting the waveform bass-line. Now only the MIDI drum track is playing.
Increase the default assigned delay effect on the MIDI drum track until it is appropriately ‘tweaked’ and then select the chorus 1 button from the 16 button arrangement section layer for song 1. When playback reaches the end of the next bar of MIDI drum track the chorus 1 arrangement section of the waveform song will therefore begin to play. (The chorus 1 arrangement section will not just begin to play when you press the button, but will do so at the next available ‘juncture,’ in this case at the beginning of the next bar of the MIDI drum track. This of course can be customized.)
At the same as the chorus 1 arrangement section begins to play quickly reduce the volume fader of the MIDI drum track to zero. A user could also bring in a predefined vocal solo element track part to play just during the transition to give the transition some ‘smoothness.’
After a few bars have played press the loop hotkey for the bass-line section of the same song designated previously to bring the bass loop of the same song back into the mix. In this fashion a user is now mixing two waveform parts of the same song.

In the above fashion a user has interactively created their own creative introduction to the first chorus of a waveform song using two elements of the original waveform song and elements of the original MIDI version of the waveform song (and possibly provided alternative elements if desired). A user could then mix in a second retrofile song as per the example below:
The chorus 1 arrangement section of song 1 and the designated bass-line loop is now playing and will repeat in time until a further command is given.
Drop out the bass-line of song 1 by re-pressing its loop button. The loop button will go from blinking (to designate playing) to dark (to designate not playing).
Set the iGruuv to have all settings apply to waveform song 2. Bring all MIDI fader volumes to zero.
Define a loop section of song 2 that will mix well the chorus 1 arrangement section of song 1. You do not want the output to be too ‘busy’ so a vocal solo might be a good start. This can be designated by loop boundaries or it may already be preset track part element of the waveform song. Let us assume in this case that it is a preset track part element of waveform song 2 set to fader 14.
Toggle the faders from MIDI to waveform and from tracks 1-8 to tracks 9-16.
Select track 14 by pressing the appropriate part select button in the part select button layer.
Hold down the effect select button and choose a custom effect to later apply to the waveform vocal solo.
Raise the volume of waveform track 14 of song 2. (The vocal solo portion of waveform song 2 will rise in volume appropriately.)
Add the pre-selected custom effect to the vocal solo of waveform song 2 until it is appropriately tweaked.
At the same time as you press the chorus 2 arrangement section button for waveform song 2 press the vocal solo element button designated to button/track 14 of song 2 and the chorus 1 arrangement section button of song 1.
At the next juncture (being the end of the longest element currently being played) the vocal solo element designated to button/track 14 of song 2 and the chorus 1 arrangement section button of song 1 will go from blinking to dark and stop playing and the chorus 2 arrangement section button for waveform song 2 will go from dark to blinking and begin to play.
Now slowly and then quickly reduce the tempo to 0 and press stop. Press stop again to save your creation and assign it a file name. It can then be replayed, further manipulated and resaved.

In the above fashion a user has interactively mixed various MIDI and waveform elements of two retrofile songs. In the above example a user has performed a sophisticated piece of ‘DJ’ing’ at the touch of a few buttons, a performance piece that would take many hours of preparation using conventional methods. A novice Retroplayer user however could achieve this with simple instruction. The difference is that with retroplayer, all the preparation has been done for you in advance.

It can be seen that using the functionality that the retrofile format and playback device provides there are near limitless possibilities for a user to creatively interact with one or more of their favorite songs. The above example should therefore not be taken to limit the scope of the invention in any way but rather as bringing to light the possibilities.

Interactive Collaboration Device.

Retroplayer's could be linked together via MIDI, USB, Ethernet, wireless Ethernet (a/g/n) or over cell phone networks for example in order for two or more users to musically collaborate.

Due to the fact that it is the MIDI that is being manipulated and the audio simply ‘follows the MIDI’ the linked retroplayer's essentially only need communicate via MIDI (and retrofile data—which is mostly MIDI markers and metadata). Not only does this make collaboration easy to implement but the data transferred in order to enable collaboration is minimal in the sense that only MIDI and retrofile data need be transferred, not band-width intensive waveform data. This means that wireless networking technologies could be utilized and easily be able to cope with the data transfer requirements of collaboration for two or more users. This also means that no copyright laws are being breached as no copyrighted works are being transferred between collaborating users, merely instructions on how to ‘use’ copyrighted works. It would appear preferable that a master retroplayer provide the overall tempo however each retroplayer would output the mixed audio (the audio output would be the same for all collaborators). Retroplayer device users control aspects of the collaboration and the input and actions of each and every collaborator is shown on each and every collaborators device in real time.

The following is two examples of how this could occur:

1. Users could collaborate on the same song. The following is an example of such an arrangement:
In this mode one retroplayer could be set to master and the others to slave. The master retroplayer is master of tempo more than anything else as this is the one thing that must be common amongst the collaborating retroplayers. An example of such collaboration could be that the master retroplayer user manipulates the arrangement of the songs (order of parts, loops, arrangement sections etc—the various elements of the songs) and the slave retroplayer users manipulate the parameters of the various elements the master retroplayer has designated to play in order. Alternatively the collaboration could be more ‘ad hoc’ whereby the master retroplayer simply controls the master tempo and the other retroplayer users could add and manipulate any track or element of a track they desire. It could be that the retroplayer users collaborate to form a cover of the original waveform song using only minimal parts of the original waveform song and mostly the various original MIDI version tracks of the song, the provided alternative MIDI and waveform tracks and ad lib creations using an inbuilt or separate retroplayer keyboard.

2. Users could collaboratively mix two or more different retrofile songs. The following is an example if such an arrangement:
User. 1 could choose waveform song x and press chorus 1 and user 2 could choose waveform song y and press verse 2. When the master user presses play, the songs will play from the start of chorus 1 and verse 2 respectively. The master retroplayer could determine the mix tempo to begin with and a master user could alter the tempo to which all songs will sync to if so desired. The two or more users could then operate their retroplayers essentially independently (other than the master tempo). and introduce elements and manipulations etc as they please.

In collaboration mode if a user starts to ad lib on a retroplayer keyboard the Retroplayer can be set up so that the notes he/she uses light up on every other users retroplayer keyboard. Therefore the other users can play ad lib using those notes and therefore will automatically be in the same key and not sound out of place. Collaborators can therefore be musically coordinated with absolutely no knowledge of musical theory, scales etc. This would obviously work particularly well however if the first user to ad lib (the one who defines which notes are to be lit up on every other users retroplayer keyboard) is a proficient keyboard player—alternatively the first ad-lib player can stick to the lit up notes provided by the MIDI track data and therefore guarantee no-one plays a ‘wrong note.’

An example of how part of a collaborative process may occur is shown in FIG. 36. It should be noted that this is merely by way of example and a person skilled in the art could see the many varied ways in which such collaboration could occur.

Retroplayer Karaoke

Retrofile songs could be provided with removed vocals such that karaoke can be performed in the traditional sense as well as a performer playing back the song in a their own creative fashion either individually or collaboratively.

Several Retroplayers could be set up (in a Karaoke club for example), one as the master (which could be operated by a club hired music professional/DJ) and others which anyone can operate.

Retroplayer Collaboration Online

Due to the fact that the amount of data transfer required in order to enable retroplayer collaboration is minimal (being only MIDI and retrofile data rather than waveform data) users could collaborate online (over the Internet) in the same way that 3D garners collaborate online.

Retroplayer Playback Device as an Audio Manipulation Device.

In order to get the most out of the functionality provided by the retrofile format it is preferable that the retroplayer take advantage of the full suite of audio manipulation technology that is currently available in order to isolate audio tracks from one another. For example, a user may want to add a provided original or alternative lead riff in replacement of the lead riff in the audio at a particular section of a song. Audio manipulation software/hardware is as far as the author is aware still unable to successfully split a mastered waveform song into its component tracks. This can be achieved to some degree however by intelligent EQ and filtering along with other advanced audio waveform manipulation techniques. Although tracks cannot be separated completely from the mastered waveform song they can be reduced or isolated to a ‘somewhat usable level.’ Such processes are normally very difficult and require the user to have a high level of skill and knowledge in choosing the correct settings etc to achieve the isolation of one track in the audio or the removal of one track in the audio. Due to the retrofit nature of the retrofile format however, all these settings can be pre-programmed before the fact such that a user can simply select mute or solo for a particular track in the particular waveform song and the pre-programmed audio manipulation techniques established during retrofitting to achieve the desired result can be put into effect. All that is required is the required level of functionality in the playback unit. In this fashion a user can mute the bass-line of a particular waveform song (to some degree) and replace it with the MIDI version of the original bass-line that they can manipulate, an alternate bass-line they can manipulate or play ad-lib on an iGruuv keyboard in replacement of the bass-line. As track splitting software/hardware becomes more sophisticated future retrofiles/retroplayers can take advantage of this functionality to a greater degree.

File Format 2.

If the retrofile format ‘catches on’ and original musicians start providing alternative MIDI and/or waveform and synthesis tracks to their prior or current compositions and users start to mix and share their own compilations it may be possible to implement an ‘enhanced version’ of the retrofile format. It is highlighted that this may only be possible if the retrofile format catches on, because in order to implement this enhanced retrofile format the various music studios (Sony etc) would need to agree to release the master tracks of original waveform songs to the public. File format 2 would provide to the full extent that which the audio manipulation capabilities outlined in 5 above provide to some extent. As mentioned above, it is true that audio manipulation technology can mute, solo and isolate tracks in songs (waveforms) to a limited extent, but in order to truly affect this functionality the different tracks of the original mastered waveform song must be provided as separate entities. Only then can a user truly mute or solo a track in the original waveform song. File format 2 is an extension of file format 1 whereby the original audio of the songs is provided in individual tracks allowing a user to mute, solo and apply filters, effects etc to the individual audio (waveform) tracks of the original song. In reference to the above ideas this means that a user could actually ‘take over’ the playback of a bass line or other track and that a collaborative effort could largely take over the song with only a few original waveform track remnants remaining if so desired. This is jamming with your favorite band at the next level.

File Sharing.

Essentially when a user purchases a song in type 1 retrofile format they are purchasing two copyrighted items, the original mastered audio of a song and the musical score or MIDI of a song. This means that when a user uses the MIDI to rearrange the audio and adds to the composition by utilizing and manipulating the provided original MIDI, the provided alternative MIDI or their own MIDI creation they have used the mastered audio copyright and perhaps the MIDI copyright. A file in retromix format however can be designed such that whether or not the user used the copyrighted waveform song and MIDI in the creation of the remix, the remix file contains no elements of the original waveform song or its corresponding MIDI. A retromix file can be designed such that a user is merely saving a set of instructions for manipulation of the original waveform song and MIDI version thereof. I.e. the user is merely saving an instruction set for the use of a type 1 or type 2 retrofile. An retromix file would therefore contain neither copyrighted waveform data, nor copyrighted MIDI data. This means that remixed works saved by a single user or by a collaboration of users as a retromix remix file, can be shared with other users without breaching copyright in any way. Other users who download from the online user community (or otherwise obtain) the retromix file who legitimately own the type 1 retrofiles or type 2 retrofiles and corresponding waveform songs (or pieces of songs) used in the retromix re-composition (and hence owns the copyrighted waveform and MIDI data) can then play back (and further remix and alter if so desired) the retromix remixes also without breaching copyright in any way.

The online user community/sales repository could be set up such that when an retroplayer is connected to the Internet sales repository and is requesting download of a particular retromix remix file, the retroplayer requesting the download is required to ‘validate’ that the user has legitimate copies of the requisite waveform songs, MIDI files/retrofile data, type 1 or 2 retrofiles files (or pieces of said files) required to playback the particular retromix remix. If not, a user could be prompted as to whether they wish to purchase the full renditions equired or perhaps only the pieces of said renditions required to play back the retromix remix file.

In any event, validation or not, an iGruuv user can only playback a particular retromix remix if they have copies of the requisite waveform songs, MIDI files/iGruuv data or type 1 or 2 retrofiles.

File sharing could also be done using a combination of wifi and torrent technology so files are shared amongst the network of iPhone's rather than via a central server. Every time you're near someone with part of a file who is also set to ‘sharing’ at the time you can get that part of the file off them.

8: Anti piracy tool.

The retrofile format can be used as a tool for enhanced anti-piracy measures for the music industry for two reasons:
1. Due to the fact that a retro file is not simply waveform data but includes MIDI, retrofile and other waveform, synthesis, playback and metadata the file format can include more sophisticated anti-piracy measures. The more sophisticated a file format is the more sophisticated anti-piracy measures can be put in it.
2. The second and most important anti-piracy measure the retrofile format provides is that a user actually wants the additional data that is included with the waveform data of a song. If a song is a simple waveform with appended copyright protection measures, the waveform can always be stripped from the rest of the data because the waveform is all the user needs or wants. The other data (copyright protection data or DRM data) is completely unwanted by the user and can be discarded. With a retrofile however, the other data (being the MIDI, retrofile, synthesis, playback and metadata) is required by the user in order to be able to use the file with retrofile functionality. The fact that the other data is wanted by the user can be used to an advantage in terms of anti-piracy because if the copy protection means is embedded in something the user actually desires and does not want to remove from the file; a user is less likely to do so.

The above description focuses on the use of MIDI as an example of the first audio information. In normal use, MIDI has three main functions:
1. MIDI acts as an interface between musical instruments and computers.
2. MIDI is a music production format that includes a digital representation of ‘musical score.’ MIDI musical score is typically represented as a piano roll (pitch) on the y axes and time on the x axis. In this fashion musical score can be represented as a plurality of dashes of different lengths (of time) at different pitches. Typically MIDI not only includes data comprising the musical score of a particular song but also other data such as tempo information, parameter levels, parameter changes over time, synthesis information etc.
3. MIDI is a ‘non-waveform’ music playback format, a format whereby a ‘MIDI player’ uses the instructions to make the music to recreate the music, rather than playing back the original recorded audio waveform (the ‘mastered audio’) of a song. Obviously the recreated audio will not match the original waveform song however MIDI can be used in this fashion to recreate a ‘likeness’ of a song. A song as a waveform data file is large in size in comparison to a MIDI file which is only the instructions to recreate the song.

However, the above described techniques could be implemented with a proprietary time grid or other timing designation/musical score encoding format. This could circumvent any copyright issues involved with the use of MIDI particularly if only ‘alternative’ MIDI tracks are provided rather than MIDI versions of the original tracks and the waveform song is not included.

In contrast, the second audio information is typically in the form of a digital audio waveform, which is stored in a digital file as a set of x,y samples representing the waveform. This can includes waveform data obtained from an optical storage medium (such as a CD) or provided in an alternative format such as an MP3 file, or the like, which typically includes waveform data as well as basic metadata such as the artists name, the song title, music genre etc appended to the waveform data.

The term video content part refers to a part or fragment of video content, and the term audio content part refers to a part or fragment of audio content. The term audio component refers to any track, such as an instrument or vocal track, within the song and can therefore represent the different individual instruments or vocalists within a song.

Persons skilled in the art will appreciate that numerous variations and modifications will become apparent. All such variations and modifications which become apparent to persons skilled in the art, should be considered to fall within the spirit and scope that the invention broadly appearing before described.

1) A method for use in editing video content and audio content, wherein the method includes, in a processing system:
a) determining a video part using video information, the video information being indicative of the video content, and the video part being indicative of a video content part;
b) determining an audio part using first audio information, the first audio information being indicative of a number of events and representing the audio content, and the audio part being indicative of an audio content part including an audio event; and,
c) editing, at least in part using the audio event, at least one of:
i) the video content part; and
ii) the audio content part using second audio information indicative of the audio content.

2) A method according to claim 1, wherein the second audio information includes a waveform of the audio content.

3) A method according to claim 1, wherein the method includes, in the processing system, at least one of:
a) aligning the video content part and the audio content part using the audio event;
b) modifying the video content part; and
c) modifying the audio content part.

4) A method according to claim 1, wherein the method includes, in the processing system, determining the audio content part from the second audio information using the first audio information.

5) A method according to claim 1, wherein the method includes, in the processing system, determining at least one of the video part and the audio part based on an association between the video part and the audio part.

6) A method according to claim 1, wherein the method includes, in the processing system, defining an association between the video part and the audio part.

7) A method according to claim 1, wherein the method includes, in the processing system, storing the video content and the audio content by storing each video content part together with an associated audio content part.

8) A method according to claim 7, wherein the method includes, in the processing system, storing the video content parts and associated audio content parts as a file.

9) A method according to claim 8, wherein the method includes, in the processing system, storing the first information in the file.

10) A method according to claim 1, wherein the method includes, in the processing system, causing the video and audio content to be presented by presenting:
a) each video content part using the video information; and
b) each audio content part using second audio information.

11) A method according to claim 1, wherein the method includes, in the processing system, determining at least one of the audio part and the video part in accordance with user input commands.

12) A method according to claim 11, wherein the method includes, in the processing system:
a) displaying to the user:
i) indications of a number of events; and
ii) indications of a number of parts of video content; and
b) allowing the user to select at least one event and at least one video part using the indications.

13) A method according to claim 12, wherein the method includes, in the processing system:
a) determining a user selection of at least one event;
b) presenting audio content including the at least one event using second audio information includes waveform data representing the audio content.

14) A method according to claim 1, wherein the method includes, in the processing system:
a) determining an event type for the event; and
b) modifying at least one of the audio content and the video content in accordance with the event type.

15) A method according to claim 1, wherein the first information includes, at least one of:
a) note data;
b) timing data;
c) marking data; and
d) instrument data.

16) A method according to claim 1, wherein the video content includes a sequence of a number of frames, and wherein the video part includes at least one frame.

17) A method according to claim 1, wherein the first audio information includes midi data.

18) A method according to claim 1, wherein the first audio information includes a time grid, the events being positioned on the time grid to thereby indicate the respective position of the event within the audio content.

19) A method according to claim 18, wherein the time grid includes an associated tempo representing the tempo of the audio content.

20) A method according to claim 1, wherein the method includes, in the processing system:
a) determining at least one video event using first video information, the first video information being indicative of a number of video events within the video content; and
b) editing at least one of the video content and the audio content at least in part using the video event.

21) A method according to claim 20, wherein the first video information includes a time grid, the video events being position on the time grid to thereby indicate the respective position of the event within the video content.

22) A method according to claim 21, wherein the time grid includes an associated tempo representing a video tempo assigned to the video content.

23) A method according to claim 22, wherein the method includes, in the processing system, editing at least one of the video and the audio content at least in part using the video tempo.

24) A method according to claim 23, wherein the method includes, in the processing system, combining audio content with video content, the audio content being selected at least partially in accordance with the video tempo and a tempo of the audio content.

25) A method according to claim 1, wherein the first video information forms part of the first audio information.

26) A method according to claim 1, wherein the method includes, in the processing system:
a) determining at least one video event using the first audio information, the first audio information being indicative of a number of video events within video content associated with the audio content; and
b) editing at least one of the video content and the audio content at least in part using the video event.

27) A method for use in generating video and audio content, the method including:
a) determining an event using first audio information, the first audio information being indicative of a number of events and representing the audio content;
b) generating a video part indicative of a video content part; and,
c) causing the video content part to be presented to the user with an audio content part including the event, the audio content part being presented using second audio information indicative of a waveform of the audio content.

28) A method for use in presenting video and audio content, the method including, in a processing system:
a) presenting video and audio content to the user;
b) determining an event within the audio content using first information, the first audio information being indicative of a number of events and representing the audio content;
c) causing at least one of:
i) modifying at least one of the video content part and the associated audio content part;
ii) allowing interaction with at least one of the video content part and the associated audio content part; and,
iii) triggering an external event.

29) A method for use in editing video content and audio content, wherein the method includes, in a processing system:
a) determining at least one video event using first video information, the first video information being indicative of a number of video events within the video content, the first video events being aligned on a time grid defining a tempo; and,
b) editing at least one of video content and audio content at least in part using the at least one video event.

30) A method for use in presenting audio content, wherein the method includes, in a processing system:
a) determining an audio part using first audio information, the first audio information being indicative of a number of events and representing the audio content, and the audio part being indicative of an audio content part including an audio event; and,
b) modifying the audio content part; and,
c) presenting audio content including the modified audio content part.

31) A method according to claim 30, wherein the audio content part is at least one of:
a) a instrument or vocal solo; and,
b) an audio content component part.

32) A method according to claim 31, wherein the component part includes a drum beat.

33) A method according to claim 30, wherein the method includes, in the processing system, presenting the audio content using second audio information indicative of the audio content, the second audio information includes a waveform of the audio content.

34) A method according to claim 33, wherein the method includes, in the processing system, presenting the audio content by:
a) determining the waveform part representing the audio content part;
b) modifying the waveform part; and,
c) presenting the second audio content using the modified waveform part.

35) Apparatus for use in editing video content and audio content, wherein the apparatus includes a processing system for:
a) determining a video part using video information, the video information being indicative of the video content, and the video part being indicative of a video content part;
b) determining an audio part using first audio information, the first audio information being indicative of a number of events and representing the audio content, and the audio part being indicative of an audio content part including an audio event; and,
c) editing, at least in part using the audio event, at least one of:
i) the video content part; and
ii) the audio content part using second audio information indicative of the audio content.

36) Apparatus for use in presenting video and audio content, the apparatus including a processing system for:
a) presenting video and audio content to the user;
b) determining an event within the audio content using first information, the first audio information being indicative of a number of events and representing the audio content;
c) causing at least one of:
i) modifying at least one of the video content part and the associated audio content part;
ii) allowing interaction with at least one of the video content part and the associated audio content part; and,
iii) triggering an external event.

37) Apparatus for use in editing video content and audio content, wherein the apparatus includes a processing system for:
a) determining at least one video event using first video information, the first video information being indicative of a number of video events within the video content, the first video events being aligned on a time grid defining a tempo; and,
b) editing at least one of video content and audio content at least in part using the at least one video event.

38) Apparatus for use in presenting audio content, wherein the apparatus includes a processing system for:
a) determining an audio part using first audio information, the first audio information being indicative of a number of events and representing the audio content, and the audio part being indicative of an audio content part including an audio event; and,
b) modifying the audio content part; and,
c) presenting audio content including the modified audio content part.

39) A machine readable file including:
a) video information, the video information being indicative of the video content;
b) first audio information, the first audio information being indicative of a number of events and representing the audio content; and,
c) second audio information indicative of the audio content. the second audio information includes a waveform of the audio content.

40) A file according to claim 39, wherein the file includes first video information, the first video information being indicative of a number of video events within the video content.

41) A file according to claim 39, wherein the first audio information is indicative of a number of video events within the video content.

42) A method for use in presenting audio content, wherein the method includes, in a processing system:
a) generating video content using first audio information representing the audio content, the first audio information being indicative of audio events and including at least one audio component, the video content including at least one video component representing the at least one audio component and including video events based on corresponding audio events;
b) causing the video content and audio content to be presented to a user, the audio content being presented at least in part using second audio information, the second audio information including a waveform of the audio content, the video and audio content being presented so that the video events are presented synchronously with corresponding audio events;
c) determining at least one input command representing user interaction with the at least one video component; and,
d) modifying the presentation of the audio content in accordance with the user input command.

43) A method according to claim 42, wherein the at least one video component is at least partially indicative of a parameter value associated with the audio component.

44) A method according to claim 43, wherein the method includes, in the processing system:
a) determining a user input command indicative of user interaction with the video component; and,
b) modifying the parameter value for the audio component in accordance with the user input command.

45) A method according to claim 42, wherein the method includes, in the processing system:
a) determining at least one parameter associated with the audio component; and
b) generating the video component using the at least one parameter.

46) A method according to claim 42, wherein the video component includes an indicator at least partially indicative of at least one of:
a) a parameter value; and
b) an audio event.

47) A method according to claim 46, wherein an indicator position of the indicator is indicative of the parameter value.

48) A method according to claim 47, wherein the method includes:
a) determining a modified indicator position in accordance with the input command; and,
b) determining a modified parameter value in accordance with the modified indicator position.

49) A method according to claim 46, wherein the method includes, in the processing system, determining a user input command indicative of user interaction with the indicator.

50) A method according to claim 42, wherein the at least one video component is a visualisation.

51) A method according to claim 50, wherein the video events include changes in at least one of:
a) a video component color;
b) a video component shape;
c) a video component size; and
d) video component movements.

52) A method according to claim 42, wherein the video content includes a plurality of video components, each video component being indicative of a respective audio component.

53) A method according to claim 52, wherein the audio content includes a plurality of audio components presented simultaneously.

54) A method according to claim 42, wherein the events include at least one of:
a) musical notes;
b) drum beats; and
c) vocal rendition indications.

55) A method according to claim 42, wherein the first information includes, at least one of:
a) note data;
b) timing data;
c) marking data; and
d) instrument data.

56) A method according to claim 42, wherein the first audio information includes midi data.

57) A method according to claim 42, wherein the first audio information includes a time grid, the events being positioned on the time grid to thereby indicate the respective position of the event within the audio content.

58) A method according to claim 57, wherein the time grid includes an associated tempo representing the tempo of the audio content.

59) A method according to claim 42, wherein the method includes, in a processing system, modifying the presentation of the audio content by modifying at least part of the audio waveform.

60) A method according to claim 42, wherein the audio component is at least one of:
a) an instrument track; and
b) a vocal track.

61) A method according to claim 42, wherein the method includes, in the processing system, modifying the presentation of the audio content by:
a) determining a part of the waveform representing the audio content to be modified;
b) modifying the waveform part; and
c) presenting the second audio content using the modified waveform part.

62) A method according to claim 61, wherein the method includes, in the processing system, modifying the waveform part by at least one of:
a) performing waveform manipulation techniques;
b) replacing the waveform part with another waveform part from the audio content; and
c) replacing the waveform part with a waveform part generated using the first information.

63) A method according to claim 42, wherein the method includes:
a) rendering a video component in accordance with midi data associated with a waveform; and
b) presenting the rendered video component and the audio content, the audio content being presented at least in part using the waveform.

64) Apparatus for use in presenting audio content, wherein the apparatus includes a processing system for:
a) generating video content using first audio information representing the audio content, the first audio information being indicative of audio events and including at least one audio component, the video content including at least one video component representing the at least one audio component and including video events based on corresponding audio events;
b) causing the video content and audio content to be presented to a user, the audio content being presented at least in part using second audio information, the second audio information including a waveform of the audio content, the video and audio content being presented so that the video events are presented synchronously with corresponding audio events;
c) determining at least one input command representing user interaction with the at least one video component; and,
d) modifying the presentation of the audio content in accordance with the user input command.

65) Apparatus according to claim 64, wherein the apparatus includes a display for displaying the video content.

66) Apparatus according to claim 65, wherein the display is a touch screen display for providing user input commands

67) Apparatus according to claim 64, wherein the apparatus includes an audio output for presenting the audio content.
